(19) United States
(12) Patent Application Publication
(10) Pub. No.: US 2005/0232511 A1
(43) Pub. Date: Oct. 20, 2005

(54) Image model based on n-pixels and defined in algebraic topology, and applications thereof

(76) Inventors: Djemel Ziou, Sherebrooke (CA); Marie-Flavie Auclair-Fortier, Quebec (CA); Madjid Allili, Sherbrooke (CA)

Correspondence Address: Lorusso Lound & Kelly, 15 Rye Street, Suite 312, Portsmouth, NH, 03801, US

(21) Appl. No.: 10/524,323

(22) PCT Filed: Aug. 8, 2003
(86) PCT No.: PCT/CA03/01214

§ 371 Date: May 31, 2005

(30) Foreign Application Priority Data
Sep. 8, 2002 (CA) 2397389

(51) Int. Cl. G06K 9/36

(52) U.S. Cl. 382/276

(57) ABSTRACT

A computational image model comprises an image support including a structure of n-pixels comprising pixel faces, quantities related to image features, and an algebraic structure relating the quantities to the n-pixels and/or pixel faces, the algebraic structure comprising algebraic operations defining a relation between the quantities. A method of computationally modelling an image comprises producing an image support including a structure of n-pixels comprising pixel faces, defining quantities related to image features, and relating the quantities to the n-pixels and/or pixel faces through an algebraic structure, and relating the quantities to each other through algebraic operations.

### FIELD OF THE INVENTION

The present invention relates to an image model based on n-pixels. More specifically, the present invention is concerned with an image model based on n-pixels, defined in algebraic form and applicable, in particular but not exclusively, for the resolution of diffusion and optical flow, and for the deformation of curves.

### BACKGROUND OF THE INVENTION

People have a notion of what an image is. For instance, for psychologists the image is linked to the shape of objects, their depth, the relationship of these shapes and their perceptual organization.

Artists are focused on how features such as shape, color, and perspective are organized to represent a scene that may originate in their imagination.

Physicists are concerned with the physical phenomena produced by a given scene and how they are represented in the image.

Neurophysiologists regard images through visual phenomena in humans and animals, such as contrast sensitivity, Mach bands, contrast, constancy, and depth perception.

While a precise definition of the image is elusive, it is clear that for certain people an image is the visualization of physiological, perceptual, or physical phenomena and for others it is related to semantic content. Whatever the term image means, the intention is to establish a foundation upon which images of all forms and contents can be discussed with minimal confusion.

In image processing and computer vision, the foundation is related to the understanding of the image formation process. Light generated by a source is modified by the objects of the scene. The modified light is captured by a system acquisition device, transformed into an appropriate form and displayed on a physical support. The content of the resulting image and, consequently, its further use, both deperid on the properties of the light (structured or not, spectral properties such as the range of wavelengths, the number of ranges and the intensity), the characteristics of the acquisition device, the transformation (analog-to-digital, pre-processing), the display format (temporal or spatial organization of image elements, film, vector, raster). From the automatic processing point of view, the image is enhanced to improve its perceptual quality or to make some of its features explicit. Usually, its content is analyzed via a successive reduction process to construct a more descriptive representation in terms of relevant features, which can be used more effectively by a decision system (car, robot, etc.) or to help human beings in their daily tasks.

One of the concerns here is to focus on the data structure for images and its consequences on the processing scheme.

Algebraic topology concepts are a key to representing images. Algebraic topology is well-known domain in mathematics [10, 6, 9]. The literature of algebraic topology offers wide knowledge that can be used for images. The specialists for algebraic topology, however, have made no effort to implement their knowledge into computer vision and image processing. Instead of using algebraic topology, the specialists of image processing and computer vision have limited themselves to develop solutions based on the topology and on discrete geometry [7, 8].

Algebraic topology was first introduced into image processing and computer vision by Allili and Ziou for topological feature extraction and shape representation in binary images [1, 2, 15]. This technology is used by Allili, Mischaikow and Tannenbaum [3] in medical binary images. Auclair et al. [4] also used algebraic topology for linear and non-linear isotropic diffusion as well as for optical flow in gray level images. P. Poulin et al. [12] used algebraic topology for snakes and elastic matching in gray level images.

In image processing and computer vision, several image models have been accepted and are in recurrent use since several decades. These image models integrate both the image support and the local quantities associated with this support. The image support is formed by pixels. With each pixel is associated a scalar quantity called a gray level, or a vector quantity called either color at the perceptual level or multispectral at the signal level. Existing models differ primarily in terms of how the image support (definition and the organization of pixels) and how values are formulated. The well-known image models are the function, the random process, and the ordered set. The image is a function Lₓ×L_{y}→G^{m}, where Lₓ={1, . . . ,Nₓ} and L_{y}={1, . . . , N_{y}}, Nₓ×N_{y} is the resolution of the image, G={1, . . . , n}, where n is the maximal quantity and m the number of image bands. In the case of a binary image n=2, image processing has roots in graph theory, language theory, logic, discrete geometry, and so on. If n>1, usually the image is modelled as a real function (analogue image where G,Lₓ,L_{y} ⊂ R). In this case, function theory, functional analysis, catastrophe theory, differential equations, and differential geometry constitute the foundation. An image can also be modelled as a collection of random variables X(i,j)|(i,j) ε Lₓ×L_{y}. In this case, the probability density function, moments, sufficient statistics, time series, and the Markov processes are the roots. When the image is modelled as an ordered set, discrete mathematics and mathematical morphology are the foundation.

Since the introduction of mathematical morphology, efforts of researchers in these fields have been focused on the use of more and more complex mathematical, physical or computer concepts as formalism of specific problems (edge detection, image segmentation, optical flow, and deformation) without questioning the image model. The definition of a new image model can lead algorithms that are designed on new basis. An image is a physical or mathematical quantity where variables (image support) represent geometrical or temporal elements such as points, lines, surfaces, and times. For example, the image, as a function Lₓ×L_{y}→G^{m}, can be defined by both the geometrical and topological properties of the domains Lₓ×L_{y} and the topological, geometrical and analytical properties of G^{m}. Although existing image models have deep roots in mathematics or in physics, the variables, the quantity and the association between them are not well-defined. For a given computer vision or image processing task, no formal mechanism is given for the integration of physical, topological, geometrical properties of objects and their behaviours as a part of the image model. Consequently, the resulting computational schemes are non-modular and sometimes not easy to reproduce.

### SUMMARY OF THE INVENTION

According to the present invention, there is provided a computational image model, comprising an image support including a structure of n-pixels comprising pixel faces, quantities related to image features, and an algebraic structure relating the quantities to the n-pixels and/or pixel faces, the algebraic structure comprising algebraic operations defining a relation between the quantities.

The present invention also relates to a method of computationally modelling an image, comprising producing an image support including a structure of n-pixels comprising pixel faces, defining quantities related to image features, and relating the quantities to the n-pixels and/or pixel faces through an algebraic structure, and relating the quantities to each other through algebraic operations.

Still in accordance with the present invention, there is provided a computational framework for solving a heat transfer problem, comprising:
producing an image support including a structure of n-pixels, the image support comprising:
   q-pixels respectively translating the n-pixel algebraically, wherein q ε {1, 2, . . . , n}, and wherein each q-pixel includes (q−1)-faces, (q−2)-faces, . . . , (q−q)-faces;
   geometrical complexes each being a collection of q-pixels;
   q-chains respectively expressing the geometrical complexes in algebraic form, each q-chain being a linear combination of all the q-pixels of the geometrical complex;
   in the geometrical complexes, q-cochains which are relations associating quantities related to image features to the q-pixels and/or faces of said q-pixels; and
   a coboundary defining a relation between q-cochains;
computing a q-cochain T of a first geometrical complex as the location of unknown temperatures;
computing a q-cochain H of the first geometrical complex as a global temperature variation;
finding a q-cochain ε of a second geometrical complex as a global energy variation, as a function of the q-cochain H through a linear transformation;
finding the q-cochain ε as a function of the q-cochain T;
defining a q-cochain G of the first geometrical complex from the q-cochain T-through a first coboundary operation, transforming the q-cochain G into a q-cochain Q of the second geometrical complex, and defining, from the q-cochain Q and through a second coboundary operation, a q-cochain D of the second geometrical complex as a global diffusion;
defining a q-cochain S of the second geometrical complex as a global source;
establishing a relation between the q-cochains ε, D and S.

The present invention further relates to a computational framework for two-dimensional active contour model, comprising:
producing an image support including a structure of n-pixels, the image support comprising:
   q-pixels respectively translating the n-pixel algebraically, wherein q ε {1, 2, . . . , n}, and wherein each q-pixel includes (q−1)-faces, (q−2)-faces, . . . , (q−q)-faces;
   geometrical complexes each being a collection of q-pixels;
   q-chains respectively expressing the geometrical complexes in algebraic form, each q-chain being a linear combination of all the q-pixels of the geometrical complex;
   in the geometrical complexes, q-cochains which are relations associating quantities related to image features to the q-pixels and/or faces of said q-pixels; and
   a coboundary defining a relation between q-cochains;
computing a displacement q-cochain D of a first geometrical complex;
computing a strain q-cochain S of a second geometrical complex, comprising:
   defining an approximate strain function \tilde{ε}(x) as a function of the q-cochain D;
   expressing the q-cochain S as a function of the approximate strain function and relative positions of the first and second geometrical complexes; and
computing a force q-cochain F of the second geometrical complex as a coboundary of the strain q-cochain S.

The foregoing and other objects, advantages and features of the present invention will become more apparent upon reading of the following non-restrictive description of illustrative embodiments thereof, given by way of example only with reference to the accompanying drawings.

The present specification refers to various references. These references are herein incorporated by reference in their entirety.

### BRIEF DESCRIPTION OF THE DRAWINGS

In the appended drawings:

FIG. 1 is an example of a 2-cube; the orientation is given by definition [0,1]×[0,1];

FIG. 2a is an example of subdivision that is a cubical complex, and FIG. 2b is another example of subdivision that is not a cubical complex;

FIG. 3 illustrates, in solid lines, an example of a primary cubical complex and, in dashed lines, an example of a secondary cubical complex;

FIG. 4a is an example of original image and FIG. 4b is an example of a resulting smoothed image;

FIGS. 5a, 5b and 5c illustrate a body in 3D space at time t. In FIG. 5a, x₁ is the location of the particle X₁, n is a vector normal to the surface, dS is an infinitesimal surface patch and dV is an infinitesimal amount of volume. In FIG. 5b, fₑ is an external force applied on dS, ρ is the mass and b is a body force applied on dV. In FIG. 5c, q is the heat flow passing through dS and r is the heat produced by dV;

FIGS. 6a, 6b and 6c are three examples of q-pixels in R² (I₁×I₂). FIG. 6a illustrates an example of 0-pixel where I₁={2} and I₂={1}, FIG. 6b an example of 1-pixel where I₁=[2,3] and I₂={1}, and FIG. 6c an example of 2-pixel where I₁=[2,3] and I₂[1,2];

FIG. 7 is an example of coboundary operation;

FIG. 8a is an example of projection onto the tangential part of the domain, and FIG. 8b is an example of projection onto the normal part of the domain;

FIGS. 9a and 9b are examples of cochains for one 3-pixel of K^{p1}. FIG. 9a illustrates an example of cochain T while FIG. 9b illustrates an example of cochain H;

FIG. 10a is an example of cochain Q for one 3-pixel of K^{s}, and FIG. 10b is an example of cochain D for one 3-pixel of K^{s};

FIG. 11a is an example of cochain T for one 3-pixel of K^{p}, and FIG. 11b is an example of cochain G for one 3-pixel of K^{p};

FIG. 12 is an example of three different paths between two points;

FIG. 13 is an example of computational scheme for an unsteady problem with no source;

FIG. 14 is an example of two cubical complexes for a 5×5 image;

FIG. 15 is an example of γₚ for one 2-pixel of K^{p};

FIG. 16a is an example of γ_{E} (in dashed lines) for one 2-pixel of K³ intersecting four pixels of K^{p}, FIG. 16b is an example of cochains T and G, and FIG. 16c is an example of cochain Q;

FIG. 17 is an example of one 3-pixel of K^{s′} surrounding one 1-pixel of K^{p′};

FIG. 18 is an example of λs for one 2-pixel of K^{p};

FIGS. 19a, 19b and 19c are examples of one 3-pixel of K^{s} intersecting four 3-pixels of K^{p}, for cochain T (FIG. 19a), cochain G (FIG. 19b), and cochain Q (FIG. 19c);

FIG. 20 is an example of two 2-pixels of K^{s} with λ's;

FIG. 21a is an example of physics-based isotropic diffusion σ={2.0, 4.0, 5.0}, and FIG. 21b is the example of physics-based isotropic diffusion of FIG. 21a convolved, for same scales;

FIGS. 22a, 22b and 22c are examples of first images of three sequences, a rotating sphere sequence (FIG. 22a) a Hamburg taxi sequence (FIG. 22b) and a tree sequence (FIG. 22c);

FIG. 23a is an example of flow pattern computed for the rotating sphere sequence of FIG. 22a using a physics-based method, and FIG. 23b is an example of flow pattern computed for the rotating sphere sequence of FIG. 22a using an iterative finite difference method;

FIG. 24a is an example of flow pattern computed for the Hamburg taxi sequence of FIG. 22b using the physics-based method, and FIG. 24b is an example of flow pattern computed for the Hamburg taxi sequence of FIG. 22b using the iterative finite difference method;

FIG. 25a is an example of flow pattern computed for the tree sequence of FIG. 22c using the physics-based method, and FIG. 25b is an example of flow pattern computed for the tree sequence of FIG. 22c using the iterative finite difference method;

FIG. 26a is an example of a first image of the tree sequence of FIG. 22c with white noise added (standard deviation of 10);

FIG. 27a is an example of flow pattern computed for the tree sequence of FIG. 22c with white noise added using the physics-based method, and FIG. 27b is an example of flow pattern computed for the tree sequence of FIG. 22c with white noise added using the iterative finite difference method;

FIG. 28a is a section of the peppers image (σ=5) of FIG. 21a corresponding to the original image with noise added, FIG. 28b is a section of the peppers image (σ=5) of FIG. 21a obtained with the PB method, and FIG. 28c is a section of the peppers image (σ=5) of FIG. 21a obtained with the FD method;

FIGS. 29a, 29b, 29c and 29d are examples of a section of the peppers image (σ=5) of FIG. 21a corresponding to the original image (FIG. 29a), corresponding to the original with white noise added (FIG. 29b, obtained using the PB method (FIG. 29c), and obtained with the FD method (FIG. 29d);

FIG. 30a is an example of PB method for σ={1.0, 3.0, 5.0}, and FIG. 30b is an example of FD method for the same scales;

FIG. 31a is an example of original image, and FIG. 31b is an example of image with noise added (standard deviation=10);

FIG. 32a is an example of PB method for σ={4.0, 8.0}, and FIG. 32b is an example of FD method for the same scales;

FIG. 33a is an example of PB method, and FIG. 33b is an example of FD method with σ=8.0;

FIG. 34 is an example of a body of arbitrary size, shape and material, where ΔS is a surface patch, f is a vector of surface forces applied on ΔS, ΔV is an amount of volume with a mass ρ, and b is a vector of body forces applied on ΔV;

FIG. 35 is an example of cutting plane passing through a point and partitioning the body into two sections;

FIG. 36 is an example of a force Δf acting on a cutting plane with normal vector n;

FIG. 37a is an example of stresses on the original body, FIG. 37b is an example of normal stress after an extension of the body, FIG. 37c is an example of normal stress after a compression of the body, and FIG. 37d is an example of shear stress after a distortion of the body;

FIG. 38 is an example of the component of the stress in the direction of x_{I};

FIGS. 39a and 39b are examples of the deformation (FIG. 39a) and distortion (FIG. 39b) of a body subjected to stresses; in both FIGS. 39a and 39b, the rectangle ABCD has been deformed or sheared into A′B′CD;

FIG. 40 is an example of normal strain of a body;

FIG. 41 is an example of shear strain in a body;

FIG. 42 is an example of a body B in motion and subjected to forces, wherein tᵢⁿ and pbᵢ are respectively the traction and body forces in the direction of x_{I};

FIG. 43a is an example of kinematic equation, FIG. 43b is an example of constitutive equation, and FIG. 43c is an example of conservation equation;

FIG. 44 is an example of decomposition of the linear elasticity problem into basic laws;

FIGS. 45a, 45b and 45c are three examples of q-pixels in R² (I₁×I₂). More specifically, FIG. 45a is an example of 0-pixel for I₁={2} and I₂={1}, FIG. 45b is an example of 1-pixel for I₁=[2,3] and I₂={1}, and FIG. 45c is an example of 2-pixel for I₁=[2,3] and I₂=[1,2];

FIG. 46 is an example of the coboundary operation;

FIG. 47a is an example of cochain U for a 3-pixel of K^{p}, and FIG. 47b is an example of cochain D for a 3-pixel of K^{p};

FIGS. 48a and 48b are example of cochains S and F, respectively, for a 3-pixel of K^{p};

FIG. 49 is an example of two cubical complexes for a 5×5 image;

FIG. 50 is an example of a 2-pixel of K^{p} and the topological quantities associated with it;

FIG. 51a is an example of γ_{F} in dashed lines, FIG. 51b is an example of 2-cochains D and U, and FIG. 51c is an example of 2-cochain S;

FIG. 52 is an example of five adjacent vertices in a curve and its deformation;

FIG. 53 is a table that shows typical values of the Poisson's ratio and Young's modulus of elasticity for some materials;

FIG. 54a is an example of initial curve, and FIG. 54b is a bright line plausibility image;

FIG. 55a is an example of results obtained for an aerial image using the PB method, and FIG. 55b is an example of results obtained for an aerial image using the FEM method;

FIG. 56 is an example of initial curve for a SAR image;

FIG. 57 is an example of line plausibility for a SAR image;

FIG. 58 is an example of road correction for a SAR image with the PB method;

FIG. 59 is an example of road correction for a SAR image with the FEM method;

FIG. 60 is an example of initial curve;

FIG. 61 is an example of bright line plausibility image;

FIG. 62 is an example of corrections for a multiband image (PB method);

FIG. 63 is an example of corrections for a Landsat 7 image (FEM);

FIG. 64a is an example of initial curves for a synthetic image, and FIG. 64b is an example of corrected curves for a synthetic image;

FIGS. 65a, 65b and 65c show an example of shape recovery of a curve when the external forces are removed, and FIG. 65d is an example of both initial curve (in white) and final curve (in black);

FIG. 66 is a schematic flow chart showing how to build an illustrative embodiment of the computational image model according to the invention; and

FIG. 67 is a schematic flow chart showing how to build a computational framework for solving a problem, in accordance with an illustrative embodiment of the present invention and using the computational image model of FIG. 66.

### DETAILED DESCRIPTION OF THE ILLUSTRATIVE EMBODIMENTS

The illustrative embodiments of the present invention are generally based on a data structure for images based on n-pixels, in which the image support, the image quantities and the allowable operations are specified separately. In this data structure, mathematics and physics are unified; that is, the data structure allows taking into account constraints originating in physics, mathematics, and the future use of the image. The image dimension is explicit, which allows us to design algorithms that operate in any dimension. The foregoing and other advantages and new open problems of this data structure will be discussed herein below.

One of the goals of the present invention is to provide a computational image model or a data structure that is capable of capturing all object properties that are needed for a given task. FIG. 66 is a schematic flow chart summarizing the procedure (successive steps 6601-6606) for building such a computational image model according to an illustrative embodiment of the invention. A data structure of the image is the formal specification of the image variables, image quantities, the association between image quantities and variables that enables capture of the geometrical and topological properties of objects as well as their physical and mathematical behavior. The abstract view of an image as a data structure as is used in computer programs is defined by the attributes and a collection of meaningful operations. The attributes are the image support and quantities that are assigned to the image support such as the image radiometry (e.g., color and grey level) or any feature that can be deduced from the radiometry (e.g. texture). These quantities are scalar, vector or tensor. The allowable operations are of two kinds: the operations that are problem independent such as read and write and those that are problem dependant such as object deformation, diffusion and optical flow. To summarize, the image is defined by the support, quantities and allowable operations. The latter three iterns will be defined in detail in the following description.

Image Support

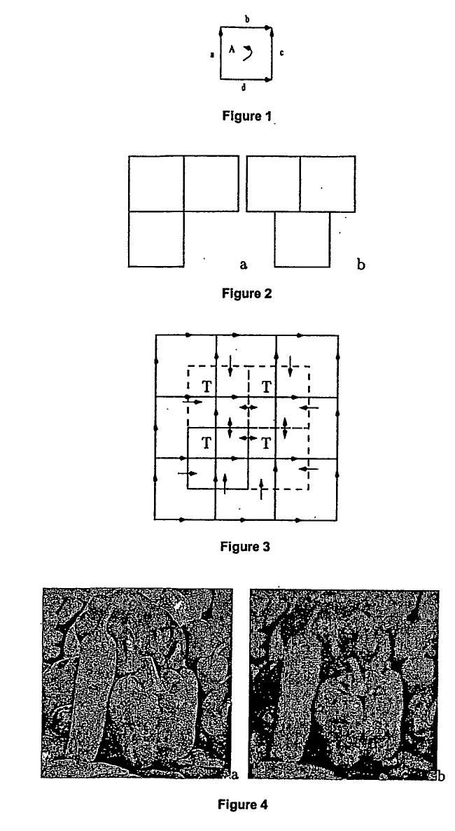

Often, discretization of an image is achieved via a cubic tessellation. For example, a 2D (two-dimensional) image support is formed by unit squares commonly called pixels. Similarly, a 3D (three-dimensional) image is a tessellation of unit cubes commonly called voxels. More generally, the illustrative embodiments of the present invention will consider the image in n dimensions as a set of unit n-cubes, which are commonly called n-pixels. When n=0, the image is a set of points; when n=1, a set of edges; when n=2, a set of squares; when n=3 a set of cubes, and so on. Any two n-pixels are either disjoint or intersect through a common i-pixel, where i<n. This subdivision of the image support is not unique. Several other geometrical forms such as, for example, triangles or hexagons can be used. It has been proven that the topological features of the image support do not depend on the subdivision used [13]. The cubical subdivision is commonly used in image processing and computer vision and will therefore be used in the non-restrictive illustrative embodiments of the present invention. One does not need to explicitly define an orientation of pixels. Indeed, the definition of a pixel as a product of intervals in a certain order coupled with the natural order of real numbers imposes an orientation on each coordinate axis and also on the canonical basis of Rⁿ (see FIG. 1).

Formally, a pixel σ ε Rⁿ as a geometric entity is translated into an algebraic structure as follows:
σ=I₁×I₂× . . . ×Iₙ (1)
where x is the Cartesian product and Iᵢ is either a singleton or an interval of unit length with integer endpoints; i.e., Iᵢ is either the singleton {k}, in which case it is said to be a degenerate interval, or the closed interval [k,k+1] for some integer k. The number q ε {0,1, . . . ,n} of non-degenerate intervals in Equation (1) is, by definition, the dimension of σ, which will be referred to as a q-pixel. For q≧1, let j={k₀,k₁, . . . ,k_{q-1}} be the ordered subset {1,2, . . . ,n} of indices for which Iₖ_{ⱼ}=[aⱼ,bⱼ] is a non-degenerate interval. Define
Aₖ_{ⱼ}σ=I₁× . . . ×Iₖ_{ⱼ}₋₁×{aⱼ}×Iₖ_{ⱼ}₊₁× . . . ×Iₙ
and
Bₖ_{ⱼ}σ=I₁× . . . ×Iₖ_{ⱼ}₋₁×{bⱼ}×Iₖ_{ⱼ}₊₁× . . . ×Iₙ
where Aₖ_{ⱼ}σ and Bₖ_{ⱼ}σ are, respectively, the front (q−1)-face and the back (q−1)-face of σ. Each of these (q−1)-faces is a (q−1)-pixels. These faces are then called (q−1)-faces of σ. In the same manner, one can define the (q−2)-faces, . . . , down to the 0-faces of σ. FIG. 1 shows a 2-pixel A, with its 1-faces a, b, c, d. The 0-faces of A are the vertices that are not represented here for the sake of clarity of the picture. The boundary of the q-pixels σ enables the writing of the relationship between a q-pixels and its (q−1)-faces in algebraic form. By definition this is the alternating sum of its (q−1)-faces, i.e.

$${\partial }_{q} σ = {\sum }_{i = 0}^{q - 1} {( - 1 )}^{i} ( {B}_{{k}_{i}} σ - {A}_{{k}_{i}} σ ) \qquad ( 2 )$$

For example, the boundary of A in FIG. 1 is given by the following relation:
∂₂σ=(−0×[0,1]+1×[0,1])−([0,1]×0−[0,1]×1)=(c−a)+(d−b).

So far, the pixel, its faces, and the association between them have been defined geometrically and algebraically. Now, the image support will be defined as a geometrical entity, called a cubical complex, and then its algebraic structure will be written. A cubical complex K in Rⁿ is a collection of q-pixels where 0≦q≦n such that:
Every face of a pixel in K is also located in K; and
The intersection of any pair of two pixels of K is either empty or formed by a common face of both pixels of the pair.

The first condition implies that all faces of a pixel belong to the cubical complex.

The second condition concerns the organization of the cubical complex. If the intersection of two pixels is empty, then the image support is formed by one or more connected components. This condition provides an image support that is more general than existing definitions since it allows a formal specification of a cubical complex that is formed either by one or more image supports (e.g., an image sequence) or by several distinct binary objects. When the intersection is a face, certain geometrical configurations of the complex are ruled out. For example, FIG. 2a illustrate a subdivision that is a cubical complex and FIG. 2b illustrates a subdivision that is not a cubical complex.

The dimension of the cubical complex K is, by definition, the largest number q for which K contains a q-pixel.

As in the case of the q-pixel, the cubical complex can be written in algebraic form. Given a topological space X ⊂ Rⁿ in terms of a cubical complex, the set of all q-pixels of X is denoted E_{q}={σ_{q}¹, . . . ,σ_{q}^{N}^{_{q}}}. A q-chain in X is a formal sum of integer multiples of elements of E_{q}. More precisely, it is a linear combination

$${λ}_{1} {σ}_{q}^{1} + ⋯ + {λ}_{{N}_{q}} {σ}_{q}^{{N}_{q}} \qquad ( 3 )$$

where λ₁, . . . ,λ_{N}_{_{q}} are integers. For example, in FIG. 1, a−c+d−b is a 1-chain. Two q-chains are added by adding corresponding coefficients. The set of q-chains can be given the structure of a free Abelian group with basis E_{q}, usually denoted by C_{q}(X). Since only finite complexes will be considered, the groups C_{q}(X) are finitely generated and C_{q}(X)=0 if q is greater than the dimension of the complex; naturally, C_{q}(X)=0 if q<0.

To define the chains that are associated With the faces of pixels of a cubical complex, Equation (2) is extended by linearity to all q-chains to obtain the boundary map ∂_{q}:C_{q}(X)→C_{q-1}(X). Note that ∂₀=0 since C₋₁(X)=0. The boundary map satisfies the following property [9]:
∂_{q} ∘ ∂_{q+1}=0 (4)

To summarize, the discrete image support of any dimension n is formed by n-pixels. Unlike conventional image models, the n-pixel is a dimensional geometric entity formed by other geometric entities called faces. The geometrical n-pixel is translated into a recurrent algebraic structure, more reliable for mathematical handling. All n-pixels of the image support form a cubical complex, a geometrical entity that is translated into an algebraic structure called the chain. The association between the n-pixel and its faces, and hence between chains of successive dimensions is given by a boundary operator. It should be noted that the use of any other geometrical primitive such as a triangle or hexagon for subdividing the image support affects the computational complexity of the derived algorithms, but it affects neither the topological features of the image support nor the computation rules for these features.

Image Quantities

In the foregoing description, the concept of the finite cubical complex was introduced to give an algebraic description of the discrete image support. A similar formulation is needed to describe the image field (scalar, vector, matrix) over the discrete image support. For this purpose, let's return to the above described chain concept to give a more general definition. Considering a cubical complex K of dimension n, each q-pixel (q≦n) of K is associated to a coefficient in the ring (A,+,*), where the elements may be scalars (gray level), vectors (color, gradient), matrices (Hessian), etc. The chain is the formal sum

$${\sum }_{i} {λ}_{i} {c}_{q}^{i}$$

where λᵢ is a coefficient in (A,+,*), and the generators c_{q}ⁱ, ∀i form a basis of an Abelian group. The chain can be seen as a vector [λ₁, . . . ,λ_{N}_{_{q}}]^{T}, where N_{q} is the number of generators used. Consequently, two chains can be summed by adding their coefficients and multiplied using the scalar product. The addition and multiplication are taken according to the definition of a ring. Moreover, one cam define a null chain (respectively unit chain) whose coefficients are all equal to the null (respectively unit) element of the + (respectively *) operation of (A,+,*). Consequently, q-chains define an image model that has attractive computational properties since they form a rich algebraic structure, the module (i.e, a vector space defined on a ring).

To briefly show how to use the chain model in image processing, a simple illustrative example concerning any global transform of the image such as histogram equalization or thresholding is presented. The chain coefficients are the gray levels. The formal expression of the global transform implies two applications: \overline{H}: (ε_{A},+,*)→(ε_{A},+,*) and H: (A,+,*)→(A,+,*), where (ε_{A},+,*) is a module. They are defined by

$$\overline{H} ( {\sum }_{i} {λ}_{i} {c}_{i} ) = {\sum }_{i} H ( {λ}_{i} ) {c}_{i} .$$

The drawback of chain-based image models is that the physical or mathematical quantities and the image support are described together in a formal sum. Consequently, the chain coefficients combine mathematical or physical quantities, pixel orientation, and possibly other quantities such as weights associated with pixels. For example, there is ambiguity in the interpretation of the sign of λᵢ: it may be due to the orientation, the physical quantities, the weights or their multiplication. This image model can be considered adequate, especially in physics [14], engineering and computer graphics [11, 5], where chains have been used to model quantities. However, this illustrative embodiment of the present invention proposes to refine this quantity model to overcome the confusion produced by the chain coefficients.

To reflect only the geometry of the image support (e.g., orientation and multiplicity), what follows will consider q-chains with integer coefficients. We are looking for an application F_{q}: C_{q}(X)→(B,+,*), which associates a global quantity (energy, gray level, color, flux, tensor, etc.) with all q-pixels, where q≦n and (B,+,*) is a ring. As in the case of the chain-based image model, for two adjacent q-pixels c_{q}¹ and c_{q}², F_{q} must satisfy F_{q}(λ₁c_{q}¹+λ₂c_{q}²)=λ₁F_{q}(c_{q}¹)+λ₂F_{q}(c_{q}²), which means that the sum of the quantities generated within each q-pixel is equal to the quantities generated within the two q-pixels. F_{q} can be extended by linearity to any q-chain

$${\sum }_{i} {λ}_{i} {c}_{q}^{i} ,$$

where each λᵢ is an integer, as follows:

$${F}_{q} ( {\sum }_{i} {λ}_{i} {c}_{q}^{i} ) = {\sum }_{i} λ {F}_{q} ( {c}_{q}^{i} ) .$$

F_{q} is called a q-cochain. To illustrate the cochain concept, let us consider a 2-pixel c₂ and a vector field V. A 0-cochain is defined by the value of V at 0-pixels. A 1-cochain is

$${\int }_{\partial {c}_{2}}^{} V \cdot ⅆ s ,$$

the line integral over the faces of c₂. A 2-cochain is

$${\int }_{{c}_{2}}^{} V \cdot ⅆ S ,$$

the surface integral over the 2-pixel c₂, and the “.” the dot product.

To summarize, a cochain allows us to associate quantities with the q-pixels and with the faces thereof. Unlike existing image models, the model according to the illustrative embodiments of the present invention provides a rich structure that allows the definition of both local and global quantities.

Operations

A generic operation that can be instantiated depending on the problem that we are dealing with will now be defined. Having in mind that a q-pixel has 3^{q} faces, the generic operation should specify the algebraic relationship between the quantities (i.e., cochains) associated with these faces. Based on the linearity principle, the quantity of a given q-pixel is transferred to its cofaces with the same or opposite sign, according to the agreement of its orientation and the orientation of its cofaces. The quantities that are transferred to the (q+1)-pixels by its faces are summed. More formally, it should be reminded that the relationship between the (q−1)-chain and the q-chain is given by the boundary operator. Similarly, the relationship between the q-cochain and the (q+1)-cochain is given by the coboundary operator δ_{q}: C^{q}→C^{q+1}, where C^{q} is the Abelian group of q-cochains. Given a (q+1)-chain c, this coboundary operator is defined by:
δ_{q}F_{q}(c)=F_{q}(∂_{q+1}c) (5)

The capacity of the cochain and the coboundary to model a given problem will now be discussed. The cochain is a linear application and should fulfill the coboundary requirement of Equation (5). Thus a question concerns the limits in modeling a given quantity. It is difficult to answer this question for the general case. Much investigation is needed first. In the present illustrative embodiment, this question is only answered by identifying several problems that can be modeled by the cochain and coboundary. Certain problems such as convolution and its applications (smoothing, numerical differentiation, high-pass filtering, noise estimation) and the Fourier transform can be modeled by the cochain without approximation since they only require setting the coefficients λᵢ of the cochain to specific values (see [16] for the case of numerical differentiation). Thresholding can be represented by the cochain without approximation since

$$H ( {\sum }_{i} {λ}_{i} {Q}_{i} ) = {\sum }_{i} {λ}_{i} H ( {Q}_{i} ) ,$$

where H: (B,+,*)→(B,+,*). Other problems can be broken down to basic laws, each of which can be described by the topological Equation (5). For example, it has been pointed out [14] that many physics problems can be broken down into basic physical laws such as balance and constitutive laws. As it will be showed herein below, balance law can be written in a discrete form by using the topological Equation (5) without approximation. The constitutive laws cannot be translated in algebraic form without approximation. Usually, they require the link between cochains that belong to different cubical complexes. For example, in the case of dual complexes, two cochains are linked by an algebraic linear system. This transformation is called “codual operation”. More generally, 0-cochains represent local quantities. However, q-cochains (q>1) represent global quantities (e.g., an integral or the summation of a differential form) since they are associated with the algebraic structure of an edge, an area, a volume, etc. Thus, the cochain, coboundary, and codual are generic algebraic structures that can be instantiated by physical or mathematical laws. The exact translation of given problem in terms of q-cochains is possible if one is able to find the basic laws that can be described without approximation by either cochains or the topological Equation (5).

In the previous example, the coboundary can be interpreted as follows: assuming that the vector field is conservative

$$V = Δ v , \qquad {\int }_{{c}_{1}}^{} Δ v \cdot ⅆ s = v ( b ) - v ( a )$$

constitutes a coboundary operator since it may be written as δ₀F₀(c₁)=F₀(∂₁c₁), where a and b are the faces of c₁. Similarly,

$${\int }_{{c}_{2}}^{} div ( V ) ⅆ S = {\int }_{\partial {c}_{2}}^{} V \cdot n ⅆ s ,$$

where n is the outward unit normal vector to ∂c₂, constitutes a coboundary operator since it may be written as δ₁F₁(c₂)=F₁(∂₂c₂). This example shows that the coboundary operator may be an exact discrete representation of the fundamental calculus theorems (line integral and Gauss).

Thanks to the chain, cochain, coboundary and codual concepts, the image model of the illustrative embodiments of the present invention can take into account the mathematical or physical laws related to the application. It can thus be instantiated to the various problems of image processing and computer vision. The underlying computational framework is strongly different form existing frameworks. For example, let us consider physics based problems such as optical flow, diffusion and deformation. Existing frameworks can be summarized as follow: 1) modeling by partial differential equation; 2) resolving the PDE by using numerical analysis scheme or Fourier space.

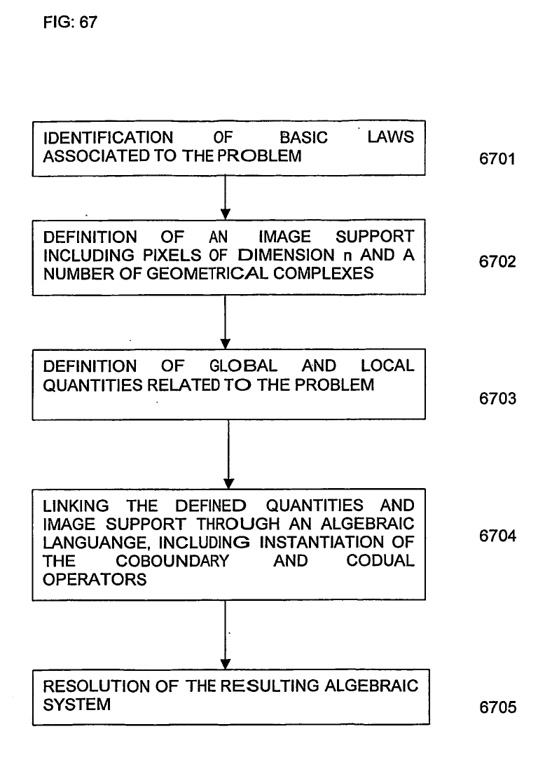

The computational framework, according to the illustrative embodiments of the present invention, can be summarized as follow: 1) identification of basic laws associated to the problem (Block 6701 of FIG. 67); 2) definition of an image support including the number of cubical complexes and the dimension of the cubes (e.g., for the case of a multi-resolution processing) (Block 6702 of FIG. 67); 3) definition of global and local quantities (Block 6703 of FIG. 67); 5) instantiation of the coboundary and codual operators (Block 6704 of FIG. 67); and 6) the resolution of resulting algebraic system (Block 6705 of FIG. 67). The advantages of this framework are described hereinbelow and will be better defined in two practical examples.

To summarize, the coboundary operator links quantities associated with the faces of an n-pixel. Codual operator links quantities associated to complexes of an image. If a given problem can be broken down into basic laws, the cochain and coboundary are the discrete representation of these basic laws. Cochain, coboundary, and codual are generic concepts that can be instantiated by physical or mathematical laws. Thus, they can be used in various computer vision and image processing problems.

### AN ILLUSTRATIVE EXAMPLE

Let us consider the linear isotropic diffusion in gray level images which is a physics-based problem. One can find all details in reference [4]. For the sake of clarity and without loss of generality, the analysis will be limited to considering the 2D global differential equation for heat flow in a homogeneous medium. Let V be a 3D region with boundary S inside the flow. The rate of heat flow across boundary S out of V is given by:

$$\int \int {\int }_{V}^{} σ ( x , t ) ⅆ V = - \int \int {\int }_{V}^{} ∇ \cdot ( λ ∇ 𝒯 ( x , t ) ) ⅆ V \qquad ( 6 )$$

where x is a spatial vector, t represents time, and λ is a positive constant.

To resolve this problem, the image support is defined by a continuous scalar field T, the temperature (i.e., gray level), two dual cubical complexes (i.e., two chains), and three cochains. If only one cubical complex is used, two different orientations are associated with each 1-face. To overcome this problem, two dual complexes (primary and secondary) are used (see FIG. 3). Concerning the use of three cochains, it has been pointed out in reference [4] that this EDP is formed by three basic physical laws. Each cochain is associated with one law. The first is the thermal tension law (also known as Fick's Law), which states that heat flows from regions of higher temperature towards regions of lower temperature. The direction of the gradient ∇T is the direction of the largest increase in temperature; the heat flows in the opposite direction. Formally, this law is written as follows:
g(x, t)=−∇T(x, t) (7)

The primary cubical complex is the support for this balance law. The orientation plotted on this cubical complex is the direction of the path on which the integral is computed. Let us assume that the 0-cochain is the temperature T associated with 0-pixel c₀. A 1-cochain G associated with 1-pixel c₁ is the global thermal tension transferred by the two 0-pixels that are the faces of c₁. Consequently, the topological equation is:
G(c₁)=δ₀T(c₁)=T(∂₁c₁) (8)

By the linearity of cochains, this topological equation is valid for all 1-chains.

The second law, called the heat source law, concerns the net outflow of internal thermal energy at the point x and time t. This is a balance law. It is given by:
σ(x, t)=∇.q(x, t) (9)

When ∇.q(x,t)>0, the outflow is positive and thermal energy must flow away from x. Similarly, if ∇.q(x,t)<0, the inflow is larger than the outflow and thermal energy increases at x. The equilibrium for a diffusion process is attained if ∇.q(x,t)=0.

Let us consider the secondary cubical complex. The orientation plotted on this cubical complex is the direction of the flow. The 2-cochain Σ associated with the 2-pixel c₂ is the global heat transferred by the faces of c₂
Σ(c₂)=δ₁Q(c₂)=Q(∂₂c₂) (10)

This topological equation is valid for all 2-chains. The third law is constitutive (it depends on the medium feature). It makes the link between the flow density law and the heat source law. It is given by:
q(x, t)=λg(x, t) (11)

This equation cannot be discretized exactly, since it involves global quantities defined on two dual complexes. Consequently, the 2-cochain± cannot be computed without approximation from the 1-cochain G. For example, they can be linked as a linear equation system ΛQ=±, where Λ is the coefficient matrix. FIG. 4a gives an example of original image and FIG. 4b and example of image smoothed using this computational scheme.

The data structure associated to the linear diffusion problem is defined by: 1) two dual cubical complexes; 2) two cochains G and Λ for global quantities and a scalar field T; 3) two coboundary operations for balance laws and a codual operation that represents the constitutive law. The framework is summarized as follows: g is approximated by a bilinear polynomial. The cochain G is computed using a line integral. q is computed using the constitutive law in Equation (11). The cochain ± is computed using Gauss's theorem. Finally, a system of linear equations obtained from Equation (11) is obtained where the unknown variables are T. It should be noted that the cochains in Equations (8) and (10) are computed without approximation.

The image model according to the illustrative embodiments of the present invention and described hereinabove may generally be characterized by three major points: 1) the image support and quantities are defined separately and then linked together via algebraic language; 2) the pixel is dimensional and is written in an algebraic form; 3) both local and global quantities are represented by the cochains and coboundary operators.

Each of these specificities will now be discussed to show their straightforward consequences for image processing.

The separability of the image model allows a distinction between image variables and image quantities. The image variables offer numerous possibilities for existing mathematical formulations such as the use of algebraic topology to help in the design of algorithms. For example, binary image algorithms are written as algebraic systems [16]. The well-defined quantities allow the use of physics, vector analysis or differential forms in the design of algorithms. Taking image support and image quantities together, well-known problems such as those of diffusion and optical flow in gray level images can be written as algebraic systems. Furthermore, the transfer of quantities between a given domain and its boundary is straightforward, using the concepts of cochain and coboundary as a general framework. For example, as shown hereinabove, in vector calculus, this transfer is easier thanks to the three fundamental calculus theorems, the line integral, Stokes's theorem, and Gauss's theorem.

Unlike existing image models, by considering the pixel as dimensional primitive the connectivity paradox of the image support is avoided [8]. That, is, the well-known Jordan theorem is fulfilled. Its decomposition into faces and the use of cubical structures such as chains make the dimension of the image explicit. Algorithms designed according to this formalism operate in any dimension. This fact overcomes the traditional limitations that are faced in designing an algorithm, say in one dimension, extending it to two dimensions, and then to three dimensions, and so on. Each extension step may be a difficult task.

The definition of the cochain depends on the problem that is dealt with. Thus, this image model offers real flexibility for the integration of mathematical objects (scalar, vector, tensor) and physical laws (balance, constitutive). Furthermore, the use of global quantities associated with an n-pixel implies noise reduction. In fact, global quantities are computed from the field by using the integral or the discrete summation. As the opposite operation from the differentiation, which enhances high frequencies of the image, the integral performs a smoothing operation. It allows us to reduce the order of the derivative used in an image-processing scheme. Consequently, the introduction of global quantities may allow the use of higher-order derivatives.

Another contribution of the image model according to the illustrative embodiments of the present invention concerns the numerical scheme used to solve nonlinear problems such as the diffusion problem and elastic matching. It should be reminded that, usually, a problem is formulated and then a numerical analysis scheme is used. The numerical analysis scheme may not have been derived for exactly this formulation and many approximations must be made. The explanation of intermediate results is not available. Consequently, no clear idea is available about the convergence of the numerical analysis scheme and the numerical results obtained may be a broad approximation of the desired solution. Based on the problems tackled, it is concluded that in the image model presented here, the numerical scheme is deduced from the problem model with-little or no approximation [4, 12]. In fact, various problems may be broken down into basic laws and then reformulated in terms of cochains and coboundaries. Thus they can be written as linear algebraic systems and solved.

### PRACTICAL EXAMPLE #1

### Physics-Based Resolution of Diffusion and Optical Flow

An alternative to Partial Differential Equations (PDES) will now be described for the solution of three problems in computer vision: linear isotropic diffusion, optical flow and nonlinear diffusion. These three problems are modeled using the heat transfer problem. Traditionally, the method for solving physics-based problems such as heat transfer is to discretize and solve a PDE by a purely mathematical process. Instead of using the PDE, the global heat problem can be decomposed into basic laws. It will be demonstrated that some of the basic laws admit an exact global version since they arise from conservation principles. It will also be showed that the assumptions made on the other basic laws can be made wisely, taking into consideration knowledge about the problem and the domain. The above-described image model will be used to allow encoding of physical laws by linking a global value on a domain with values on its boundary. The resulting algorithm performs in any dimension. The numerical scheme is derived in a straightforward way from the problem modelled. It thus provides a physical explanation of each solving step in the solution.

Background

In recent years, Partial Differential Equations (PDEs) have attracted increasing interest in the field of computer vision. Since PDEs have been the subject of much study by numericians, powerful numerical schemes have been developed to solve them. Consequently, domains such as image enhancement, restoration, multi-scale analysis and surface evolution all benefit greatly from PDEs [25].

One important class of equations governing certain physical processes is the linear elliptic PDE of the general form known as the Helmholz equation:
∇²u(x)+p(x)u(x)=f(x) (12)
where x denotes a vector in the n-dimensional space, u(x) is the dependent variable, ∇² is the Laplacian operator, and p(x) and f(x) are spatial functions. When p(x)=0, this corresponds to the Poisson equation [21, 32] (also known as the non-homogeneous Laplace equation [30, 44]). One of the physical processes governed by Equation (12) is steady-state heat transfer.

In the field of computer vision, Equation (12) may arise from two approaches. The first is variational calculus. As a matter of fact, many problems such as shape from shading [39], surface reconstruction [32, 40] and the computation of optical flow [29] can be formulated as variational problems. The solutions to these variational problems are given by Euler-Lagrange equations, which are in the form of Equation (12) [31, 32]. The second approach is physics-based. For example, diffusion processes arise from heat equations and shock filters from work in fluid mechanics [25]. For both the variational and the physics-based approaches, the resulting PDEs are continuous and have to be discretized.

Traditionally, the discretization of PDEs in computer vision has been done by applying finite difference methods [23, 31, 39, 40]. Equation (12) is solved iteratively using either a direct Fourier-based Poisson solver for each iteration [39], finite elements [24], or spectral methods [32]. Iterative methods such as those in [39] do not ensure convergence unless smoothness is very high [21].

Existing methods for the resolution of problems involving PDEs can be summarized as follows: 1) identification of basic laws; 2) combination of the basic laws in order to write the PDEs; 3) discretization of the PDEs; 4) resolution of the PDEs via a numerical method.

This process, which has been used in various fields of application, is purely mathematical. Consequently, it has the following drawbacks: 1) Some quantities involved in the solution process do not have a physical interpretation; 2) This lack of interpretation is manifested in intermediate solutions involving iterative processes and since these solutions cannot be physically explained, discovery of the optimal solution cannot be ensured in an optimal time.

Solution

To overcome these drawbacks, an alternative to PDE resolution in the context of the heat transfer problem is proposed and will be described hereinbelow.

Generally; basic laws in physics-based problems are combined into a global conservation equation [42] that is valid on-the whole body or a part of it. A local conservation equation (PDE) is then obtained by considering the particular case of a part of a body reduced to a point.

In discrete problems such as those encountered in computer vision, the continuous domain is subdivided into many sub-domains in which there is only one value available, which can be considered as a global value. Therefore, instead of using the PDE, this illustrative embodiment of the present invention proposes to use the global conservation equation directly on each sub-domain.

In order to handle these physical laws which link global values at points, lines, surfaces, volumes, etc. the image model with roots in computational algebraic topology described hereinabove is used. This model makes it possible to represent global values on entities of any dimension at the same time.

The above described methodology presents a number of advantages:
1) Many of the basic laws arise out of conservation principles and hence they are valid either at a point (local form as in Equation (12)) or over an entire region (global form). Fundamental theorems of calculus such as the Gauss, Green and Line Integral theorems allow the computation of the coboundary operator without any approximation.
2) Some laws require approximations that can be performed wisely, taking into account knowledge about the problem and the domain.
3) The intermediate results have a physical explanation because they represent physical quantities. For that reason, every step has a physical interpretation. Thus there are no longer problems of non-optimality of the solution, because we avoid non-temporal iterative methods.
4) As mentioned earlier, this method can be used with other physics based problems by applying the appropriate basic laws.
5) Thanks to the image model, the resulting algorithm performs in any dimension.
6) The computational rules associated with the coboundary operator can be changed without changing the formalism of the operation itself.
7) The same formalism can be used for pixel-based and other types of decomposition of the image (e.g. regions).

In order to validate the method, the equation for steady state heat transfer is resolved in two applications: the linear diffusion and optical flow. These problems generate equations of the form of Equation (12) or its global version. The present methodology can also be used to resolve unsteady heat transfer with no source and we apply it to non-linear diffusion.

Physical Principles (Explanation of the Physical Foundations of the Heat Transfer Problem)

Two interesting particular cases for diffusion and optical flow problems can be distinguished: steady-state heat transfer and unsteady heat transfer with no source.

Two important classes of laws are present: conservation and constitutive laws. Conservation laws are independent of the properties of the material, whereas constitutive laws are specific to them. The physical properties associated with a moving object are energy, work and heat. In what follows, each of these quantities are described.

Energy Modeling

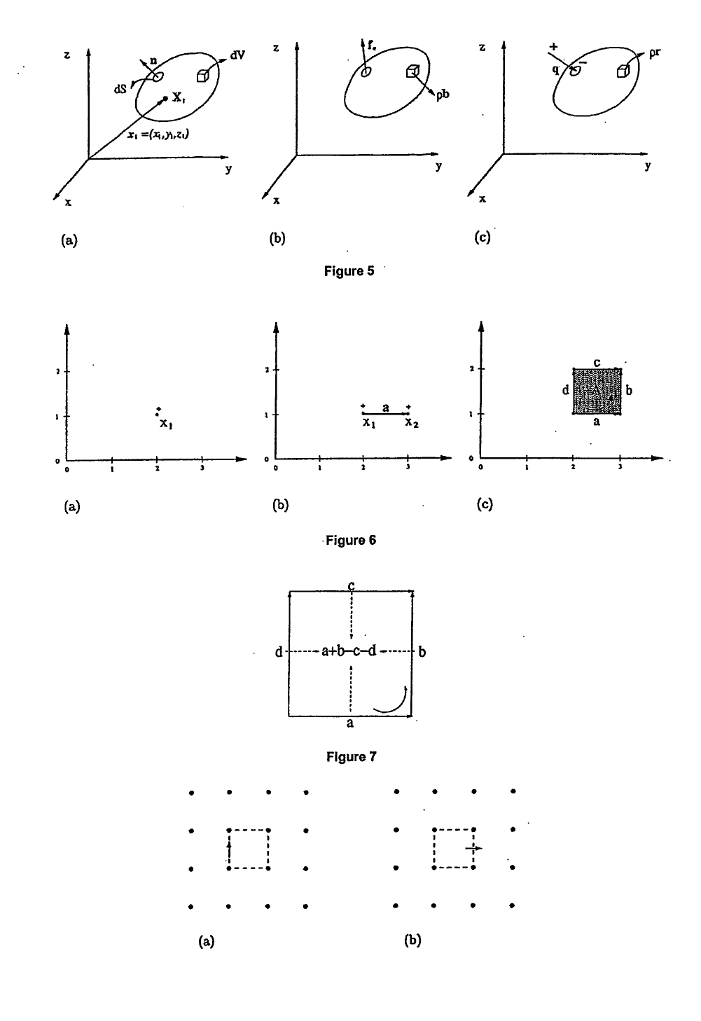

Some quantities for a continuous body occupying a volume V bordered by a surface S in a 3D space will first be defined. Such a body can be said as composed of an infinite number of particles (as many as desired), these particles being the smallest elements [33]. FIG. 5a illustrates such a body. At time t, a particle labelled X occupies a specific position:
x=(x(t), y(t), z(t))

Each particle can move in space, so a velocity vector is associated with it at time t:

$${v}^{*} ( X , t ) = \frac{ⅆ x}{ⅆ t} = v ( x , t )$$

Physical quantities can be associated with a particle labelled X (material description) or a position x in space (spatial description). For example, v*(X,t) is the material description of the velocity of particle X and v(x,t) is the spatial description of the particle located at position x. For the present purpose, spatial descriptions are used to derive the heat transfer equation. Vector n(x,t) is the outward direction of the surface at point x.

The mass Δm of a small amount of volume ΔV of a body is a measure of its inertia (tendency to resist motion). The term mass density, ρ is used to denote the following quantity:

$$ρ = {lim}_{Δ V \to 0} \frac{Δ m}{Δ V}$$

ρ(x,t) is thus the mass density of the particle located at x at time t.

Two kinds of energy are associated with a moving object: kinetic and internal energy. Kinetic energy is a measure of the state of motion of a body: the faster the body moves, the greater its kinetic energy [28]. Because it is a measure of inertia, kinetic energy also fakes the mass into account. For a particle located at x at time t, the kinetic energy is thus defined as

$$K ( x , t ) = \frac{1}{2} ρ ( x , t ) ( v ( x , t ) \cdot v ( x , t ) )$$

where “·” is the dot product. To obtain the kinetic energy for the entire body at time t, K(x,t) is integrated over the volume V:

$$K ( t ) = \frac{1}{2} \int \int {\int }_{V}^{} ρ ( x , t ) ( v ( x , t ) \cdot v ( x , t ) ) ⅆ V$$

where dV is an infinitesimal amount of the volume V.

Internal energy is a measure of the state of temperature of a body. The hotter the body, the greater its internal energy. At time t, each particle has an internal energy density ε(x,t) associated with it. The internal energy density is proportional to the temperature of the particle T(x,t) with a material-specific heat constant c; that is, ε(x,t)=cT(x,t). For the entire body, the total internal energy is integrated over the volume V:

$$E ( t ) = \int \int {\int }_{V}^{} ρ ( x , t ) ɛ ( x , t ) ⅆ V \qquad ( 13 )$$

The total energy for the body can now be defined as K(t)+E(t).

Work Modeling

Let us suppose that a body is submitted to an external force fₑ(x,t) (e.g. a traction force) and an internal density force b(x,t) (e.g. gravity). FIG. 5b presents the action of external and internal forces. Work is defined as the energy transferred to a body by means of a force acting on the body [28]. Work is negative when the energy is transferred from the body. Suppose that F(x) is an internal or external force that is constant over time, acting on a particle located at x during an amount of time t. This force will produce a displacement of the particle to position x₁. This displacement is Δx=x₁−x. The work w(F, x) done by this force during this time is:
w(F, x)=F(x)·Δx
and the instantaneous power P(x, t) is:

$$\begin{matrix}P ( x , t ) = {lim}_{Δ t \to 0} \frac{w ( F , x )}{Δ t} \\ = F ( x ) \cdot {lim}_{Δ t \to 0} \frac{Δ x}{Δ t} \\ = F ( x ) \cdot \frac{ⅆ x}{ⅆ t} \\ = F ( x ) \cdot v ( x , t )\end{matrix}$$

External forces act essentially on the surface of the body. The instantaneous work Pₑ(t) done by the external forces on the entire body is thus the result of the integration of the external power over the surface:

$${P}_{e} ( t ) = \int {\int }_{S}^{} {f}_{e} ( x , t ) \cdot v ( x , t ) ⅆ S$$

where dS is an infinitesimal part of the surface of the body.

Defining b(x, t) as the internal density force, the internal force is thus ρ(x, t)b(x, t). The rate of work over time done by the internal forces on the entire body is obtained by integrating internal work over the volume:

$${P}_{i} ( t ) = \int \int {\int }_{V}^{} ρ ( x , t ) ( b ( x , t ) \cdot v ( x , t ) ) ⅆ V$$

The total work is thus P(t)=Pₑ(t)+Pⱼ(t)
Heat Modeling

Heat can be defined as the energy transferred to a body owing to a difference in temperature. The heat flow density vector q(x, t) is a measure of the rate of heat conducted into the body per unit area per unit of time. How q(x, t) is defined will be explained later. The external heat addition rate over time is the amount of heat coming from outside the body and entering by its surface. It is computed by projecting q(x, t) onto the inward normal vector (−n(x, t)) and integrating this projection over the surface:

$${Q}_{e} ( t ) = \int {\int }_{S}^{} q ( x , t ) \cdot ( - n ( x , t ) ) ⅆ S \qquad ( 14 )$$

Now if a body has a rate of heat generation per unit of volume and time r(x, t), the internal rate of heat addition over time is computed by integrating r(x, t) over the volume:

$${Q}_{i} ( t ) = \int \int {\int }_{V}^{} ρ ( x , t ) r ( x , t ) ⅆ V$$

FIG. 5c shows q(x, t) and r(x, t). To simplify, the source σ(x, t) is defined as the rate of heat generated in a particle located at x per unit of volume and time:
σ(x, t)=ρ(x, t)r(x, t) (15)

In many cases, this source is known. However, it could also be a linear function of the temperature: σ(x, t)=a(x, t)+b(x, t)T(x, t) [38]. The total rate of heat addition over time is thus:
Q(t)=Qₑ(t)+Qᵢ(t)
Energy Conservation Law

A class of equations in continuum mechanics are those describing the conservation (equilibrium) principles. They express the conservation of certain physical quantities (mass, momentum, energy, etc.) over an entire body and as such they take the form of global equations over the whole body or a part of it [33].

Conservation principles can be seen intuitively as follows: the change in the total amount of a physical quantity inside a body is equal to the amount of this quantity entering or leaving the body (through the boundary) and the amount generated or absorbed within the body. These laws are applicable for all continuous materials, moving and stationary, deformable and non-deformable, and must always be satisfied. The global conservation equations can then be used to derive their local counterparts, called the associated field equations, which are valid at each point of the body including its borders.

The first law of thermodynamics, which is relevant for the understanding of the heat transfer equation will now be discussed. This law involves both kinetic and internal energies and states that the total variation of energy in a body (or a part of a body) is the result of the time rate of work and the rate of heat addition combined:

$$\frac{ⅆ}{ⅆ t} ( E ( t ) + K ( t ) ) = P ( t ) + Q ( t ) . \qquad ( 16 )$$

For heat transfer, the only interest resides in the case of immobile bodies, that is v=(0,0,0), n(x,t)=n(x) and ρ(x,t)=ρ(x). Equation (16) thus becomes:

$$\frac{ⅆ}{ⅆ t} \int \int {\int }_{V}^{} ρ ( x ) ɛ ( x , t ) ⅆ V = \int {\int }_{S}^{} - ( q ( x , t ) \cdot n ( x , t ) ) ⅆ S + \int \int {\int }_{V}^{} σ ( x , t ) ⅆ V$$

which now states that the thermal energy variation in a body is due to internal heat production added to the heat flowing into the body. Using the divergence theorem for Qₑ [33] and recalling that ε(x,t)=cT(x,t), we obtain the thermal energy conservation law:

$$\int \int {\int }_{V}^{} ρ ( x ) c \frac{ⅆ}{ⅆ t} T ( x , t ) ⅆ V = \int \int {\int }_{V}^{} - ∇ \cdot q ( x , t ) ⅆ V + \int \int {\int }_{V}^{} σ ( x , t ) ⅆ V \qquad ( 17 )$$

where ∇. is the divergence operator. To simplify, let us define the temperature variation

$$h ( x , t ) = \frac{ⅆ}{ⅆ t} T ( x , t ) .$$

Equation (17) is a conservation equation and is thus valid over the entire body, a part or a point of this body. Consequently, the integral signs can be taken off:

$$\underbrace{c ρ ( x ) h ( x , t )}_{{Thermal energy}_{variation}} = \underbrace{- ∇ \cdot q ( x , t )}_{{Rate of heat}_{entering}} + \underbrace{σ ( x , t ) .}_{{Rate of}_{{heat}_{generation}}} \qquad ( 18 )$$

This equation Is said to be local, whereas Equation (17) is said to be global. The thermal energy variation is called the unsteady term, the rate of heat entering is called the diffusion term and the rate of heat generation is called the source term.

Based on Equation (18), two cases are be considered: the steady state case and the unsteady case with no source. The term steady simply means that there is no variation of the thermal energy of the system over time. That is, the left side of Equation (18) is null:
cρ(x)h(x, t)=0 (19)

This implies that the heat diffusion compensates for the internal heat production:
∇·q(x, t)=σ(x, t) (20)

In the unsteady case with no source we have:
σ(x, t)=0 (21)
which means that the time variation of thermal energy is explained by the heat diffusion alone:
cρ(x)h(x, t)=−∇·q(x, t) (22)
Constitutive Principles

In Equation (18), there are three unknown variables: ρ(x), h(x,t) and q(x,t). Let's look at the example of q(x,t). Suppose that we can measure the time variation of the thermal energy (left side of the equation) and also of the temperature T. We know that q(x,t) is related to the temperature, but since different materials usually have different diffusion properties, the missing equation q(x,t)=f(T,x,t) must depend on properties of the material we are studying, such as its homogeneity and type of diffusivity. Consequently, the system of equations contains more unknown variables than equations and the function f(T,x,t) must be added to the system formed by Equation (18). This is due to the difference in material properties. Different materials behave differently, but are subject to the same conservation laws. Constitutive equations such as f(T,x,t), which reflect the internal constitution of materials, allow us to complete the system of equations.

Decomposition Into Basic Laws

As indicated in the foregoing description, conservation equations are always valid regardless of the materials, whereas constitutive equations are dependent on their properties. When solving directly PDEs like Equation (18) in a discretized context with methods such as the finite differences approach, one makes global assumptions about the time and space behavior of the diffusion, energy variation and source terms without taking into account the nature of the basic laws underlying the problem. Some of these do not require any approximation since they come from conservation principles. Also, a more physically realistic solution can be obtained by choosing a proper approximation for each basic law arising from a constitutive principle. Consequently, we propose to decompose the terms of Equation (18) into basic laws. This equation can be broken down into one constitutive and two conservative laws for the steady state case. In the unsteady case, an additional constitutive and another conservative law must also be considered. Note that since the source term is often known, it will not be decomposed. Recalling that the diffusion term α(x,t) is the rate of heat entering the particle located at x at time t, then:
α(x, t)=−∇·q(x, t) (23)
is a first basic conservation law.

The second conservation law concerns the thermal tension. We first define the thermal tension vector g(x,t) as the vector representing the direction and magnitude of the greatest temperature decrease at a fixed time t. As g(x,t) is source-oriented (from hot to cold), a minus sign must be inserted before ∇T(x,t) which represents the direction and magnitude of the greatest temperature increase:
g(x, t)=−∇T(x, t) (24)
This equation is a second basic law. Since the thermal tension is the gradient of a scalar field, it is by definition a conservative field in space. It can be said that −T(x,t) is the potential field of g(x,t) [26, 41].

The third law is a constitutive law. The heat flow density q(x,t) is defined as the quantity and the direction of the heat flowing into the particle located at point x at time t. It is represented by a vector and greatly depends on the behavior of the material. In the case of uniform, homogeneous materials, it has been proven experimentally by Fourier [20, 27] that q(x,t) is directly proportional to the difference of temperature relative to neighbors of this particle:
q(x, t)=λg(x, t) (25)
where λ is a material-specific thermal conductivity constant. The value of λ is known for many types of materials. Equation (25) is called the Fourier heat conduction law. For a non-homogeneous material, we consider that it has the behavior of a homogeneous material on an infinitesimal patch, but the conductivity changes with each patch; that is:
q(x, t)=λ(x, t)g(x, t)

For the unsteady case, the fourth basic law is:
ε(x, t)=cρ(x)h(x, t) (26)
where ε(x,t) is the thermal energy variation (the unsteady term). This equation is a constitutive one because it involves ρ(x), which is material-dependent.

Finally, the fifth basic law is related to the temperature variation and is a conservation law:

$$h ( x , t ) = \frac{ⅆ}{ⅆ t} T ( x , t ) \qquad ( 27 )$$

Considering only the temperature Tₓ(t) of the particle located at x, we reduce the basic law to a 1-dimensional equation and we can thus say that Tₓ(t) is a conservative field in time-space.

To summarize, three basic laws for the diffusion term of equation (18) have been defined, that is:
α(x, t)=−∇·q(x, t)
q(x, t)=λg(x, t)
g(x, t)=−∇T(x, t)

There are also two additional basic laws for the unsteady term, that is:
ε(x, t)=cρ(x)h(x, t)

$$h ( x , t ) = \frac{ⅆ}{ⅆ t} T ( x , t )$$

Combining all these elements, the following relation is obtained:

$$c ρ ( x , t ) \frac{ⅆ}{ⅆ t} T ( x , t ) = ∇ \cdot ( λ ∇ T ( x , t ) ) + σ ( x , t ) \qquad ( 28 )$$

Discrete Representation of Images

Some algebraic tools used to model images will now be recalled from the above description. An image is composed of two distinctive parts: the image support (pixels) and some field quantity associated with each pixel. This quantity may be scalar (e.g. gray level), vectorial (e.g. color, multispectral, optical flow) or tensorial (e.g. Hessian). The image support is modelled in terms of cubical complexes, chains and boundaries as described in the foregoing description. With these concepts, it is possible to give a formal description of an image support of any dimension. For quantities, the concept of cochains has been introduced, these cochains being representations of fields over a cubical complex. For the use of these concepts in image processing, see [16].

As discussed hereinabove, an image is a complex of unit cubes usually called pixels. A pixel γ ⊂ Rⁿ is a product:
γ=I₁×I₂× . . . ×Iₙ
where Iⱼ is either a singleton or an interval of unit length with integer endpoints. Thus Iⱼ is either the singleton {k} and is said to be a degenerate interval, or the closed interval [k, k+1] for some k ε Z. The number q ε{0,1, . . . ,n} of non-degenerate intervals is by definition the dimension of γ, which is called a q-pixel. FIGS. 6a-6c illustrate three elementary pixels in R². For q≧1, let J={k₀,k₁, . . . ,k_{q-1}} be the ordered subset {1,2, . . . ,n} of indices for which Iⱼ_{ₖ}=[aⱼ,bⱼ] is non-degenerate. Let us define:
Aₖ_{ⱼ}σ=I₁× . . . Iₖ_{ⱼ}₋₁×{aⱼ}×Iₖ_{ⱼ}₊₁× . . . ×Iₙ
and
Bₖ_{ⱼ}σ=I₁× . . . Iₖ_{ⱼ}₋₁×{bⱼ}×Iₖ_{ⱼ}₊₁× . . . ×Iₙ

The Aₖ_{ⱼ} and the Bₖ_{ⱼ} are called the (q−1)-faces of σ. One can define the (q−2)-faces, . . . , down to the 0-faces of σ in the same way. The faces of γ different from γ itself are called its proper faces.

By definition, a natural orientation of the cube is assumed for each pixel. Suppose that γ denotes a particular positively oriented q-pixel. It is natural to denote the same pixel with opposite orientation by −γ. Examples of orientations are given in FIGS. 6a-6b. A cubical complex in Rⁿ is a finite collection K of q-pixels such that every face of any pixel of the image support is also a pixel in K and the intersection of any two pixels of K is either empty or a face of each of them. For example, traditional 2D image models only considered pixels as 2D square elements. The definitions presented above allow us to consider 2-pixels (square elements), 1-pixels (line elements) and 0-pixels (point elements) simultaneously.

In order to write the image support in algebraic form, the concept of chains is introduced. Any set of oriented q-pixels of a cubical complex can be written in algebraic form by attributing to them the coefficient 0,1 or −1, if they are not in the set or if they should or should not be taken with positive orientation, respectively. In order to represent weighted domains, arbitrary integer multiplicity is allowed for each q-pixel.

Given a topological space X ⊂ Rⁿ in terms of a cubical complex, we get a free abelian group C_{q}(X) generated by all the q-pixels. The elements of this group are called q-chains and they are formal linear combinations of q-pixels [16]. A formal expression for a q-chain c_{q} is

$${c}_{q} = {\sum }_{{γ}_{i} ∈ K} {λ}_{i} {γ}_{i}$$

where λᵢ ε Z.

The last step needed for the description of the image plane is the introduction of the concept of a boundary of a chain. Given a q-pixel γ, we define its boundary ∂γ as the (q−1)-chain corresponding to the alternating sum of its (q−1)-faces. The sum is taken according to the orientation of the (q−1)-faces with respect to the orientation of the q-pixel. A (q−1)-face of γ is said to be positively oriented relative to the orientation of γ if its orientation is compatible with the orientation of γ. By linearity, the extension of the definition of boundary to arbitrary q-chains is easy. For instance, in FIGS. 6b and 6c, the boundary of the 1-pixel a is x₂−x₁ and the boundary of the 2-pixel A is a+b−c−d; then a and b are said to be positively oriented with respect to the orientation of A but c and d are said to be negatively oriented with respect to the orientation of A. Let us notice that the boundary of a 1-pixel is always the difference between its boundary points. The boundary can be defined recursively. Given a (q−1chain and a q-chain γ_{q} defined as γ_{q}=γ_{q-1}×[a,b], the boundary of γ_{q} can be recursively written as:
∂γ_{q}=∂γ_{q-1}×[a, b]+(−1)^{(q-1)}(γ_{q-1}×{b}−γ_{q-1}×{a}) (29)

In order to model the pixel quantity over the image plane, an application F that associates a global quantity with all q-pixels γ of a cubical complex is determined and is denoted by <F,γ>. This quantity may be any mathematical entity such as a scalar, a vector, etc. For two adjacent q-pixels γ₁ and γ₂, F must satisfy <F, λ₁γ₁+λ₂γ₂>=λ₁<F, γ₁>+λ₂<F, γ₂>, which means that the sum of the quantity over each pixel is equal to the quantity over the two pixels. The resulting transformation F: C_{q}(X)→R is called a q-cochain and is used as a representation of a quantity over the cubical complex.

Finally, an operator is needed to associate a global quantity with the (q+1)-pixels according to the global quantities given on their q-faces. Given a q-cochain F, we define an operator ∂, called the coboundary operator, which transforms F into a (q+1)-cochain ∂F such that:
<δF, γ>=<F, ∂γ> (30)
for all (q+1 )-chains γ. The coboundary is defined as the signed sum of the physical quantities associated with the q-faces of γ. The sum is taken according to the relative orientation of the q-faces of the (q+1 )-pixels of γ with respect to the orientation of the pixels. FIG. 7 presents an example of the coboundary operator for a 2-pixel.

With this image model in hand, the basic laws described hereinabove will be used to rewrite the global heat transfer equation in algebraic terms [43].

Representation of the Heat Transfer Equation

The process for representing the heat transfer equation in terms of algebraic topology can be summarized as follows. The image support is subdivided into cubical complexes. Basic laws are applied to pixels of various dimensions. These laws involve the computation of global quantities on pixels, expressed as cochains. Some of these laws link global quantities on pixels with, global quantities on their boundaries and hence are expressed as coboundaries. The other laws are expressed as linear transformations between pairs of cochains. The topological formalism of cochain and coboundary is a generic one; that is, it does not offer computational rules. The cochains must be instantiated depending on the problem to be considered.

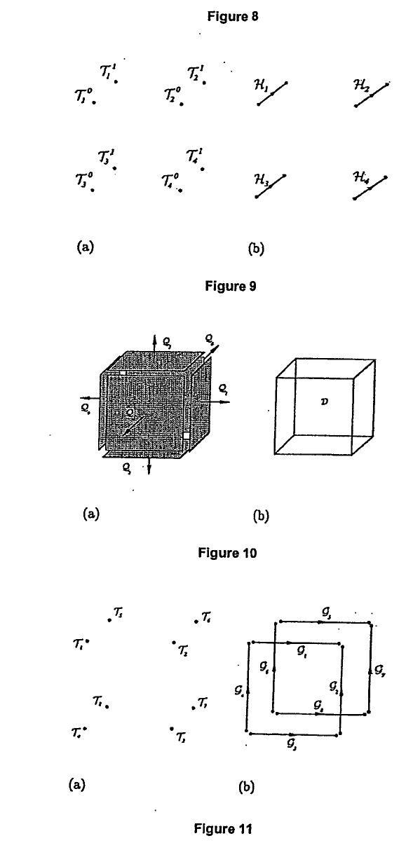

The basic laws presented hereinabove will be reformulated in a topological way and then to give computational rules for cochains in the context of the heat transfer problem. Since we want to represent two kinds of global values over the spatio-temporal image, two complexes will be used. The first complex is associated with global values corresponding to projections onto the tangential part of the domain (e.g. global thermal tension) while the second complex refers to values related to projections onto the normal part of the domain (e.g. heat entering a particle). These two distinct orientations (see FIGS. 8a and 8b give rise to two different complexes.

Global Heat Transfer

Let us assume that an image has n spatial dimensions and r pixels. Suppose also that a time interval [t₀, t₁] can be split into i equal sub-intervals [tₖ, tₖ₊₁], k ε [0, i−1]. Let us consider an n-complex representing the subdivided spatial support of the image K^{s′}. One can consider an (n+1)-complex representing the spatio-temporal support of the image:
K^{s}=K^{sl}×[tₖ, tₖ₊₁], ∀k ε [0, l−1]

Now, let us consider γ_{E}, an (n+1)-pixel of K^{s}, and the following cochain, defined as <ε,γ_{E}>. Thus, we therefore need to define which value to use as cochain ε in the heat transfer problem. Let us define ε as the global energy variation of the (n+1)-pixel γ_{E}:

$$〈 ℰ , {γ}_{E} 〉 = {\int }_{{γ}_{E}}^{} ε ( x , t ) ⅆ {γ}_{E} \qquad ( 31 )$$

where dγ_{E} is an infinitesimal part of the domain represented by γ_{E}. Now, using the global version of Equation (18), we obtain:

$${\int }_{{γ}_{E}}^{} ε ( x , t ) ⅆ {γ}_{E} = {\int }_{{γ}_{E}}^{} α ( x , t ) ⅆ {γ}_{E} + {\int }_{{γ}_{E}}^{} σ ( x , t ) ⅆ {γ}_{E}$$

From this equation, we define two more cochains, representing first, the global diffusion:

$$〈 𝒟 , {γ}_{E} 〉 = {\int }_{{γ}_{E}}^{} α ( x , t ) ⅆ {γ}_{E} \qquad ( 32 )$$

and second, the global source:

$$〈 𝒮 , {γ}_{E} 〉 = {\int }_{{γ}_{E}}^{} σ ( x , t ) ⅆ {γ}_{E}$$

Thus, the following relation is obtained between the three cochains:
<ε, γ_{E}>=<D, γ_{E}>+<S, γ_{E}> (33)

The rules used for cochains ε and D are then decomposed into basic laws. The rule for cochain S is not decomposed since it is assumed that its global value is known on γ_{E}. Let us finally mention that both steady and unsteady heat transfer problems can be considered using Equation (33) by setting respectively, cochains ε and S, to zero.

Global Temperature Variation

Let us consider another n-complex, K^{p′}, representing the subdivided spatial domain of the image. An (n+1 )-complex representing the spatio-temporal image can then be defined as:
K^{p}=K^{p′}×[tₖ, tₖ₊₁], ∀k ε [0, l−1]

Let us consider γ_{H}, a 1-pixel of K^{p} defined as xᵢ×[tₖ,tₖ₊₁], i ε[1,r], kε[0,l−1] where xᵢ is a 0-pixel of K^{p′}. Let us also consider a 0-cochain T and a 1-cochain H such that:
<H, γ_{H}>=<δT, γ_{H}>=<T, ∂γ_{H}> (34)

FIGS. 9a and 9b present examples of cochains T and H for K^{p} of dimension 3.

Applying Equation (29), it is found that the boundary of γ_{H} is ∂γ_{H}=xᵢ×{tₖ₊₁}−xᵢ×{tₖ}. According to the linearity of the cochain, the computational rule relating the global value associated to γ_{H} with the values at its boundary xᵢ×{tₖ} and xᵢ×{tₖ₊₁} is:
<T, ∂γ_{H}>=<T, xᵢ×{tₖ₊₁}−xᵢ×{tₖ}>=<T, xᵢ×{tₖ₊₁}>−<T, xᵢ×{tₖ}> (35)

This equation is general and applies to many problems. To define which values to use as 0-cochain and 1-cochain, let us take the global version of Equation (27) on γ_{H} and apply the fundamental calculus theorem:

$${\int }_{{γ}_{H}}^{} h ( x , t ) ⅆ {γ}_{H} = {\int }_{{t}_{k}}^{{t}_{k + 1}} \frac{ⅆ}{ⅆ t} T ( {x}_{i} , t ) ⅆ t = T ( {x}_{i} , {t}_{k + 1} ) - T ( {x}_{i} , {t}_{k} )$$

Looking at this equation, it can be seen that it is similar to Equation (35). Thus we define T=T(x, t). The location of the unknown temperatures to compute will correspond to the 0-pixels of K^{p}. In order to fulfill Equation (34), the following relation is used:

$$〈 ℋ , {γ}_{H} 〉 = {\int }_{{γ}_{H}}^{} h ( x , t ) ⅆ {γ}_{H} \qquad ( 36 )$$

this relation being called the global temperature variation. These three equations are extended by linearity to a 1-chain of K^{p} defined as γ×[tₖ, tₖ₊₁], where γ is an arbitrary 0-chain of K^{p′}.
Global Energy Variation

We want to link cochains H and ε, representing the global temperature variation and the global energy variation, respectively. For this purpose, a representation of Equation (26) is needed. The two cochains are not from the same cubical complex (H is from K^{p} and ε is from K^{s}), and moreover, Equation (26) is material-dependent; therefore they cannot be linked exactly. However, we can express this link as a linear transformation:
H→ε

Recalling Equation (31), the following relation is obtained:

$$〈 ℰ , {γ}_{E} 〉 = {\int }_{{γ}_{E}}^{} ε ( x , t ) ⅆ {γ}_{E} = {\int }_{{γ}_{E}}^{} c ρ ( x ) h ( x , t ) ⅆ {γ}_{E} \qquad ( 37 )$$

Unfortunately, the value of ρ(x) or h(x, t) is not known at all points of the volume. Consequently, these two fields are approximated over the volume. The approximations are denoted by \tilde{ρ}(x) and \tilde{h}(x, t). For one 1-pixel γ_{H}, defined as xᵢ×[tₖ,tₖ₊₁], the approximation is performed piecewise such that \tilde{h}(x, t) must fulfill Equation (36).

$${\int }_{{t}_{k}}^{{t}_{k + 1}} \tilde{h} ( {x}_{i} , t ) = 〈 ℋ , {γ}_{H} 〉 \qquad ( 38 )$$

Equation (37) thus becomes:

$$〈 ℰ , {γ}_{E} 〉 = {\int }_{{γ}_{E}}^{} c \tilde{ρ} ( x ) \tilde{h} ( x , t ) ⅆ {γ}_{E} = {f}_{e} ( c , ℋ ) = Γ \qquad ( 39 )$$

where dV is an infinitesimal part of γ_{E} which depends on the choice of the approximation functions \tilde{ρ}(x) and \tilde{h}(x, t) and the position of K^{s} with respect to K^{p}.
Global Diffusion

Let us consider an n-cochain Q and an (n+1)-cochain D defined by the coboundary:
<D, γ_{E}>=<δQ, γ_{E}>=<Q, ∂γ_{E}> (40)

FIG. 10 presents examples of Q and D for K^{s} of dimension 3. Let us assume that the n-faces γ_{Q}_{ᵢ} of γ_{E} are positively oriented relative to γ_{E}. According to the linearity of the cochain, the computational rule is:

$$〈 𝒟 , {γ}_{E} 〉 = {\sum }_{{γ}_{{Q}_{i}} ∈ \partial {γ}_{E}} 〈 Q , {γ}_{{Q}_{i}} 〉 \qquad ( 41 )$$

Again, this equation is general; hence a global value is found for the (n+1 )-cochain D, which can be computed by summing the global values at the boundary of γ_{E}. According to Equation (32), the following relation is obtained:

$$〈 𝒟 , {γ}_{E} 〉 = {\int }_{{γ}_{E}}^{} α ( x , t ) ⅆ {γ}_{E}$$

The divergence theorem is applied to this equation to obtain:

$${ℊ}_{t} ( x ) = \frac{1}{4 π t} {ⅇ}^{- ( \frac{{x}^{2} + {y}^{2}}{4 t} )}$$

where n(x, t) is the normal vector to an infinitesimal part of the domain represented by γ_{Q}. This last equation is in the form of a coboundary (Equation (41)), from the following relation is defined:

$$〈 Q , {γ}_{{Q}_{i}} 〉 = {\int }_{{γ}_{{Q}_{i}}}^{} - q ( x , t ) \cdot n ( x , t ) ⅆ {γ}_{{Q}_{i}} \qquad ( 42 )$$

Again, the previous definitions can be extended by linearity to arbitrary (n+1 )-chains of K^{s}. And there is absolutely no approximation in these equations.

Global Thermal Tension

Let us consider a 1-pixel γ_{G} of K^{p} defined as γ×tₖ, k ε8 0,l−1], where γ is a 1-pixel of K^{p′} whose boundary is defined as ∂γ=xⱼ−xᵢ, i,j ε[1,r]. Let us also consider a 0-cochain T and a 1-cochain G defined by the coboundary:
<G, γ_{G}>=<δT, γ_{G}>=<T, ∂γ_{G}> (43)

FIGS. 11a and 11b present examples of cochains T and G for one 3-pixel of K^{p}. The boundary of γ_{G} is ∂γ_{G}=xⱼ×{tₖ}−xᵢ×{tₖ}. According to the linearity of the cochain, the computational rule relating the global value associated with γ_{G} to the values at xᵢ×{tₖ} and xⱼ×{tₖ} is:
<T, ∂γ_{G}>=<T, xⱼ×{tₖ}−xᵢ×{tₖ>=<T, xⱼ×{tₖ}>−<T, xᵢ×{tₖ}> (44)

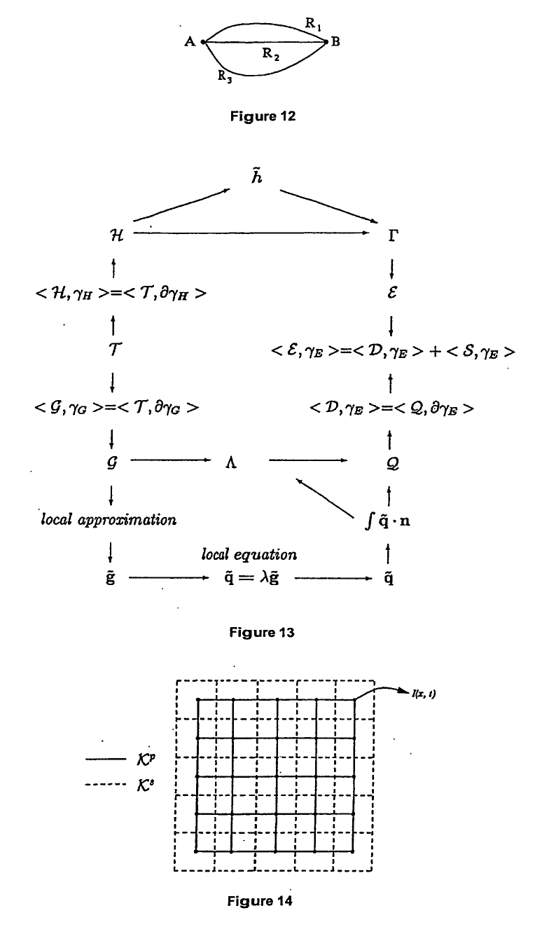

To define which values to use as cochains G and T let us take the global form of Equation (24) on γ_{G}:

$$\begin{matrix}{\int }_{{γ}_{G}}^{} g ( x , t ) \cdot ⅆ {γ}_{G} = {\int }_{{x}_{i}}^{{x}_{j}} g ( x , {t}_{k} ) \cdot ⅆ γ \\ = {\int }_{{x}_{i}}^{{x}_{j}} - ∇ T ( x , {t}_{k} ) \cdot ⅆ γ\end{matrix} \qquad ( 45 )$$

where dγ is an infinitesimal part of γ. Since g(x, t) is a spatial conservative field, we can apply the line integral theorem [26, 41] saying that for a conservative field F(x)=∇f(x) and two points A and B, in an open connected region containing F(x), the integral of the tangential part of F(x) along the curve R joining A and B is independent of the path (FIG. 12):

$$\begin{matrix}{\int }_{A}^{B} F ( x ) \cdot ⅆ {R}_{1} = {\int }_{A}^{B} F ( x ) \cdot ⅆ {R}_{2} \\ = {\int }_{A}^{B} F ( x ) \cdot ⅆ {R}_{3} \\ = f ( B ) - f ( A )\end{matrix}$$

From this theorem, Equation (45) can be rewritten as:

$$\begin{matrix}{\int }_{{x}_{i}}^{{x}_{j}} g ( x , {t}_{k} ) \cdot ⅆ γ = ( - T ( {x}_{j} , {t}_{k} ) ) - ( - T ( {x}_{i} , {t}_{k} ) ) \\ = T ( {x}_{i} , {t}_{k} ) - T ( {x}_{j} , {t}_{k} )\end{matrix} \qquad ( 46 )$$

Looking at Equation (46), it can be seen that it is similar to Equation (44). Thus T=T(x, t) is defined. Consequently, the location of the unknown temperatures to be computed correspond to the 0-pixels of K^{p} which is coherent with the conclusions hereinabove. In order to fulfill Equation (43), we have:

$$〈 𝒢 , {γ}_{G} 〉 = {\int }_{{γ}_{G}}^{} - g ( x , t ) \cdot ⅆ {γ}_{G} \qquad ( 47 )$$

The previous definitions are extended by linearity to 1-chains of K^{p} defined as γ×{tₖ}, where γ is an arbitrary 1-chain of K^{p′}.

Heat Flow Density

The coboundaries <Q, ∂γ_{E}> (Equation (40)) and <T, ∂γ_{G}> (Equation (43)) provide exact global versions of Equation (23) on K^{s} and Equation (24) on K^{p}, respectively. In order to complete the diffusion term, Equation 25, which links local values g(x,t) and q(x,t) is represented. Equation (25) is a constitutive equation and cannot be represented by a topological equation. However, a relation transforming cochain G into cochain Q can be found:
<G, γ_{G}> [symbol] <Q, γ_{Q}>
as a global counterpart for Equation (25). To find this transformation, Equation 42 is recalled:

$$\begin{matrix}〈 Q , {γ}_{{Q}_{i}} 〉 = {\int }_{{γ}_{{Q}_{i}}}^{} - q ( x , t ) \cdot n ( x , t ) ⅆ {γ}_{{Q}_{i}} \\ = {\int }_{{γ}_{{Q}_{i}}}^{} - λ g ( x , t ) \cdot n ( x , t ) ⅆ {γ}_{{Q}_{i}}\end{matrix}$$

this equation relating cochain Q to field g(x,t). Unfortunately, field g(x,t) is not known, so that this equation has to be approximated with a field \tilde{g}(x,t). Let us consider γₙ, an n-pixel of K^{p} defined as γₙ=γₓ×{tₖ}, k ε [O,l−1] where γₓ is an n-pixel of K^{p′}. This approximation is performed piecewise such that for each 1-face γ_{G} of yₙ, \tilde{g}(x,t) satisfies:

$${\int }_{{γ}_{G}}^{} - \tilde{g} ( x , t ) \cdot ⅆ R = 〈 𝒢 , {γ}_{G} 〉 \qquad ( 48 )$$

where dR is an infinitesimal part of the domain represented by γ_{G}. Equation (25) is then applied to obtain \tilde{q}(x,t):
\tilde{q}(x, t)=λ\tilde{g}(x, t)
at all points of the domain. Equation (42) becomes:

$$〈 Q , {γ}_{{Q}_{i}} 〉 = {\int }_{{γ}_{{Q}_{i}}}^{} - \tilde{q} ( x , t ) \cdot n ( x , t ) ⅆ {γ}_{{Q}_{i}} = {f}_{ℊ} ( λ , 𝒢 ) \qquad ( 49 )$$

The transformation that is looked for is thus:
Λ=f_{g}(λ, G)
which depends on the choice of an approximation function \tilde{g}(x,t) and the position of K^{s} with respect to K^{p}.
Boundary Conditions

The decomposition process that has been presented herein is carried out with the assumption that all the needed quantities surrounding a pixel are known. For instance, in the-steady state heat transfer problem, for a particular (n+1)-pixel, the cochain S is known for all other surrounding (n+1)-pixels, that is, there are as many equations as variables.

Unfortunately, this assumption is not verified at the borders of the image. Thus, as in solving the PDE, certain boundary conditions are imposed to specify the gray-level conditions at the boundary of the image. For instance, these conditions may prescribe the values of either cochain T (Dirichlet boundary conditions) or cochain Q (Neumann boundary conditions).

Summary of the Algorithm

The algorithm used to find an expression of the temperatures at time tₖ₊₁ as a function of the temperatures at time tₖ will now be summarized. The input data for this algorithm are the cochain S and the Dirichlet boundary conditions. That is, T is known for all pixels on the boundary of the image, which includes the values at time t₀.
1. Choose the positions for K^{p′} and K^{s′}.
2. Compute ε as a function of H:
   (a) Choose the approximation functions \tilde{h}(x,t) and \tilde{ρ}(x).
   (b) Apply Equation (38) to find \tilde{h}(x,tₖ, tₗ) as a function of H.
   (c) Apply Equation (39) to find the transformation Γ, expressing ε as a function of H.
3. Apply Γ and Equation (34) to find ε as a function of T.
4. Compute Q as a function of G:
   (a) Choose the approximation function \tilde{g}(x,t).
   (b) Apply Equation (48) to find \tilde{g}(x,t) as a function of G.
   (c) Apply Equation (49) to find the transformation Λ, expressing Q as a function of G.
5. Apply Equation (40), Λ and Equation (43) to find D as a function of T.
6. Apply Equation (33) to obtain an equation of the temperatures at time tₖ₊₁ as a function of the temperatures at time tₖ

FIG. 13 presents an overview of the computational scheme.

Applications

Linear Isotropic Diffusion

One of the most direct applications of the heat transfer equation is the isotropic diffusion of gray-level intensities; that is, smoothing. For a 2D image I(x), with x=(x,y), the resolution of the PDE:

$$\frac{\partial }{\partial t} I ( x , t ) = {∇}^{2} I ( x , t ) \qquad ( 50 )$$

is equivalent to the convolution:
I(x, t)=(I*gₜ)(x)
where

$${ℊ}_{t} ( x ) = \frac{1}{4 π t} {ⅇ}^{- ( \frac{{x}^{2} + {y}^{2}}{4 t} )}$$

is a Gaussian with variance σ²=2t [25]. One can see t as the scale of the smoothing operation. Let us assume that the Laplacian image at scale t:
L(x, t)=∇²I(x, t) (51)
is known. One can consider this equation as a steady state heat transfer problem with T(x,t)=I(x,t), σ(x,t)=−L(x,t) and λ=1.

It is desired to solve Equation (51) for local I(x,t) located at the center of each image pixel. Employing the process presented hereinabove, we first position the two cubical complexes representing two subdivisions of the image plane. As stated hereinabove, the primary complex K^{p′} is defined with 0-pixels corresponding to pixel centers. For the sake of simplicity, K^{s′} corresponds to the image pixels; that is, the secondary 2-pixels γₛ are rectangular and symmetrically staggered relative to the 1-pixels of K^{p} and the 1-pixels γ_{q} of K^{s} intersect orthogonally in the centers of the primary 1-pixels. Since there is no variation in steady-state heat transfer over time, the time parameter is dropped. This means that K^{p}=K^{p′}, K^{s}=K^{s′} and the time integral in cochain computation are dropped. It can be seen that the approximation function f_{g} depends on the position of K^{s} with respect to K^{p}.

FIG. 14 shows the two complexes for a 5×5 image. Positioning the 1-faces of K^{s} such as each passes through the center point between two 0-pixels of K^{p} allows us to compute a polynomial function of order 1 with the same accuracy as that obtained using one of order 2 [37, 34].

A global value for the 2-cochain <S, γ_{E}> is needed. If it is assumed that a pixel value represents the global value of intensity, <S, γ_{E}>=−L(x) can be directly set. This assumption is reasonable if image acquisition is considered as a process which accumulates the total number of photons within a global area corresponding to the pixel [22].

An approximation function \tilde{g}(x) is chosen. For simplicity, we assume that \tilde{g}(x) arises from a bilinear approximation, that is:
\tilde{g}(x)=(a+by)·\vec{i}+(c+dx)·\vec{j}

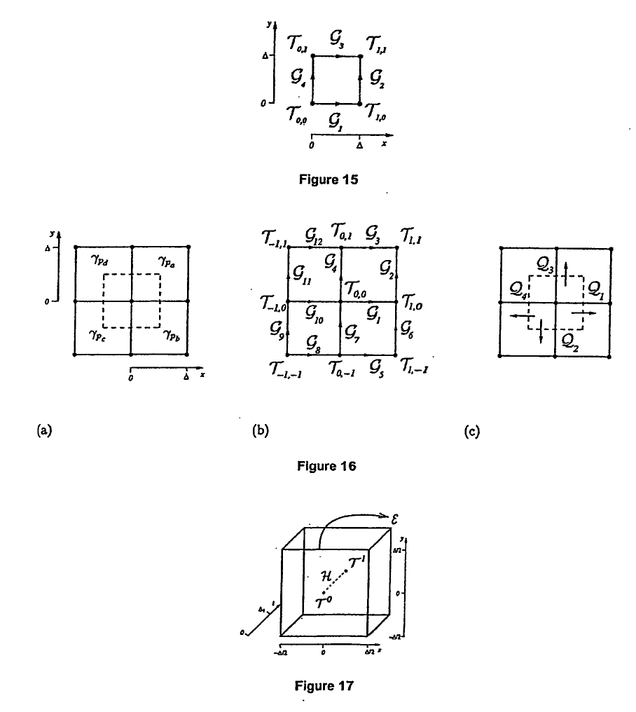

Given a 2-pixel γₚ of K^{p}, \tilde{g}(x) satisfies Equation 48 for each 1-face of γₚ. As an example, let us find the coefficients a, b, c and d for such a pixel defined as in FIG. 15:

$$\begin{matrix}{𝒢}_{1} = {\int }_{0}^{Δ} - \tilde{g} ( x , 0 ) \cdot \vec{i} ⅆ x \\ {𝒢}_{2} = {\int }_{0}^{Δ} - \tilde{g} ( Δ , y ) \cdot \vec{j} ⅆ y \\ {𝒢}_{3} = {\int }_{0}^{Δ} - \tilde{g} ( x , Δ ) \cdot \vec{i} ⅆ x \\ {𝒢}_{4} = {\int }_{0}^{Δ} - \tilde{g} ( 0 , y ) \cdot \vec{j} ⅆ y\end{matrix}$$

from which

$$\begin{matrix}\tilde{g} ( x ) = - \frac{1}{Δ} [ ( {𝒢}_{1} + \frac{( {𝒢}_{3} - {𝒢}_{1} )}{Δ} y ) \cdot \vec{i} + ( {𝒢}_{4} + \frac{( {𝒢}_{2} - {𝒢}_{4} )}{Δ} x ) \cdot \vec{j} ] , \\ x ∈ {γ}_{p}\end{matrix} \qquad ( 52 )$$

is obtained. \tilde{g}(x) is thus a piecewise function of G, but as G is computed from T, and \tilde{g}(x) can also be expressed as a function of T. For each primary 2-pixel, Equation 25 is applied to obtain \tilde{q}(x)=\tilde{g}(x).

The next step is to compute <Q, γ_{Q}> for K^{s} from Equation (49). Each secondary 2-pixel γₛ intersects with four primary 2-pixels, γₚₐ, γ_{pb}, γ_{pc} and γ_{pd}. There are four segments in the approximation function \tilde{q}(x) corresponding to the four primary 2-pixels; that is, \tilde{q}ₐ(x), \tilde{q}_{b}(x), \tilde{q}_{c} (x) and \tilde{q}_{d}(x). FIGS. 16a-16c illustrate γ_{E}. Cochain <Q, γ_{Q}> corresponding to the four 1-faces of γ_{E} is found by:

$$\begin{matrix}{Q}_{1} = {\int }_{0}^{Δ / 2} - {\tilde{q}}_{a} ( Δ / 2 , y ) \cdot \vec{i} ⅆ y + {\int }_{- Δ / 2}^{0} - {\tilde{q}}_{b} ( Δ / 2 , y ) \cdot \vec{i} ⅆ y \\ = \frac{3 {𝒢}_{1}}{4} + \frac{{𝒢}_{3}}{8} + \frac{{𝒢}_{5}}{8} \\ {Q}_{2} = {\int }_{0}^{Δ / 2} - {\tilde{q}}_{b} ( x , - Δ / 2 ) \cdot ( - \vec{j} ) ⅆ x + \\ {\int }_{- Δ / 2}^{0} - {\tilde{q}}_{c} ( x , - Δ / 2 ) \cdot ( - \vec{j} ) ⅆ x \\ = - \frac{3 {𝒢}_{7}}{4} - \frac{{𝒢}_{6}}{8} - \frac{{𝒢}_{9}}{8} \\ {Q}_{3} = {\int }_{0}^{Δ / 2} - {\tilde{q}}_{a} ( x , Δ / 2 ) \cdot \vec{j} ⅆ x + {\int }_{- Δ / 2}^{0} - {\tilde{q}}_{d} ( x , Δ / 2 ) \cdot \vec{j} ⅆ x \\ = \frac{3 {𝒢}_{4}}{4} + \frac{{𝒢}_{2}}{8} + \frac{{𝒢}_{11}}{8} \\ {Q}_{4} = {\int }_{0}^{Δ / 2} - {\tilde{q}}_{d} ( - Δ / 2 , y ) \cdot ( - \vec{i} ) ⅆ y + \\ {\int }_{- Δ / 2}^{0} - {\tilde{q}}_{c} ( - Δ / 2 , y ) \cdot ( - \vec{i} ) ⅆ y \\ = - \frac{3 {𝒢}_{10}}{4} - \frac{{𝒢}_{12}}{8} - \frac{{𝒢}_{8}}{8}\end{matrix} \qquad ( 53 )$$

Using Equation 41, we obtain:
<D, γ_{E}>=Q₁+Q₂+Q₃+Q₄ (54)

Substituting Equation (43) in Equation (53), Equation (53) in Equation (54) and Equation (54) in Equation (33), <S, γ_{E}> can now be expressed as a function of T. As an example, <S, γ_{E}> is presented for a 2-pixel γ_{E}, and defined as in FIG. 16a-16c:

$$\begin{matrix}〈 𝒮 , {γ}_{s} 〉 = - 3 {𝒯}_{0 , 0} + \frac{1}{2} [ {𝒯}_{0 , 1} + {𝒯}_{1 , 0} + {𝒯}_{0 , - 1} + {𝒯}_{- 1 , 0} ] + \\ \frac{1}{4} [ {𝒯}_{- 1 , 1} + {𝒯}_{1 , 1} + {𝒯}_{1 , - 1} + {𝒯}_{- 1 , - 1} ]\end{matrix} \qquad ( 55 )$$

For each non-border pixel (represented by a secondary 2-pixel), an equation in the form of Equation (55) is obtained. For the-border pixels, T=I(x) is set. Solving this system, the smoothed image I(x,t)=T is obtained.

Optical Flow

An indirect application of the heat transfer equation is the computation of optical flow for a 2D image sequence I(x,t), using the Horn and Schunk [29] algorithm. It can be shown that the velocity vector u(x,t)=(u(x,t), v(x,t)) satisfies the following constraint arising from variational calculus (for greater legibility, (x,t) has been dropped):
Iₓ²u+IₓI_{y}v=α²∇²u−IₓIₜ
IₓI_{y}u+I_{y}²v=α²∇²v−I_{y}Iₜ (56)
where α is a weighting factor and Iₓ, I_{y} and Iₜ are the first derivatives of I(x,t) in x, y and t, respectively. Let us rewrite Equation (56) in the following vectorial form:
∇I(∇I·u)=α²∇²u−Iₜ∇I
where ∇²u=(∇²u, ∇²v). Reorganizing the terms of Equation (56), the following equation is obtained:
α²∇²u=∇I(∇I·u)+Iₜ∇I (57)

Taking σ(x, t)=−∇I(∇I·u)−Iₜ ∇I as a heat source, Equation (57) can be seen as a steady state heat transfer equation in which the cochain T corresponds to u(x, t) and λ=α². It can thus be decomposed using the method described hereinabove. The cochain T is u(x, t), and the following relation is obtained:

$$\begin{matrix}- \frac{{I}_{t} ∇ I}{{α}^{2}} = - 3 {𝒰}_{0 , 0} + ∇ I ( ∇ I \cdot {𝒰}_{0 , 0} ) + \\ \frac{1}{2} [ {𝒰}_{0 , 1} + {𝒰}_{1 , 0} + {𝒰}_{0 , - 1} + {𝒰}_{- 1 , 0} ] + \\ \frac{1}{4} [ {𝒰}_{- 1 , 1} + {𝒰}_{1 , 1} + {𝒰}_{1 , - 1} + {𝒰}_{- 1 , - 1} ]\end{matrix}$$

For the same reasons as in the linear diffusion problem, special considerations are needed at the borders of the image. Zero velocity is assumed at the borders of the image and the system is solved to get the velocity field for each point of the image.

Nonlinear Diffusion

Linear isotropic diffusion reduces noise but also blurs edges. As the scale increases, edges tend to be harder to identify [43]. One possible way of reducing this effect might be to consider the heat conduction coefficient λ as a field function dependent on the magnitude of the edges; that is:

$$\frac{\partial }{\partial t} I ( x , t ) = ∇ \cdot ( ℊ ( {\vert ∇ I ( x , t ) \vert}^{2} ) ∇ I ( x , t ) ) \qquad ( 58 )$$

which corresponds to Equation (28) with λ(x,t)=g(|∇I(x,t)|²), T(x,t)=I(x,t), ρ(x)=1, c=1 and σ(x,t)=0 (i.e., unsteady transfer with no source). The conduction function g(s) must display the following behavior: in constant regions, there should be linear isotropic diffusion (Equation (50)), that is g(|∇I(x,t)|²)=1 for |∇I(x,t)|²=0, and almost no diffusion when the magnitude of the edge is great; that is, g(|∇I(x,t)|²)=0 for |∇I(x,t)|²→∞. Perona and Malik [38] proposed the following functions:

$$\begin{matrix}ℊ ( s ) = \frac{1}{1 + \frac{{s}^{2}}{{k}^{2}}} , & ( k > 0 ) \\ and & \\ ℊ ( s ) = {ⅇ}^{- \frac{{s}^{2}}{{k}^{2}}} , & ( k > 0 )\end{matrix}$$

The parameter k in these functions is difficult to set because it controls the threshold of diffusion but also the steepness of the function [35]. An advantageous alternative is to use the function:

$$ℊ ( s ) = \frac{1}{2} tanh ( γ ( k - s ) + 1 )$$

where k and γ control the threshold and the steepness, respectively. Equation (58) is then soved for a particular t (the scale) with initial conditions:
I(x, 0)=I(x)
where I(x) is the original image.

Let us assume that we have I time steps Δt=t/l. First, the same cubical complexes K^{p′} and K^{s′} are used as hereinabove and the following relations are defined:
K^{p}=K^{p′}×[tₖ, tₖ₊₁]
K⁸=K^{8′}×[tₖ, tₖ₊₁], tₖ=kΔt, ∀k ε [0, l−1]

Secondly, the following assumption is made about the spatial behavior of h(x, t); that is, the approximation function \tilde{h}(x, t) is chosen. For a 3-pixel γ_{E} as defined in FIG. 17, it is assume that H is the mean value over [−Δ/2, Δ/2]×[−Δ/2, Δ/2]. Thus, ε=H; that is, using Equation (34), the following relation can also be written:
<ε, γ_{E}>=T¹−T⁰ (59)

For the sake of simplicity, the same spatial bilinear approximation function \tilde{g}(x, t) as hereinabove is used. The behavior over a time step has to be approximated. Some common assumptions about time variation may be generalized by proposing [37]:

$${\int }_{{t}_{k}}^{{t}_{k + 1}} A ( t ) ⅆ t = ( w A ( {t}_{k + 1} ) + ( 1 - w ) A ( {t}_{k} ) ) Δ t , \qquad 0 \leq w \leq 1$$

where A(t) is some quantity and w is a weighting factor [37]. Some values of w lead to well-known schemes: 1) w leads to the explicit scheme; that is, the value at tₖ prevails for the entire time interval except at time tₖ₊₁, 2) w=1 leads to the fully implicit scheme; that is, the value changes at time tₖ from A(tₖ) to A(tₖ₊₁) and stays there throughout the whole time interval. 3) w=0.5 leads to the semi-implicit or Crank-Nicolson scheme; that is, there is a linear variation of A(t). It is proposed to use the implicit scheme because for large values of Δt, it best emulates long term time behavior for heat [37]. That is for a 3-pixel, and for w=1:

$$\begin{matrix}\tilde{g} ( x ) = - \frac{1}{Δ} [ ( {𝒢}_{1}^{1} + \frac{( {𝒢}_{3}^{1} - {𝒢}_{1}^{1}}{Δ} y ) \cdot \vec{i} + ( {𝒢}_{4}^{1} + \frac{( {𝒢}_{2}^{1} - {𝒢}_{4}^{1} )}{Δ} x ) \cdot \vec{j} ] Δ t , \\ x ∈ {γ}_{p} , t ∈ [ 0 , Δ t ]\end{matrix}$$

In order to obtain the local function \tilde{q}(x, t) Equation (25) is applied:
\tilde{q}(x, t)=λ(x, t)\tilde{g}(x, t)
where λ(x, t)=g(|∇I(x,t)|²). As ∇I(x,t) is a spatially sampled image where samples are located at the 0-pixels of K^{p}, the local values of λ(x, t) are approximated. For the sake of simplicity, a bilinear approximation is once again used; that is:
\tilde{λ}(x)=a+bx+cy+dxy

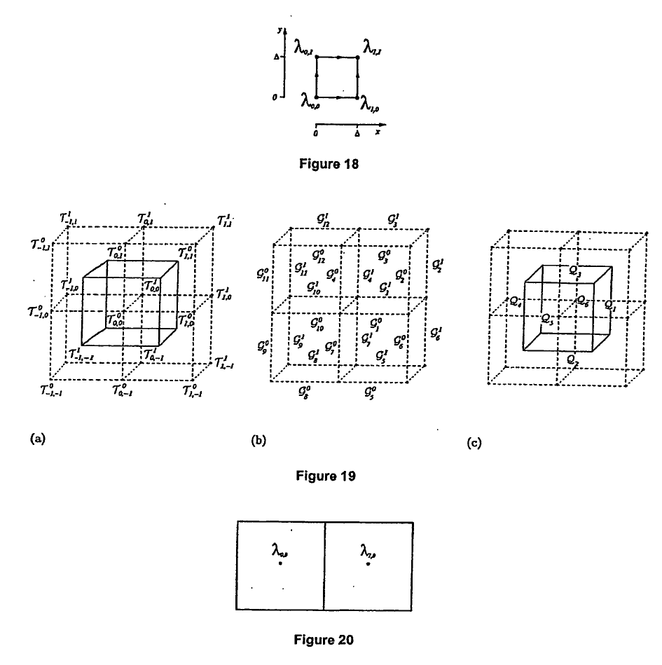

For a 2-pixel of K^{p}, as illustrated in FIG. 18, the following relation is obtained:

$$\tilde{λ} ( x , t ) = {λ}_{0 , 0} + \frac{1}{Δ} ( ( {λ}_{1 , 0} - {λ}_{0 , 0} ) x + ( {λ}_{0 , 1} - {λ}_{0 , 0} ) y ) + \frac{1}{{Δ}^{2}} ( {λ}_{0 , 0} - {λ}_{1 , 0} - {λ}_{0 , 1} + {λ}_{1 , 1} ) \qquad ( 60 )$$

Using these assumptions, the same steps as in hereinabove are followed to find Q as a function of G. For instance, this function for one n-pixel as defined in FIG. 16c is:
Q₁=(CL)^{t}G
where C, L and G are matrices defined as:

$$\begin{matrix}C = [ \begin{matrix}1 / 24 & 7 / 24 & 1 / 24 & 1 / 24 & 7 / 24 & 1 / 24 \\ 0 & 1 / 24 & 1 / 48 & 0 & 1 / 24 & 1 / 48 \\ 1 / 48 & 1 / 24 & 0 & 1 / 48 & 1 / 24 & 0\end{matrix} ] , \\ \begin{matrix}L = [ \begin{matrix}{λ}_{0 , - 1} \\ {λ}_{0 , 0} \\ {λ}_{0 , 1} \\ {λ}_{1 , - 1} \\ {λ}_{1 , 0} \\ {λ}_{1 , 1}\end{matrix} ] & & and & & G = [ \begin{matrix}{𝒢}_{1}^{1} \\ {𝒢}_{3}^{1} \\ {𝒢}_{5}^{1}\end{matrix} ]\end{matrix}\end{matrix}$$

Using Equations (40) and (43), we can express D can be expressed as a function of T. For one 3-pixel, γ_{E} of K^{s′} as defined in FIG. 19, and the following relation is obtained:
<D, γ_{E}>=(C_{λ}L_{λ})^{t}TΔt (61)
where C, L and T are matrices defined as

$$\begin{matrix}{C}_{λ} = \\ [ \begin{matrix}1 / 24 & 1 / 16 & 0 & 1 / 16 & 1 / 12 & 0 & 0 & 0 & 0 \\ 1 / 48 & 1 / 2 & 1 / 48 & 0 & 5 / 24 & 0 & 0 & 0 & 0 \\ 0 & 1 / 16 & 1 / 24 & 0 & 1 / 12 & 1 / 16 & 0 & 0 & 0 \\ 1 / 48 & 0 & 0 & 1 / 4 & 5 / 24 & 0 & 1 / 48 & 0 & 0 \\ - 1 / 12 & - 3 / 8 & - 1 / 12 & - 3 / 8 & - 7 / 6 & - 3 / 8 & - 1 / 12 & - 3 / 8 & - 1 / 12 \\ 0 & 0 & 1 / 48 & 0 & 5 / 24 & 1 / 4 & 0 & 0 & 1 / 48 \\ 0 & 0 & 0 & 1 / 16 & 1 / 12 & 0 & 1 / 24 & 1 / 16 & 0 \\ 0 & 0 & 0 & 0 & 5 / 24 & 0 & 1 / 48 & 1 / 4 & 1 / 48 \\ 0 & 0 & 0 & 0 & 1 / 12 & 1 / 16 & 0 & 1 / 16 & 1 / 24\end{matrix} ] , \\ \begin{matrix}{L}_{λ} = [ \begin{matrix}{λ}_{- 1 , - 1} \\ {λ}_{0 , - 1} \\ {λ}_{1 , - 1} \\ {λ}_{- 1 , 0} \\ {λ}_{0 , 0} \\ {λ}_{1 , 0} \\ {λ}_{- 1 , 1} \\ {λ}_{0 , 1} \\ {λ}_{1 , 1}\end{matrix} ] & & and & & T = [ \begin{matrix}{𝒯}_{- 1 , - 1}^{1} \\ {𝒯}_{0 , - 1}^{1} \\ {𝒯}_{1 , - 1}^{1} \\ {𝒯}_{- 1 , 0}^{1} \\ {𝒯}_{0 , 0}^{1} \\ {𝒯}_{1 , 0}^{1} \\ {𝒯}_{- 1 , 1}^{1} \\ {𝒯}_{0 , 1}^{1} \\ {𝒯}_{1 , 1}^{1}\end{matrix} ]\end{matrix}\end{matrix}$$

Equation 33 with <S, γ_{E}>=0 is applied to obtain, for each 3-pixel of K^{p′}:
T_{0,0}¹−(C_{λ}L_{λ})^{t}TΔt=T_{0,0}⁰
which defines the system of linear equations. The initial conditions are T⁰=I(x).
A Different Hypothesis for Heat Conduction

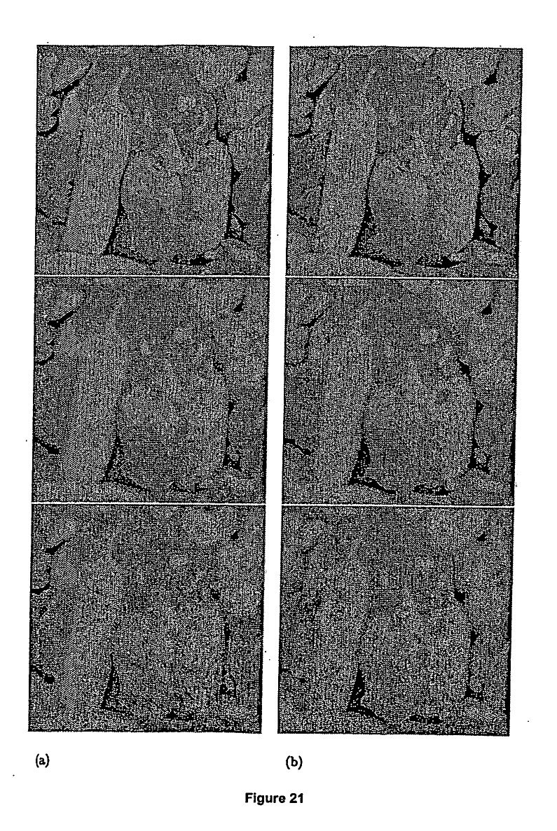

In the preceding discussion, λ(x) has been approximated with a bilinear function, essentially for the sake of simplicity. Nevertheless, it could be preferable to use another assumption. Actually, this simple approach does not accurately handle abrupt changes in conductivity. For example, two 2-pixels of K^{s}, as shown in FIG. 20 will be considered. To compute Q, λ(x) is approximated at the borders of the pixels based on the values at their centers. Using bilinear approximation, the value of \tilde{λ}(x) on the line linking two points is declared be the arithmetic mean of the values at these points. For instance, given λ_{0,0}→0 and λ_{1,0}→1, the conduction at the border is about 0.5. This means that the zero conductivity at one pixel is partly cancelled out by the fact that on the pixel beside it, there is a high conductivity coefficient. In non-linear gray level diffusion, we are confronted with precisely this kind of abrupt change. For example, at step edge pixels, the conduction may need to be very low, whereas immediately adjacent, it may needs to be almost one.

A better assumption would thus be to consider \tilde{λ}(x) as constant over one single 2-pixel of K^{s} [37]. Therefore, on the 1-face common to two pixels as in FIG. 20:

$$\tilde{λ} ( x ) = {( \frac{0.5}{{λ}_{0 , 0}} + \frac{0.5}{{λ}_{1 , 0}} )}^{- 1} = \frac{2 {λ}_{0 , 0} {λ}_{1 , 0}}{{λ}_{0 , 0} + {λ}_{1 , 0}}$$

It can easily be seen that when λ_{0,0}→0, then \tilde{λ}→0 and when λ_{0,0}<<λ_{1,0}, then \tilde{λ}→2λ_{0,O}. This means that in both situations, the low conductivity would prevail at the boundary common to the two pixels [37]. With this assumption, the matrices C_{λ} and L_{λ} are modified as follows:

$$\begin{matrix}{C}_{λ} = [ \begin{matrix}1 / 4 & 1 / 4 & 0 & 0 \\ 3 / 2 & - 1 / 4 & - 1 / 4 & 0 \\ 1 / 4 & 0 & 1 / 4 & 0 \\ - 1 / 4 & 3 / 2 & 0 & - 1 / 4 \\ - 3 / 2 & - 3 / 2 & - 3 / 2 & - 3 / 2 \\ - 1 / 4 & 0 & 3 / 2 & - 1 / 4 \\ 0 & 1 / 4 & 0 & 1 / 4 \\ 0 & - 1 / 4 & - 1 / 4 & 3 / 2 \\ 0 & 0 & 1 / 4 & 1 / 4\end{matrix} ] , and \\ {L}_{λ} = {λ}_{0 , 0} [ \begin{matrix}{λ}_{0 , - 1} / ( {λ}_{0 , - 1} + {λ}_{0 , 0} ) \\ {λ}_{- 1 , 0} / ( {λ}_{- 1 , 0} + {λ}_{0 , 0} ) \\ {λ}_{1 , 0} / ( {λ}_{1 , 0} + {λ}_{0 , 0} ) \\ {λ}_{0 , 1} / ( {λ}_{0 , 1} + {λ}_{0 , 0} )\end{matrix} ]\end{matrix}$$

Experimental Results

The proposed approach was tested on real and synthetic images in the context of linear isotropic diffusion, optical flow and non-linear diffusion. The results were compared with another method in each case.

For linear diffusion, FIG. 21a presents our physics-based method (PB) at three different scales and FIG. 21b shows the result by convolution for the same scales. In the absence of a quantitative evaluation, it can be said that subjectively the results seem to be similar.

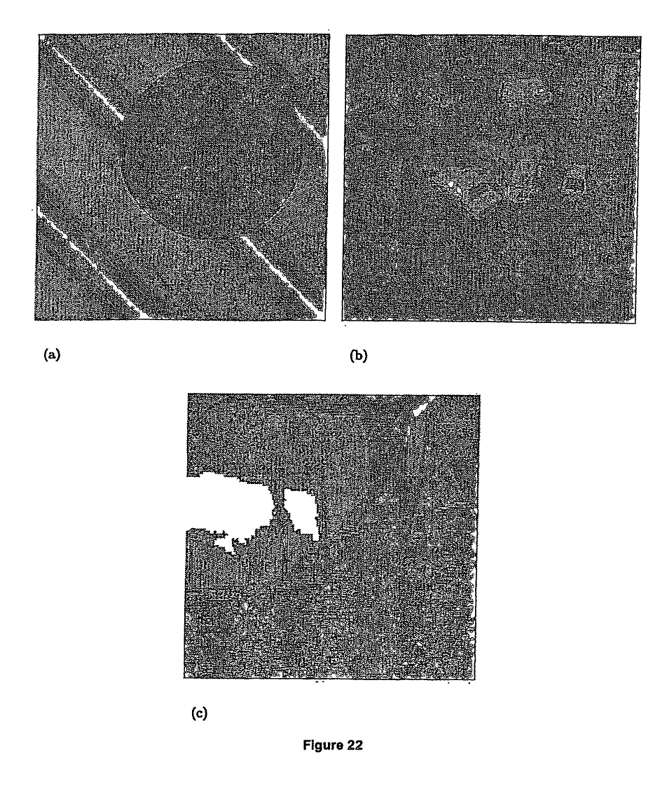

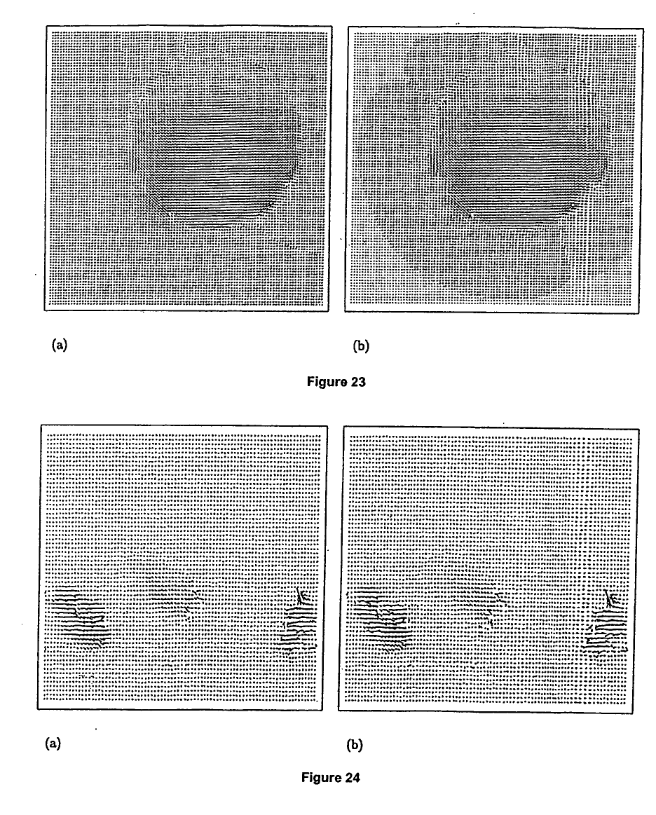

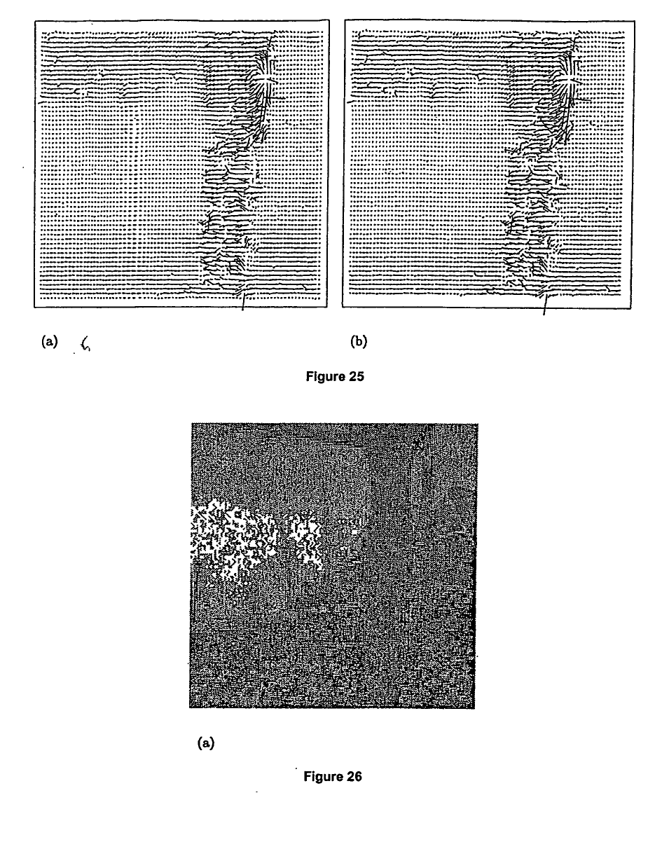

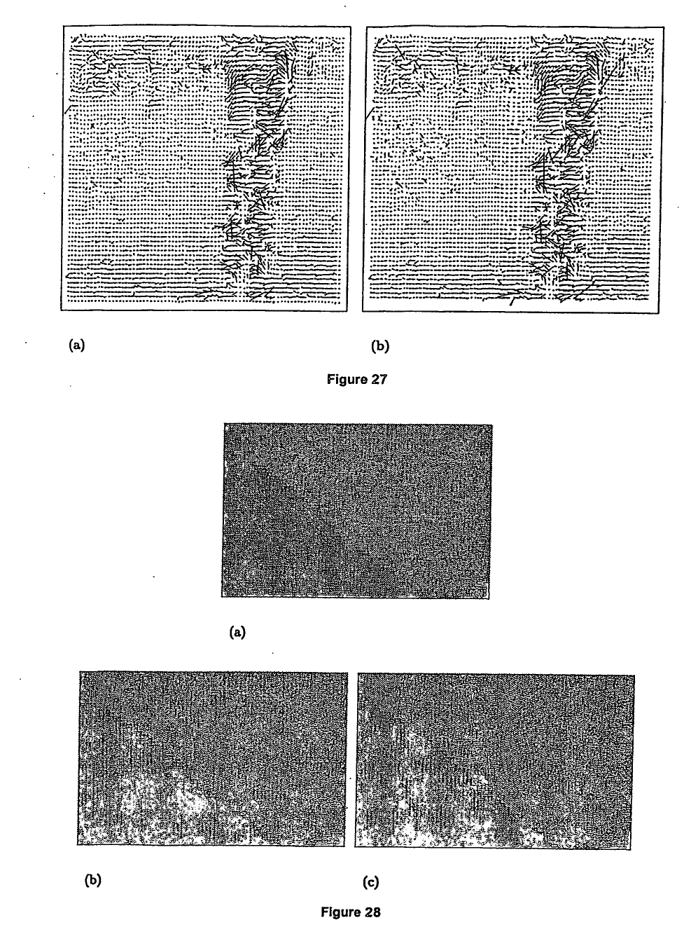

For optical flow, FIGS. 22a-22c show the first frames of three sequences: rotating sphere, Hamburg taxi and tree sequences. The results are compared with those being obtained using a finite-difference implementation of the Horn and Schunck algorithm (FD) [18, 19]. In these three examples and for both the PB and FD methods, the image derivatives are computed by convolution with the appropriate Gaussian derivatives. Both temporal and spatial scales are set to 1, as is the weighting factor α. FIGS. 23a and 23b shows the flow pattern computed for the sphere sequence. FIGS. 24a-b and 25a-b present the flow patterns for the taxi and tree sequences, respectively. For the rotating sphere and the taxi sequences, we obtain similar results with both methods. For the tree sequence, we also obtain similar results even if the extreme values seem to be smaller with the PB method than with the FD method. This fact is more apparent in FIGS. 27a and 27b which show respectively the results for the PB and FD methods for the tree sequence in which white noise (standard deviation of 10) has been added (see FIG. 26). Another advantage of the method according to the present invention is that it avoids iterations since the algorithm is applied only once.

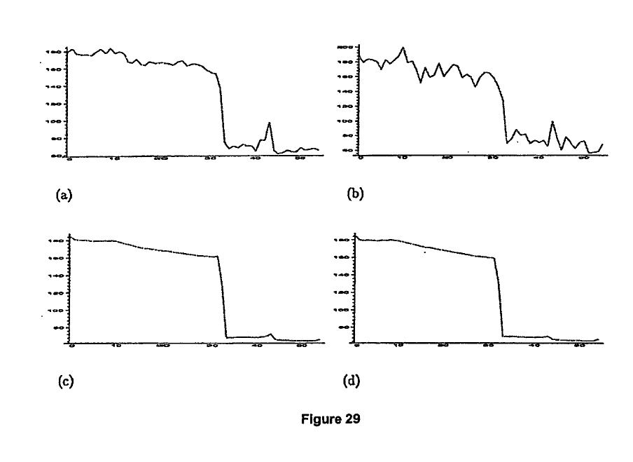

For nonlinear diffusion, FIGS. 28a-28c compare the PB method with constant hypothesis on λ and the FD [38, 17] method for a small window of the peppers image with σ=5. FIG. 28b presents the original section with white noise added (standard deviation of 10). FIGS. 28b and 28c show respectively the results for the PB and FD methods. One can notice that some details are better conserved in FIG. 28c than in FIG. 28b. This fact is enlightened in FIGS. 29a-29d which show a profile of the diagonal line starting at the upper right corner and finishing at the lower left corner.

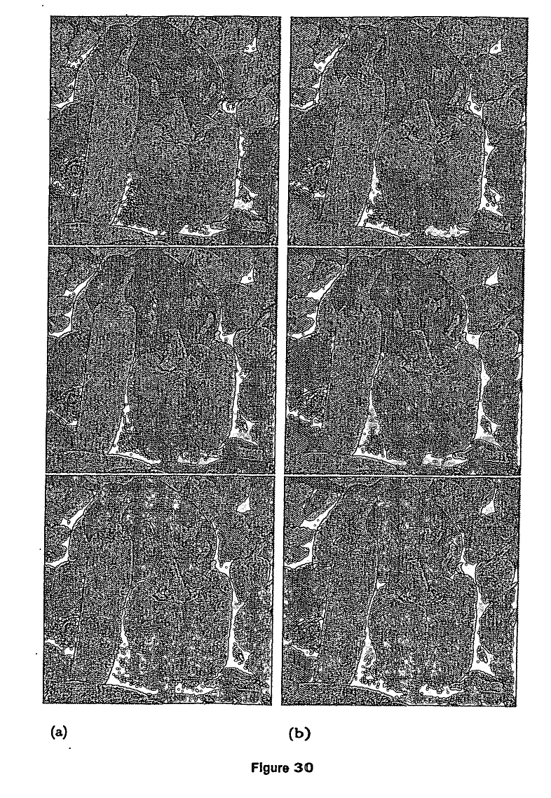

FIGS. 30a and 30b present the results for the peppers image with σ=1.0, 3.0 and 5.0. The results for PB seem a little sharper than the FD results.

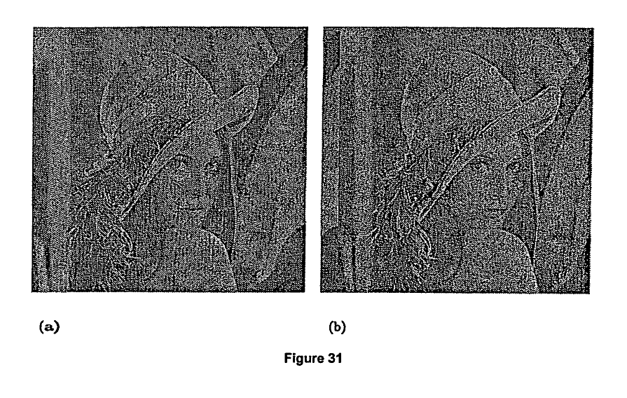

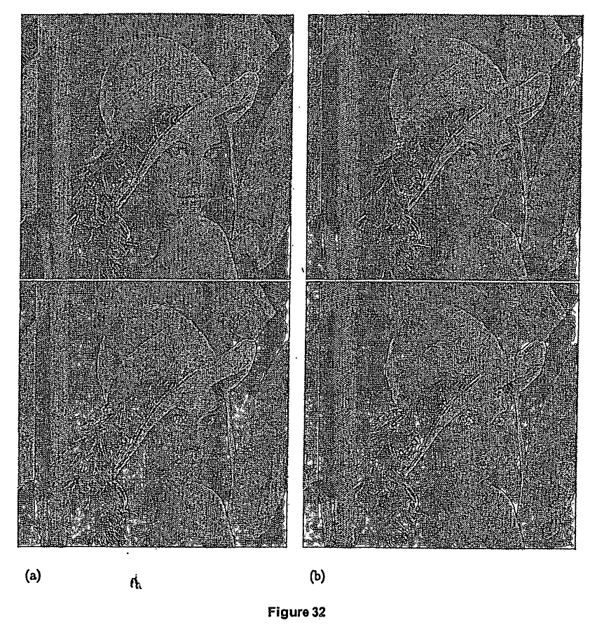

FIGS. 32a and 32b show the results for the Lena image (FIG. 31a) with an added white noise of standard deviation 10 (FIG. 31b) at two different scales, σ=4.0 and 8.0. Again, the PB method seems to give sharper results at both scales.

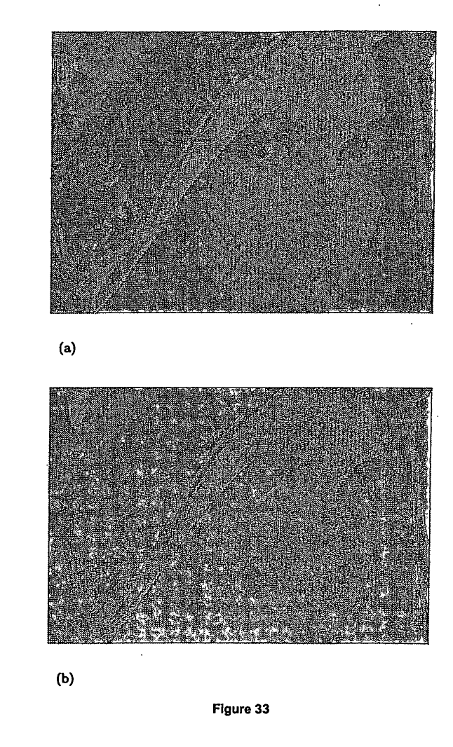

FIGS. 33a and 33b present details of the Lena results at σ=8.0. FIG. 33b seems smoother in constant zones but some details are lost. For example, compare the eyes, the trim on the hat and the right side of the face.

Conclusion

An alternative approach to the PDE-based resolution of the diffusion problem was described. The proposed approach differs in two significant ways from with the classical PDE resolution scheme: 1) the image is considered as a cubical complex for which algebraic structures such as chains, cochains, boundaries and coboundaries are defined; and 2) the diffusion problem is decomposed into conservative and constitutive basic laws, each of which is represented by cochains and coboundaries.

The conservative basic laws are represented without approximation while some approximations are required for the constitutive laws. This means that unlike traditional PDE resolution, for which many approximations must be made, all approximations are known since they are only needed in the representation of the constitutive equations. Coboundaries are computed using fundamental theorems of calculus such as the Green, Stokes and Line Integral theorems. Unlike iterative numerical analysis algorithms that do not allow the explanation of intermediate results, the use of basic laws allows the physical explanation of all steps and intermediate results of the algorithm. Moreover, since there is no iteration in the resolution process, there is no problem about the convergence of the numerical analysis scheme. Furthermore, the use of cubical complexes provides algorithms that can operate in any dimension. It has the significant advantage of avoiding the potentially difficult task of extending the algorithm to higher dimensions. Cochains and coboundaries allow the use of both global and local quantities. Integrals or discrete summations over fields are used to compute global quantities. This allows the reduction of noise by performing a smoothing operation, as opposed to differentiation, which enhances high frequencies.

In computer vision and image processing, several problems can be modeled as diffusion problems. The proposed approach has been validated on smoothing by linear and nonlinear diffusion and on the computation of optical flow. The results obtained confirm the effectiveness of this approach.

### PRACTICAL EXAMPLE #2

### A Physics-Based Model for Active Contours

A new active contours model is presented. It is based upon a decomposition or the linear elasticity problem into basic physical laws. As opposite with other physics-based active contours model which solve the partial differential equation arising from the physical laws by some purely numerical techniques, exact global values are used and approximations made only when they are needed. Moreover, these approximations can be made wisely assuming some knowledge about the problem and the domain. The deformations computed with the present approach have a physical interpretation. In addition, the deformed curves have some interesting physical properties such as the ability to recover their original shape when the external forces are removed. The physical laws are encoded using the computational algebraic topology based image model described herein. The resultant numerical scheme is then straightforward. The image model allows our algorithm to perform with either 2D or 3D problems.

Introduction

These last years, active contours and active surfaces have been widely studied since the introduction of active contours by Kass et al [59]. They have been used in image segmentation [62], tracking [68], automatic correction and updating of road databases [46], etc.

To solve these problems, many different approaches have been proposed (see [57, 63]) in particular physical models derived from equations of continuum mechanics. Mass-springs models are physical models which use a discrete representation of the objects. Objects are modeled as a lattice with point masses linked together by springs [57]. Information is thus only available at a finite number of points [63]. These methods offer only a rough approximation of the phenomena happening in a body [57]. Moreover, the determination of spring constants reflecting the material properties may be a very fastidious work. However, they offer real-time performances and allows for parallel computations.

Other physical models based upon the minimization of an energy functional which takes into account an internal regularizing force and an external force applied on the data are also often used. Some of them consider the deformable bodies as continuous objects by approximating their continuous behavior with methods such as the finite element method (FEM). FEM are closer to the physics than mass-springs models but their computational requirements make them difficult to be applied in real-time systems without preprocessing steps [57]. Finite difference methods (FDM) are also used to discretize the objects. They usually offer better performance than FEM but they require the computation of fourth order derivatives which make them sensitive to noise [63].

For a given curve S₁ the application of the FEM and FDM methods leads to a discrete stationary system of equations of the form:
KS=f(S)
where K is a matrix which encodes the regularizing constraints on S and f(S) represents the data potential. However, some problems such as animation in graphics applications require to take into account a dynamic evolution of the curve [57]. In these case, inertial body forces and damping forces may also by considered by controlling the deformations through a Newtonian law of motion:

$$M \frac{{\partial }^{2} S}{\partial {t}^{2}} + D \frac{\partial S}{\partial t} + K S = f ( S ) \qquad ( 62 )$$

or by a Lagrangian evolution

$$\frac{\partial S}{\partial t} + K S = f ( S ) \qquad ( 63 )$$

where M and D are respectively matrices which represent the mass model and the background damping. Equations (62) and (63) are solved using various numerical schemes [70, 64] assuming an initial curve S₀ close to the solution which evolves until the inertial terms go to zero.

Over the last years, a lot of different methods have been introduced to compute the matrices M, D and K but as pointed out by Montagnat et al [63], these methods have a major drawback: the corresponding system deformations do not have any physical interpretations.

A new model which includes a physical interpretation of the deformations is described hereinbelow. The model is similar to a mass-springs model but it includes both the efficiency of the mass-springs models and the accuracy of the physical modeling of the FEM by providing a systematic method for specifying springs constants reflecting the properties of the materials.

To achieve it, we propose to use directly the basic laws of physics which lead to the partial differential equations (62) and (63). These equations are indeed obtained by considering and mixing together some basic laws of physics into a global conservation law and considering its local counterpart [72]. This approach is not always well suited for problems such as computer vision in which the continuous domain must be subdivided into many sub-domains for which there are often only one information available. The use of this information as a global value over each sub-domain allow to directly use the global conservation law which can lead to an algorithm less sensitive to noise.

To encode these global values over points, surfaces, volumes, etc arising from some physical laws, we use the computational algebraic topology based image model described hereinabove.

The approach according to this illustrative embodiment of the present invention has several advantages. 1) Since the linear elasticity problem is well-known in continuum mechanics, the modeling according to the illustrative embodiment of the present invention can be made wisely in order to provide some good physical interpretation of the whole deformation process and of its intermediate steps. This allows an easier determination of the parameters used in the process since they have a physical meaning; 2) The determination of the springs constants in order to reflect the material properties is straightforward; 3) The objects in the image (e.g. curves, surfaces) are modeled as entities having their own physical properties such as elasticity and rigidity. They have the property of recovering their original state when the forces applied on them are removed; 4) Both smooth results and results having high curvature points can be obtained; 5) The complexity of the algorithm is minimal and allows for real-time simulation without any extra preprocessing steps [51]; 6) The image model allows our algorithm to perform with either 2D or 3D problems.

Physical Modeling

One of the objectives of this illustrative embodiment of the present invention is to model the objects in an image (e.g. curves, surfaces, etc) as entities having their own physical properties such as elasticity and rigidity. As a consequence, these objects need to satisfy the laws and principles of the continuum mechanics. For instance, a body subjected to forces must move or deform according to the universal laws of physics.

These principles and laws to which all bodies must obey will now be presented. We first introduce the concepts of stress and strain which are required in the statement of the governing equations for deformable bodies. Then, the physical laws related to the linear elasticity problem will be presented.

The elasticity theory has been widely studied by engineers and scientists and is the main subject of many books. The present specification only presents the concepts of this theory which are relevant to our application. The concepts presented here are well known and may be found in many continuum mechanics books such as [65, 50].

Forces, Stresses and Strains

A material body in a 3-D space is always subjected to forces. These forces may come from an external agent (external forces) or issue from the object itself (internal forces). When the external forces are greater than the internal forces, then the body can undergo deformations (strains) or be accelerated. This deformation can induce internal forces (stresses) if the material is elastic. The concepts of force, stress and strain and the relation between strain and stress is exposed hereinbelow.

Forces Acting on a Body

Two basic types of forces act on a body. First, there are the interatomic forces which hold the body's particles together at some configuration. These forces, called internal forces, can either attempt to separate or bring the particles closer according to the fact that the body undergoes a contraction or an extension [65]. They act in response to a force applied by some other agent. Assuming the equilibrium of the body and using Newton's law of reaction, they must be equal in magnitude to the forces applied to the body but in opposite direction [66].

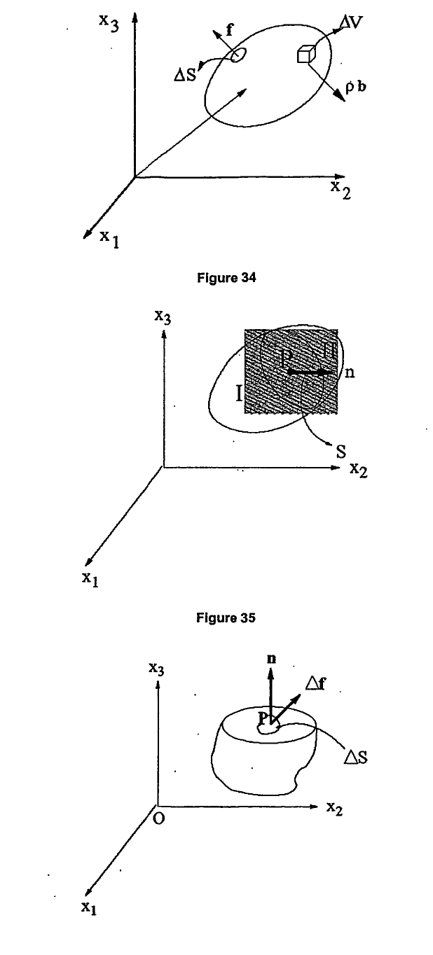

On the other hand, there are the forces applied by an external agent, called external forces. Two types of these forces are generally applied on a body. First, there are forces such as gravity and inertia called the body forces, which act on all volume elements. These forces, noted bᵢ (forces per unit of mass in a direction xᵢ), are distributed in every part of the body. Secondly, there are forces which act on and are distributed over a surface element such as the contact forces between solid elements [49]. These forces, noted fi (forces per unit of area in a direction xᵢ, are called the surface forces. The surface element may be inside the body or a part of a bounding surface [60]. A body of arbitrary size, shape and material subjected to surface and body forces is shown in FIG. 34.

External forces applied on a body must be transmitted to it. A rigid body can then undergo either a spatial shift, a rotation of both of them. In the case of a non-rigid body, it can also go through a deformation or a distortion in which case internal forces will be developed to counterbalance the external forces. If the internal and external forces are balanced, we say that the body is in static equilibrium. Otherwise the body can be accelerated which would give rise to inertia forces [58]. Using d'Alembert's principle, these forces may be included as part of the body forces [48] such that the equilibrium equations can be satisfied. If the body gets deformed then the deformation can either be elastic or not and is subjected to the material properties of the body such as its elasticity and its rigidity. If the internal forces induced by the material properties of a body are too weak to counterbalance the external forces, then the body can be permanently deformed [52].

We assume herein the material to be isotropic with respect to some mechanical properties. We then suppose that the material properties are the same in all directions for a given point [60]. We also consider an homogeneous material which means that its properties are identical at all locations.

The Concept of Stress at a Point

Let us consider an isotropic and homogeneous body B. Let us assume that B is subjected to arbitrary surface and body forces such that B is in static equilibrium. Let P be a interior point of B and S be a plane surface passing through P. S will be referred to as the cutting plane and is defined by the unit normal vector n=(n₁, n₂, n₃)^{T}. Then S partitions B into two sections I and II as shown in FIG. 35.

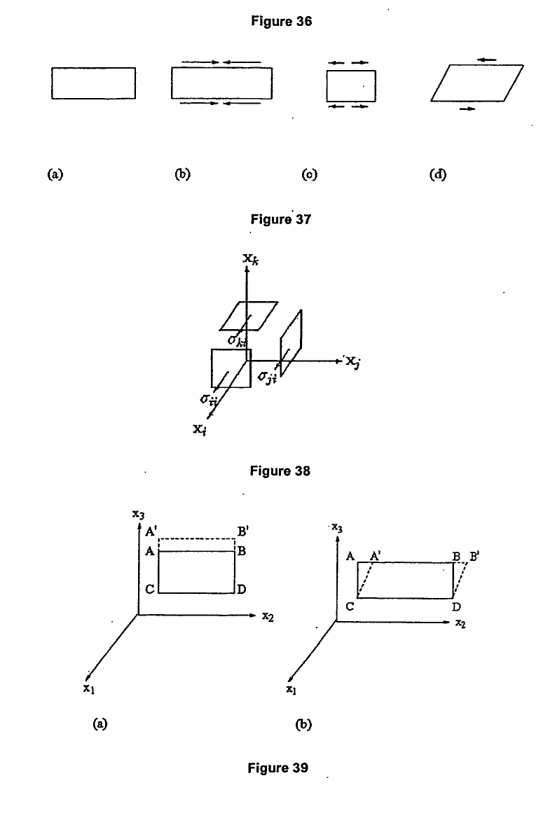

Let us assume that ΔS is a small element of area of the cutting plane surrounding P (see FIG. 36).

Since the body is in static equilibrium then the force system acting on each part I and II taken alone must also be in equilibrium. This generally requires that some internal forces are transmitted by part I to part II. These forces are not necessarily distributed uniformly on every part of the cutting plane. Thus they may vary in magnitude and direction over it. We generally want to determine precisely that force distribution at every point of ΔS. The term stress is used to define the intensity and the direction of the internal force Δf acting at point P. Using the Cauchy stress principle [60] we define the stress vector (or traction vector or traction forces) tⁿ at P as:

$${t}^{n} = {lim}_{Δ S -> 0} \frac{Δ f}{Δ S}$$

assuming that P remains an interior point of ΔS as its area reduces to zero.

Let us mention that tⁿ is not necessarily in the direction of the normal vector n at P. However, it may be decomposed into a component perpendicular to the cutting plane, called the normal stress, and a component parallel to it, called the shear stress. The normal stress attempts to separate (bring closer) the material particles after a compression (an extension) of an elastic body when it tries to recover its original state. On the other hand, the shear stress acts parallel to the cutting plane and tends to slide adjacent planes with respect to each other (see FIG. 37a-37d).

It should be first noticed that the stress vector tⁿ is defined with respect to the cutting plane's unit normal vector n. Since there are infinitely many cutting planes going through P there are also as many stress vectors defined at P. Juvinall [58] defines the state of stress at a point P as a complete description of the stress magnitude and direction for all possible cutting plane passing through P. Fortunately, this description can be fully obtained by considering any three mutually perpendicular planes passing at P [58]. For the sake of simplicity, we usually use the three axes defined by the three canonical vectors x₁, x₂ and x₃.

Let us define σᵢⱼ as the stress component in the direction of xⱼ when the normal vector is parallel to the axe defined by xᵢ. If i=j then σᵢᵢ represents a normal stress. Otherwise, σᵢⱼ is a shear stress. With these conventions, the component tᵢⁿ in the direction of xᵢ of the traction force tⁿ depends on the normal stress σᵢᵢ, the shear stresses σⱼᵢ and σₖᵢ and the normal vector n such that (see FIG. 38):

$$\begin{matrix}{t}_{i}^{n} = {σ}_{1 i} {n}_{1} + {σ}_{2 i} {n}_{2} + {σ}_{3 i} {n}_{3} \\ = {\sum }_{j = 1}^{3} {σ}_{ji} {n}_{j}\end{matrix} \qquad ( 64 )$$

Equation (64) is known as the Cauchy stress formula.

Since each of the three coordinates axes involves six stress components, there is a total of nine stress components. However the equilibrium of moments at P [49] gives that only six of these are independent that is σᵢⱼ=σⱼᵢ for all i, j=1, 2, 3. This means that the state of stress at a point is fully determined by σ₁₁, σ₂₂, σ₃₃, σ₁₂, σ₁₃ and σ₂₃.

The Concept of Strain at a Point

Any non-rigid body goes through deformations and distortions when subjected to forces. The body can either extend or contract (deformation) or have a geometric modification of its shape (distortion). FIGS. 39a and 39b present these concepts.

The term strain refers to the direction and intensity of the deformation at any given point with respect to a specific plane passing through that point [58]. As for stress, the strain is defined according to a specific cutting plane. The state of strain is defined by Juvinall [58] as the complete definition of the magnitude and direction of the deformation at a given point with respect to a all cutting planes passing through that point.

As for the state of stress, the description can be obtained by considering any three mutually perpendicular planes passing at P. One can therefore see a great similarity between stress and strain. However, there is a major difference between them: strains are generally some directly measurable quantities while stresses are not. Fortunately, stresses can be computed from strains (and vice versa) using a constitutive equation.

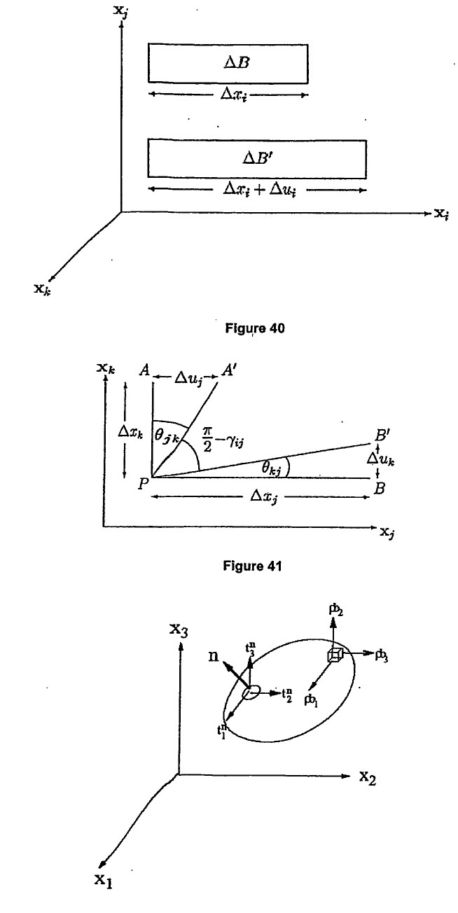

As for stress, two types of strains can be defined. First, there are the strains which result of a change in the dimensions of the body (deformation). Let B be the same body defined hereinabove, ΔB be a small element of B of length Δxᵢ in the direction of xᵢ and ΔB′ be the deformation of ΔB such that Δuᵢ is the change in lenght of ΔB after the application of a force in the direction of xᵢ (see FIG. 40). The normal strain εᵢₗ at P in the xᵢ direction with respect to a cutting plane having xᵢ as normal vector is the unit deformation of a line element [65] in the direction of xᵢ. It is formally defined as:

$${ɛ}_{ii} = {lim}_{Δ {x}_{i} -> 0} \frac{Δ {u}_{i}}{Δ {x}_{i}} = \frac{\partial {u}_{i}}{\partial {x}_{i}}$$

The normal strain is clearly the unit change in length per unit original length for the element in the direction of xᵢ. Since it is the ratio of two units of length, it is dimensionless even if it is sometimes expressed as units of length per unit of length such as inches per inch.

Let us now suppose that there are two perpendicular lines PB and PA of length Δxⱼ and Δxₖ respectively in the direction of xⱼ and xₖ (see FIG. 41).

Let us assume that after a distortion points A and B move respectively to A′ and B′ while P remains fixed. The lines PA and PB have been rotated of angles θⱼₖ and θₖⱼ such that:

$$\frac{Δ {u}_{j}}{Δ {x}_{k}} = tan ( {θ}_{jk} ) and \frac{Δ {u}_{k}}{Δ {x}_{j}} = tan ( {θ}_{kj} )$$

where Δuⱼ and Δuₖ are respectively the displacements of B and A in the xⱼ and xₖ directions.

If it is assumed that only small distortions occur, then we can approximate both tangents by their angles. Thus:

$$\begin{matrix}{θ}_{jk} ≅ tan ( {θ}_{jk} ) \\ = \frac{Δ {u}_{j}}{Δ {x}_{k}} and \\ {θ}_{kj} ≅ tan ( {θ}_{kj} ) \\ = \frac{Δ {u}_{k}}{Δ {x}_{j}}\end{matrix}$$

or, taking their infinitesimal analogous:

$$\begin{matrix}{θ}_{jk} = {lim}_{Δ {x}_{k} -> 0} \frac{Δ {u}_{j}}{Δ {x}_{k}} \\ = \frac{\partial {u}_{j}}{\partial {x}_{k}} and \\ {θ}_{kj} = {lim}_{Δ {x}_{j} -> 0} \frac{Δ {u}_{k}}{Δ {x}_{j}} \\ = \frac{\partial {u}_{k}}{\partial {x}_{j}}\end{matrix} \qquad ( 65 )$$

The shear strain γᵢₖ at P with respect to the cutting plane having xᵢ as normal vector is the angle in radians through which two orthogonal lines in the undistorted body are rotated by a distortion [56]. That is γᵢₖ=θⱼₖ+θₖⱼ. The two subscripts in γᵢₖ have a similar meaning as for stress. For instance, γᵢₖ is the strain acting on two adjacent planes perpendicular to the xᵢ axis and sliding them relative to each other in the xₖ direction.

Let us recall that these definitions have been made under the assumption that only very small displacements occur in the body. The normal and shear strains are supposed small compared to unity [50]. If this constraint is relaxed in order to include large deformations then the system to solve for the computation of the forces, the stresses, the strains or the displacements becomes non-linear and then harder to solve. This is sometimes necessary in some problems where large deformations can occur such as for thin flexible bodies [50] of for the modelization of human tissue [53]. However, if we restrict ourselves to small deformations, then the approximations made to define the shear strains do not induce too many errors and are widely accepted in the classical theory of elasticity [69, 65, 49, 50].

Finally, Equation (65) clearly shows that the shear strain is also a dimensionless quantity since it is the ratio of two units of length. Defining for i≠j:

$${ɛ}_{ij} = \frac{1}{2} {γ}_{ij} ( i , j = 1 , 2 , 3 )$$

the followin strain-displacement relation (or the kinematical relationship [69]) is obtained:

$${ɛ}_{ij} = \frac{1}{2} [ \frac{\partial {u}_{i}}{\partial {x}_{j}} + \frac{\partial {u}_{j}}{\partial {x}_{i}} ] \qquad ( 66 )$$

As for stresses, there is a total of nine strain components at each point of the body (three per mutually perpendicular cutting planes) but by symmetry they can be reduced to six, that is γⱼₖ=γₖⱼ for all j, k=1, 2, 3 with j≠k. The state of strain at any point can then be described by ε₁₁, ε₂₂, ε₃₃, ε₁₂, ε₁₃ and ε₂₃.

Relations Between Forces, Stresses and Strains

As mentioned hereinabove, strains are measurable quantities while stress are not even if both can be computed from the other. This is due to the fact that some knowledge about the material of a body is necessary to measure the stresses from strains and vice versa. For instance, a steel beam and a rubber beam induce different internal forces when bent equally.

This gap between strains and stresses will now be filled by stating the physical laws relating them to each other. This hole between strains and stresses needs to be filled by a constitutive equation (or material law), which reflect the internal constitution of the materials. The material law for the linear elasticity problem is known as the Hooke's law.

Before stating the law, it should be first reminded that a material has an elastic behavior when it satisfies the two following conditions:
1. The stresses depend only on the strains.
2. Its properties allow a body to recover its original shape when the external forces applied on the body are removed [60].

If theses conditions are not satisfied, a body is said to have an inelastic behavior. Any body may be seen as having an elastic behavior as long as it is not deformed beyond a limit value. This value is called the elastic limit [52, 49] and is usually defined as the maximum value of stress that a body can undergo without undergoing a permanent deformation.

In addition, if the stress is a linear function of the strain, an elastic material has a linear elastic behavior. In what follows, it is assumed that the material has a linear elastic behavior.

As mentioned in [60] and [49], in many situations the problem of elasticity can be considered as a 2D problem. This particular case is known as plane elasticity. Two basic types of problems compose the plane elasticity. The problems in which the stress components in one direction for a body are all zero are referred to as plane stress problems. On the other hand, if all the strain components in one direction for a body are zero then the state of strain for that body is referred to as plane strain (see [65, 60, 58]).

The present problem is considered as a plane strain problem. This distinction is important since the constitutive equation slightly differs according to the fact that a plane stress or a plane strain problem is considered.

The Hooke's Law

When a rubber ball is compressed its diameter in the directions perpendicular to the applied force gets larger. A similar phenomenon occurs when a rubber band is extended and its cross section gets smaller¹. In fact, these changes in dimensions happen in all materials even if they can't always be noticed by a naked eye [52].
¹ Example taken in [52]

When a stress is acting on an isotropic and homogeneous body in only one direction (uniaxial stress), one can show that the transverse strain ε^{⊥} (the strain in a perpendicular direction) is directly proportional to the strain ε induced by the stress:
ε^{⊥}=−vε
The ratio:

$$v = \frac{- {ɛ}^{⊥}}{ɛ}$$

is called the Poisson ratio. It is supposed constant when the stress is below the elastic limit [66].

The linear relationship between a uniaxial stress σᵢᵢ in a direction xᵢ and the corresponding strain εᵢᵢ is known as the Hooke's law [52, 58] and is written as:

$${ɛ}_{ii} = \frac{{σ}_{ii}}{E}$$

where E is the Young's modulus of elasticity. Of course, the Hooke's law is valid if the stress is not beyond the elastic limit of the material.

As pointed out by Boresi [49], the stresses at any point depend on all the strains in the neighborhood of that point. Thus the total deformation in the xᵢ direction depends not only on the stress in that direction but also of the deformations in the other two perpendicular directions. For instance the normal strain εᵢᵢ does not only depend on

$$\frac{{σ}_{ii}}{E}$$

(Hooke's law) but also of the transverse strains εⱼⱼ and εₖₖ such that the total deformation in the direction of xᵢ is:

$$\begin{matrix}{ɛ}_{ii} = \frac{{σ}_{ii}}{E} - v {ɛ}_{jj} - v {ɛ}_{kk} \\ = \frac{{σ}_{ii}}{E} - v \frac{{σ}_{jj}}{E} - v \frac{{σ}_{kk}}{E} \\ = \frac{1}{E} [ {σ}_{ii} - v ( {σ}_{jj} + {σ}_{kk} ) ] ( i \neq j \neq k )\end{matrix} \qquad ( 67 )$$

Equation (67) is the normal strain-stress relation. For isotropic materials, it can be shown that the normal strains are not influenced by the shear stresses [52]. Consequently, the shear stresses only induce shear strains and they are related by the relation:

$$2 {ɛ}_{ij} = \frac{{σ}_{ij}}{G} ( i \neq j ) \qquad ( 68 )$$

where

$$G = \frac{E}{2 ( 1 + v )}$$

is called the modulus of rigidity. Equations (67) and (68) are known as the Generalized Hooke's law for linear elastic isotropic materials [52]. These equations can be inverted in order to express the stresses as functions of the strains:

$$\begin{matrix}{σ}_{ii} = \frac{E}{( 1 + v ) ( 1 - 2 v )} [ ( 1 - v ) {ɛ}_{ii} + v ( {ɛ}_{jj} + {ɛ}_{kk} ) ] & ( 69 ) \\ {σ}_{ij} = 2 G {ɛ}_{ij} = \frac{E}{1 + v} {ɛ}_{ij} ( i \neq j ) & ( 70 )\end{matrix}$$

Relation Between Forces and Stresses

It is well known that the conservation (balance, equilibrium) laws constitute an important class of equations in continuum mechanics. They relate the change in total amount of a physical quantity inside a body with the amount of this quantity, which flows through its boundary. These laws must be satisfied for every continuous materials. Local differential equations are usually used to express these laws. In what follows, the linear momentum, which is relevant for the linear elasticity problem, is presented.

To every material body B is associated a measure of its inertia called the mass. This measure may vary in space and time inside a body. Let V be the volume of B, S its bounding surface and Δm be the mass of a small amount of volume ΔV. The mass density is given by:

$$ρ = ρ ( x , t ) = {lim}_{Δ V -> 0} \frac{Δ m}{Δ V}$$

Let us assume that distributed body forces ρbᵢ and tractions forces tᵢⁿ are applied to S (see FIG. 42). Let also assume that B is moving under the velocity field vᵢ=vᵢ(x,t). The quantity:

$${P}_{i} ( t ) = {\int \int \int }_{V} ρ {υ}_{i} ⅆ V$$

is called the linear momentum of B. The principle of linear momentum [49] states that the resultant force acting on a body is equal to the time rate of change of the linear momentum. Thus:

$$\frac{ⅆ}{ⅆ t} {\int \int \int }_{V} ρ {υ}_{i} ⅆ V = \underbrace{{\int \int }_{S} {t}_{i}^{n} ⅆ S + {\int \int \int }_{V} ρ {b}_{i} ⅆ V}_{Forces acting on the body} \qquad ( 71 )$$

Recalling Equation (64):

$${t}_{i}^{n} = {\sum }_{j = 1}^{3} {σ}_{ji} {n}_{j}$$

where n=(n₁, n₂, n₃)^{T} is the unit normal vector to the surface and σ=(σ₁₁, σ₂₁, σ₃₁)^{T} and using Gauss's divergence theorem, the following relation is obtained:

$$\frac{ⅆ}{ⅆ t} {\int \int \int }_{V} ρ {υ}_{i} ⅆ V = {\int \int \int }_{V} ρ \frac{\partial {υ}_{i}}{\partial t} ⅆ V = \\ {\int \int \int }_{V} ( ∇ \cdot σ + ρ {b}_{i} ) ⅆ V \qquad ( 72 )$$

Since V is arbitrary then the integral sign can be retrieved leading to the local equations of motion:

$$ρ \frac{ⅆ {υ}_{i}}{ⅆ t} = ∇ \cdot σ + ρ {b}_{i} \qquad ( 73 )$$

The global equilibrium equations can be obtained assuming a zero velocity field in Equation (72):

$$\underbrace{\int {\int }_{V} \int ∇ \cdot σ ⅆ V}_{Internal forces} + \underbrace{\int {\int }_{V} \int ρ {b}_{i} ⅆ V}_{External forces} = 0 ( i = 1 , 2 , 3 ) \qquad ( 74 )$$

and their local counterparts are:
∇·σ+ρbᵢ=0 (i=1, 2, 3) (75)

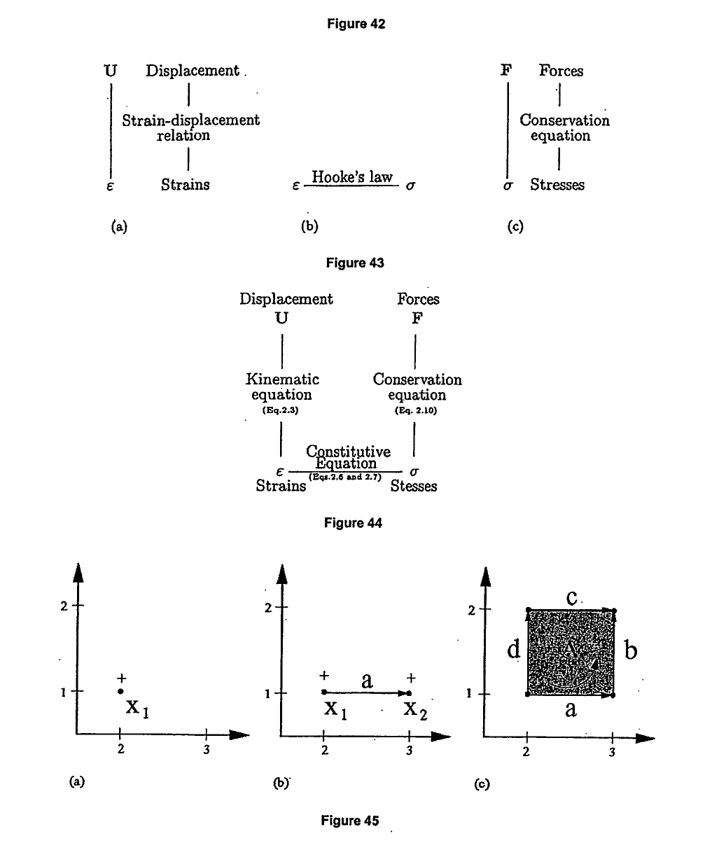

Let us now summarize the decomposition of the problem. The relation between the global displacement U of a body and the corresponding strains (see FIG. 43a) has been introduced hereinabove. The constitutive equation relating the strains and the stresses (see FIG. 43b) has also been presented. Finally, how the stresses are related to forces using the linear momentum principle (see FIG. 43c) has been described. A general scheme similar to the one presented by Tonti [72] may then be introduced to summarize how the internal reaction forces of a body are related to the global displacements of that body (FIG. 44).

Discrete Representation of Images

Some algebraic tools used to model the image will now be recalled from the above description. An image is composed of two distinctive parts: the image support (pixels) and some field quantity associated to each pixel. This quantity can be scalar (e.g. gray level), vectorial (e.g. color, multispectral, optical flow) or tensorial (e.g. Hessian). The image support is modelled in terms of cubical complexes, chains and boundaries. With these concepts, it is possible to give a formal description of an image support of any dimension. For quantities, the concept of cochains which are representations of fields over a cubical complex is introduced. For the use of these concepts in image processing, see [45].

An image is a complex of unit cubes usually called pixels. A pixel γ⊂Rⁿ n is a product:
γ=I₁×I₂× . . . ×Iₙ
where Iⱼ is either a singleton or an interval of unit length with integer end points. Then Iⱼ is either the singleton {k} and is said to be a degenerate interval, or the closed interval [k, k+1] for some k ε Z. The number q ε {0,1, . . . , n} of non-degenerate intervals is by definition the dimension of γ which is called a q-pixel. FIGS. 45a-45b illustrate three elementary pixels in R².

For q≧1, let J={k₀, k₁, . . . , k_{q-1},} be the ordered subset {1, 2, . . . , n} of indices for which Iₖ_{ⱼ}=[aⱼ, bⱼ] is non-degenerate. Define:
Aₖ_{ⱼ}σ=I₁× . . . Iₖ_{ⱼ}₋₁×{aⱼ}×Iₖ_{ⱼ}₊₁× . . . ×Iₙ
and
Bₖ_{ⱼ}σ=I₁× . . . Iₖ_{ⱼ}₋₁×{bⱼ}×Iₖ_{ⱼ}₊₁× . . . ×Iₙ

The Aₖ_{ⱼ} and the Bₖ_{ⱼ} are called the (q−1)-faces of σ. One can define the (q−2)-faces, . . . , down to the 0-faces of σ the same way. The faces of γ different from γ itself are called its proper faces.

By definition, a natural orientation of the cube is assumed for each pixel. Suppose that γ denotes a particular positive oriented q-pixel. It is natural to denote the same pixel with opposite orientation by −γ. Examples of orientations are given in FIGS. 45a-45c. A cubical complex in Rⁿ is a finite collection K of q-pixels such that every face of any pixel of the image support called K is also a pixel in K and the intersection of any two pixels of K is either empty or a face of each of them. For example, traditional 2D image models was only considering pixel as a 2D squared element. Definitions presented before allows us to consider 2-pixels (squared elements), 1-pixels (line elements) and 0-pixels (punctual elements) simultaneously.

In order to write the image support in algebraic form, the concept of chains is introduced. Any set of oriented q-pixels of a cubical complex can be written in algebraic form by attributing them the coefficient 0,1 or −1, if they are not in the set or if they should or not be taken with positive orientation, respectively. In order to represent weighted domains, arbitrary integer multiplicity for each q-pixel is allowed.

Given a topological space X ⊂ Rⁿ in terms of a cubical complex, a free abelian group C_{q}(X) generated by all the q-pixels is obtained. The elements of this group are called q-chains and they are formal linear combinations of q-pixels [45]. A formal expression for a q-chain c_{q} is

$${c}_{q} = {\sum }_{{γ}_{i} ∈ K} {λ}_{i} {γ}_{i}$$

where λᵢ ε Z.

The last step needed for the description of the image plan is the introduction of the concept of boundary of a chain. Given a q-pixel γ, its boundary ∂γ is defined as the (q−1)-chain corresponding to the alternating sum of its (q−1)faces. The sum is taken according to the orientation of the (q−1)-faces with respect to the orientation of the q-pixel. It is said that a (q−1)-face of γ is relatively positively oriented with respect to the orientation of γ if its orientation is compatible with the orientation of γ. By linearity, the extension of the definition of boundary to arbitrary q-chains is expedient. For instance, in

FIGS. 45b and 45c, the boundary of the 1-pixel a is x₂−x₁ and the boundary of the 2-pixel A is a+b−c−d whereby a and b are positively oriented with respect to orientation of A but c and d are negatively oriented with respect to orientation of A. Let us notice that the boundary of a 1-pixel is always the difference of its boundary points. The boundary can be defined recursively. Suppose a (q−1)-chain and a q-chain γ_{q} defined as γ_{q}=γ_{q-1}×[a, b], the boundary of γ_{q} can be recursively written as:
∂γ_{q}=∂γ_{q-1}×[a, b]+(−1)^{(q-1)}(γ_{q-1}×{b{−γ_{q-1}×{a}) (76)

In order to model the pixels quantity over the image plane, an application F has to be found to associate a global quantity with all q-pixels γ of a cubical complex. This application is denoted <F, γ>. This quantity may be any mathematical entities such as scalars, vectors, etc. For two adjacent q-pixels γ₁ and γ₂. F must satisfy <F, λ₁γ₁+λ₂γ₂>=λ₁<F, γ₁>+λ₂<F, γ₂>, which means that the sum of the quantity over each pixel is equal to the quantity over the two pixels. The resulting transformation F:C_{q}(X)→R is called a q-cochain and is used as a representation of a quantity over the cubical complex.

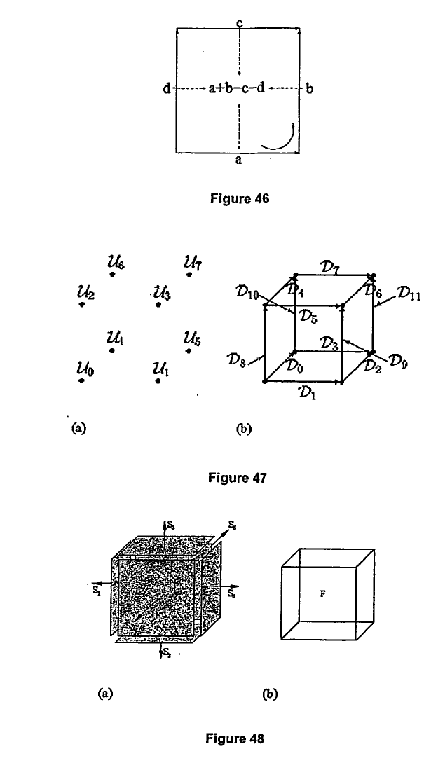

An operator is finally needed to associate a global quantity to the (q+1)-pixels according to the global quantities given on their q-faces. Given a q-cochain F, an operator ∂, called the coboundary operator, is used to transform F into a (q+1)-cochain ∂F such that:
<δF, γ>=<F, ∂γ> (77)
for all (q+1)-chains γ. The coboundary is defined as the signed sum of the physical quantities associated with the q-faces of γ. The sum is taken according to the relative orientation of the q-faces of the (q+1)-pixels of γ with respect to their orientation. FIG. 46 presents an example of the coboundary operation for a 2-pixel.
Representation of the Equilibrium Equation

The basic laws of FIG. 44 with concepts of algebraic topology in order to get a generic algorithm for solving the equilibrium Equation (74) will now be modeled.

The algorithm is resumed as follows: 1) The image support is firstly subdivided into cubical complexes; 2) Global quantities are computed over pixels of various dimensions via cochains according to basic laws; 3) The constitutive equations 69 and 70 are expressed as a linear transformation between two cochains.

The Relative Displacement

Let B be a body in a 3D space and K^{p} be a 3-complex representing the subdivided spatial support of B. Let us consider a 0-cochain U and a 1-cochain D such that D is the coboundary of U:

$$\begin{matrix}𝒟 : {𝒞}_{1} ( {𝒦}^{p} ) -> {ℝ}^{3} \\ γ ↦ 〈 𝒟 , γ 〉 = 〈 δ𝒰 , γ 〉 = 〈 𝒰 , \partial γ 〉\end{matrix} \qquad ( 78 )$$

FIGS. 47a and 47b present some examples of U and D for a 3-pixel of K^{p}.

The computational rules for both cochains U and D will now be specified. Recalling the strain-displacement relation (Equation (66)):

$${ɛ}_{ij} = \frac{1}{2} [ \frac{\partial {u}_{j}}{\partial {x}_{i}} + \frac{\partial {u}_{i}}{\partial {x}_{j}} ] \qquad ( 79 )$$

we have an application ε′:

$$\begin{matrix}{ɛ}^{′} : {ℝ}^{3} -> {ℝ}^{6} \\ U ↦ {ɛ}^{′} ( U ) = {( {ɛ}_{11} , {ɛ}_{22} , {ɛ}_{33} , {ɛ}_{12} , {ɛ}_{13} , {ɛ}_{23} )}^{T}\end{matrix}$$

Omitting the shear strain components as in [67], the following relation may be defined:

$$\begin{matrix}{ɛ}^{′} : {ℝ}^{3} -> {ℝ}^{3} \\ U ↦ ɛ ( U ) = {( {ɛ}_{11} , {ɛ}_{22} , {ɛ}_{33} )}^{T} = ∇ U\end{matrix} \qquad ( 80 )$$

Using the global form of Equation (80) over a 1-pixel γ_{D} such that ∂γ_{D}=x_{*}−x_{#}, the following relation is obtained:

$${\int }_{γ D} ɛ ( U ) ⅆ {γ}_{D} = {\int }_{{x}_{\#}}^{{x}_{*}} ɛ ( U ) ⅆ {γ}_{D} = {\int }_{{x}_{\#}}^{{x}_{*}} ∇ U ⅆ {γ}_{D} \qquad ( 81 )$$

where dγ_{D} is an infinitesimal part of the domain γ_{D}. Since Δu is a conservative field, applied is the line integral theorem [55, 71] which states that for a conservative field F(x)=∇f(x) and for two points A and B in an opened connected region containing F(x) the integral of the tangential part of F(x) along a curve R joining A and B Is independent of the path:

$${\int }_{A}^{B} F ( x ) ⅆ R = f ( B ) - f ( A )$$

From Equation (81), the following relation is then obtained:

$${\int }_{{x}_{\#}}^{{x}_{*}} ∇ U ⅆ {γ}_{D} = U ( {x}_{*} ) - U ( {x}_{\#} ) \qquad ( 82 )$$

On the other hand, applying the cochain D to the 1-pixel γ_{D} leads to:
<D, γ_{D}>=<U, ∂γ_{D}>=U(x_{*}−x_{#})=U(x_{*})−U(x_{#}) (83)
which is the same form as Equation (82). U(x)=U(x) is then defined. Consequently, the location of the displacement vector U must correspond to the 0-pixels of K^{p}. The previous definitions are extended by linearity to the 1-chains of K^{p}.
The Force-Stress Relation

Let us consider another 3-complex K^{s} also representing the subdivided spatial support of the body B. Let us also consider a 3-cochain F and a 2-cochain S such that F is the coboundary of S:

$$ℱ : {𝒞}_{3} ( {𝒦}^{p} ) -> {ℝ}^{3} \\ γ ↦ < ℱ , γ >= < δ 𝒮 , γ >= < 𝒮 , \partial γ > \qquad ( 84 )$$

FIGS. 48a and 48b present some examples of F and S for a 3-pixel of K^{p}.

Let γ_{F} be a 3-pixel of K^{s} and γ_{S} be a 2-chain over K^{s} such that γ_{S}=∂γ_{F}. Let us assume that the 2-faces γ_{S}, of γ_{F} are relatively positively oriented with respect to the orientation of γ_{F}. The definition of the coboundary leads to:

$$< ℱ , {γ}_{F} >= {\sum }_{{γ}_{{s}_{j}}} < 𝒮 , {γ}_{{S}_{j}} > \qquad ( 85 )$$

Again, the computational rules associated with F and S are determined. Setting a zero velocity field in Equation (71) leads to:

$${\int \int }_{V} ρ {b}_{i} ⅆ V = {\int \int }_{S} - {σ}_{i} \cdot n ⅆ S$$

where σ₁=(σ₁ᵢ, σ₂ᵢ, σ₃ᵢ). To fulfill Equation (85), the following relation is defined:

$$\begin{matrix}< {ℱ}_{i} , {γ}_{F} >= {\int \int \int }_{V} ρ {b}_{i} ⅆ V and & ( 86 ) \\ < {𝒮}_{i} , {γ}_{{S}_{j}} >= {\int \int }_{S} - {σ}_{i} \cdot n ⅆ S ( i = 1 , 2 , 3 ) & ( 87 )\end{matrix}$$

where
F=(F₁, F₂, F₃)^{T}
and
S=(S₁, S₂, S₃)^{T}
The Stress-Strain Relation

Exact global versions of Equations (66) on K^{p} and (74) on K^{s} having been presented by the means of Equations (83), (86) and (87). In order to complete the scheme of FIG. 44, representation of the Hooke's law (Equations 69 and 70) which links the local values of ε(x) and σ(x) is needed. Since Equations (69) and (70) are constitutive equations, a topological expression thereof cannot be provided. Instead, they are expressed as linear transformations between the cochains D and S:
D [symbol] S

To find this transformation, Equation (87) is recalled:

$$< {𝒮}_{i} , {γ}_{{S}_{j}} >= \int {\int }_{S} - {σ}_{i} \cdot n ⅆ S ( i = 1 , 2 , 3 )$$

which links the cochain S with the strains ε using the generalized Hooke's law. Unfortunately, the strains are only known at a finite number of points and are then approximated over the whole domain S with an approximation function \tilde{ε}(x). \tilde{ε}(x) is chosen such that for each 1-face γ_{D} of a 2-pixel γ of K^{p}, the following relation is obtained:

$${\int }_{{γ}_{D}} \tilde{ɛ} ( x ) \cdot ⅆ R = < 𝒟 , {γ}_{D} > \qquad ( 88 )$$

where dR is an infinitesimal part of the domain represented by γ_{D}. It should be pointed out that that only approximation of the normal components of ε is needed. In fact, given:

$$∇ \tilde{U} ( x ) = {( \frac{\partial {\tilde{U}}_{1}}{\partial {x}_{1}} ( x ) , \frac{\partial {\tilde{U}}_{2}}{\partial {x}_{2}} ( x ) , \frac{\partial {\tilde{U}}_{3}}{\partial {x}_{3}} ( x ) )}^{T} = \\ {( {\tilde{ɛ}}_{11} ( x ) , {\tilde{ɛ}}_{22} ( x ) , {\tilde{ɛ}}_{33} ( x ) )}^{T} = \tilde{ɛ} ( x )$$

where ũ(x) is the approximated displacement vector over γ and if \tilde{e}(x) is chosen to satisfy Equation (88), then the vector Ũ(x) is fully determined. Then the shear components of \tilde{ε}(x) can be computed by appropriately differentiating the components of Ũ(x). Using this remark and applying the generalized Hooke's law to \tilde{ε}(x) satisfying Equation (88), the following relation is obtained:

$${\tilde{σ}}_{ii} ( x ) = \frac{E}{( 1 + v ) ( 1 - 2 v )} [ ( 1 - v ) {\tilde{ɛ}}_{ii} ( x ) + v ( {\tilde{ɛ}}_{jj} ( x ) + {\tilde{ɛ}}_{kk} ( x ) ) ]$$

$${\tilde{σ}}_{ij} ( x ) = \frac{E}{( 1 + v )} {\tilde{ɛ}}_{ij} ( x ) ( i , j , k = 1 , 2 , 3 )$$

at all point of γ. Equation (87) is then replaced by:

$$< {𝒮}_{i} , {γ}_{{S}_{j}} >= \int {\int }_{S} - {\tilde{σ}}_{i} ( x ) \cdot n ⅆ S = {Λ}_{i} ( ɛ ) ( i = 1 , 2 , 3 ) \qquad ( 89 )$$

which depends on the choice of the approximation function \tilde{ε}(x) and of the relative position of K^{s} with respect to K^{p}.
Summary of the Algorithm

The algorithm used to find an expression of the internal forces according to the displacements of a body is now summarized. The input data for this algorithm are the cochain U and the material properties of the body (the values of E and v).
1. Choice of the location of Kₚ with respect to K^{s}.
2. Computation of the cochain D.
3. Computation of the cochain S
   (a) Choice of the approximation function \tilde{ε}(x).
   (b) Application of Equation (89) to express S as a function of the displacement components.
4. Computation of the force by applying Equation (85).
   Applications
   Active Contours

The above described approach is applied to a 2D active contour model based upon a Lagrangian evolution of the curve S:

$$\frac{\partial S}{\partial t} + KS = {F}_{ext} ( S ) \qquad ( 90 )$$

where K is the matrix which contains the regularization forces of the curve.

This dynamic system is discretized in time using a finite difference scheme. For a given time step Δt, the time derivative can be approximated by:

$$\frac{\partial S}{\partial t} ≅ \frac{{S}_{t + Δ t} - {S}_{t}}{Δ t}$$

The curve deformation is governed by each vertex displacements compared to their neighbors until the equilibrium between the inertia forces, the image forces and the internal forces. Equation 90 is solved using an explicit scheme:
S_{t+Δt}=Sₜ+Δt(Fₑₓₜ−KSₜ) (91)

Assuming that the initial curve S₀ was in an equilibrium state and that the initial body forces F₀=KS₀ are constant during the deformation process, these forces can be added to the external forces Fₑₓₜ leading to a modified version of Equation (91):

$$\begin{matrix}{S}_{t + Δ t} = {S}_{t} + Δ t ( {F}_{ext} + {F}_{0} - {KS}_{t} ) \\ = {S}_{t} + Δ t ( {F}_{ext} - ( {KS}_{t} - {KS}_{0} ) ) \\ = {S}_{t} + Δ t ( {F}_{ext} - KU )\end{matrix} \qquad ( 92 )$$

where U is the displacement vector of the curve S.

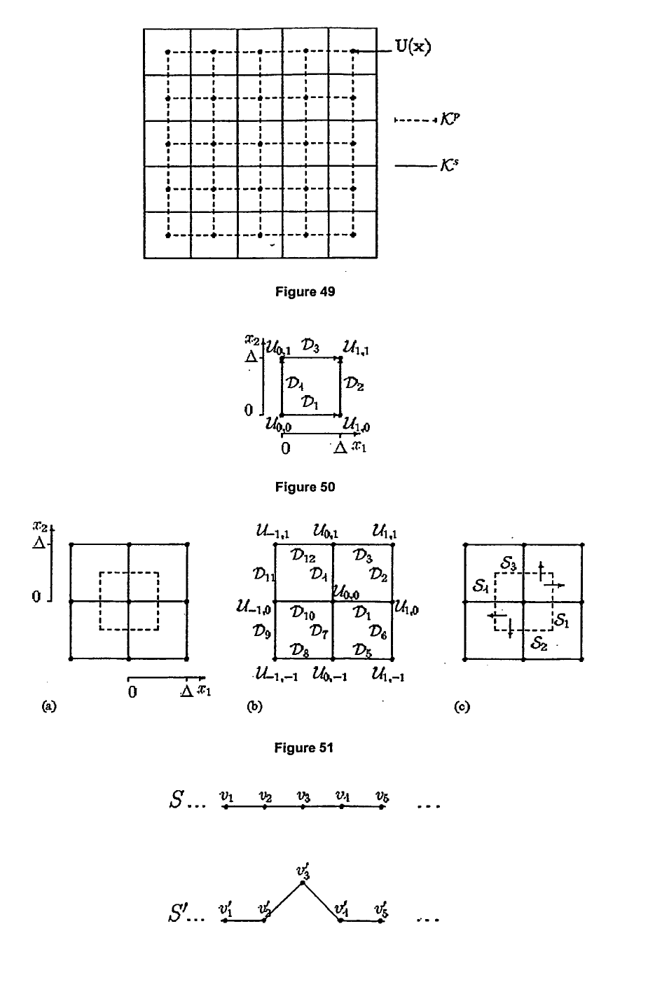

The image subdivision process is similar to the one presented in [57]. Here, it is desired to solve Equation (92) for local U(x) located at the center of each pixel and known initial curve S₀ closed to the solution. Following the steps presented hereinabove, the two dimensional cubical complexes K^{p} and K^{s} are first positioned. As mentioned, K^{p} is placed in order to have its 0-pixels corresponding to the center of the image pixels. K^{s} is positioned in such a way that its 2-pixels coincide with the image pixels. Thus, the 2-pixels of K^{s} are rectangular and symmetrically staggered with the 1-pixels of K^{p} and each 1-pixel of intersects orthogonally in the middle of a 1-pixel of K^{p}. Mattiussi [61] showed that this way of positioning K^{s} allows the use of lower order approximation polynomials without losing accuracy. FIG. 49 shows the two complexes positions for a 5×5 image.

In order to solve Equation (92), global values F are needed over each pixel of K^{s}. Since these values are generally known, there is no need to try to express them in a topological way. In the examples, the gradient field of the bright line plausibility image obtained using a line detector proposed in [54] has been used. It was assumed that the gradient provides global values valid over the whole pixel. Thus F=ΔL is set where L is the line plausibility image, ΔL=g′_{σ} *L and g′_{σ} is the Gaussian derivative at scale σ. An approximation function \tilde{ε}(x)=(\tilde{ε}₁₁ (x), \tilde{ε}₂₂ (x))^{T} is also chosen. For simplicity, it is assumed that \tilde{ε}(x)=∇Ũ(x) arises from a bilinear approximation:
Ũ(x)=(Ũ₁(x), Ũ₂(x))^{T}=a+bx₁+cx₂+dx₁x₂
Thus:
\tilde{ε}₁₁(x)=b+dx₂
\tilde{ε}₂₂(x)=c+dx₂

Since \tilde{ε}₁₁ (x) and \tilde{ε}₂₂ (x) has to satisfy Equation (88) for all 1-faces γ_{D} of any 2-pixel γ of K^{p} as in FIG. 50, the following relations hold:

$${𝒟}_{1} = {\int }_{0}^{Δ} \tilde{ɛ} ( {x}_{1} , 0 ) \cdot {i}^{->} ⅆ {x}_{1}$$

$${𝒟}_{2} = {\int }_{0}^{Δ} \tilde{ɛ} ( Δ , {x}_{2} ) \cdot {j}^{->} ⅆ {x}_{2}$$

$${𝒟}_{3} = {\int }_{0}^{Δ} \tilde{ɛ} ( {x}_{1} , Δ ) \cdot {i}^{->} ⅆ {x}_{1}$$

$${𝒟}_{4} = {\int }_{0}^{Δ} \tilde{ɛ} ( 0 , Δ ) \cdot {j}^{->} ⅆ {x}_{2}$$

from which the following relation is obtained:

$$\tilde{ɛ} ( x ) = \frac{1}{Δ} [ ( {𝒟}_{1} + \frac{{𝒟}_{3} - {𝒟}_{1}}{Δ} {x}_{2} ) , ( {𝒟}_{4} + \frac{{𝒟}_{2} - {𝒟}_{4}}{Δ} {x}_{1} ) ] = ∇ \tilde{U} ( x ) \qquad ( 93 )$$

From Equation 93 and the definition of the normal strains, it is straightforward that:

$$\tilde{U} ( x ) = k + \frac{1}{Δ} ( {𝒟}_{1} {x}_{1} + {𝒟}_{4} {x}_{2} ) + \frac{1}{{Δ}^{2}} ( {𝒟}_{3} - {𝒟}_{1} + {𝒟}_{2} - {𝒟}_{4} ) {x}_{1} {x}_{2} \qquad ( 94 )$$

where k=Ũ(0). Equations (83) and (94) lead to:

$$\begin{matrix}\tilde{U} ( x ) = \tilde{U} ( {x}_{1} , {x}_{2} ) \\ = U ( 0 , 0 ) + \frac{1}{Δ} ( U ( Δ , 0 ) - U ( 0 , 0 ) ) {x}_{1} + \frac{1}{Δ} ( U ( 0 , Δ ) - \\ U ( 0 , 0 ) ) {x}_{2} + \frac{1}{{Δ}^{2}} ( U ( 0 , 0 ) + U ( Δ , Δ ) - U ( 0 , Δ ) - \\ U ( Δ , 0 ) ) {x}_{1} {x}_{2}\end{matrix} \qquad ( 95 )$$

from which the values of \tilde{σ}ᵢ (x)=(\tilde{σ}₁ᵢ′(x), \tilde{σ}₂ᵢ (x))^{T} can be deduced.

The last step is the computation of the internal forces F for each 2-pixel of K^{s}. With K^{p} and K^{s} positioned as mentioned before, each 2-pixel γ_{F} of K^{s} intersects four 2-pixels γ_{A}, γ_{B}, γ_{C} and γ_{D} of K^{p}. That is, four approximation functions \tilde{σ}ᵢ^{A}, \tilde{σ}ᵢ^{B}, \tilde{σ}ᵢ^{C} and \tilde{σ}ᵢ^{D} corresponding to the four intersecting 2-pixels of K^{p} (see FIG. 51) have to be considered.

The value of the cochain S are found over the four 1-face of γ by the appropriate integration:

$${𝒮}_{i}^{1} = {\int }_{0}^{\frac{Δ}{2}} {\tilde{σ}}_{i}^{A} ( \frac{Δ}{2} , {x}_{2} ) \cdot {i}^{->} ⅆ {x}_{2} + {\int }_{- \frac{Δ}{2}}^{0} {\tilde{σ}}_{i}^{B} ( \frac{Δ}{2} , {x}_{2} ) \cdot {i}^{->} ⅆ {x}_{2}$$

$${𝒮}_{i}^{2} = {\int }_{0}^{\frac{Δ}{2}} {\tilde{σ}}_{i}^{B} ( {x}_{1} , - \frac{Δ}{2} ) \cdot - \vec{j} ⅆ {x}_{1} + {\int }_{- \frac{Δ}{2}}^{0} {\tilde{σ}}_{i}^{C} ( {x}_{1} , - \frac{Δ}{2} ) \cdot - \vec{j} ⅆ {x}_{1}$$

$${𝒮}_{i}^{3} = {\int }_{0}^{\frac{Δ}{2}} {\tilde{σ}}_{i}^{A} ( {x}_{1} , \frac{Δ}{2} ) \cdot {j}^{->} ⅆ {x}_{1} + {\int }_{- \frac{Δ}{2}}^{0} {\tilde{σ}}_{i}^{D} ( {x}_{1} , \frac{Δ}{2} ) \cdot {j}^{->} ⅆ {x}_{1}$$

$${𝒮}_{i}^{4} = {\int }_{0}^{\frac{Δ}{2}} {\tilde{σ}}_{i}^{D} ( - \frac{Δ}{2} , {x}_{2} ) \cdot - {i}^{->} ⅆ {x}_{2} + {\int }_{- \frac{Δ}{2}}^{0} {\tilde{σ}}_{i}^{C} ( - \frac{Δ}{2} , {x}_{2} ) \cdot - {i}^{->} ⅆ {x}_{2}$$

Equation (85) leads to:
<Fᵢ, γ_{F}>=Sᵢ¹+Sᵢ²+Sᵢ³+Sᵢ⁴ (96)

By substituting Equations (96) and (95) in Equation (96), the internal forces F can be expressed as a function of the displacement U. As an example, the values of F are represented for the 2-pixel γ_{F} of FIG. 50 with Δ=1:

$${F}_{1} = C [ ( 3 - 4 v ) {u}_{- 1 , 1} + ( 2 - 8 v ) {u}_{0 , 1} + ( 3 - 4 v ) {u}_{1 , 1} + ( 10 + 8 v ) {u}_{- 1 , 0} + ( - 36 + 48 v ) {u}_{0 , 0} + ( 10 - 8 v ) {u}_{1 , 0} + ( 3 - 4 v ) {u}_{- 1 , - 1} + ( 2 - 8 v ) u 0 , - 1 + ( 3 - 4 v ) {u}_{1 , - 1} - 2 {υ}_{- 1 , 1} + 2 {υ}_{1 , 1} + 2 {υ}_{- 1 , - 1} - 2 {υ}_{1 , - 1} ]$$

$${F}_{2} = C [ ( 3 - 4 v ) {u}_{- 1 , 1} + ( 10 - 8 v ) {u}_{0 , 1} + ( 3 - 4 v ) {u}_{1 , 1} + ( 2 - 8 v ) {u}_{- 1 , 0} + ( - 36 + 48 v ) {u}_{0 , 0} + ( 2 - 8 v ) {u}_{1 , 0} + ( 3 - 4 v ) {u}_{- 1 , - 1} + ( 10 - 8 v ) {u}_{0 , - 1} + ( 3 - 4 v ) {u}_{1 , - 1} - 2 {υ}_{- 1 , 1} + 2 {υ}_{1 , 1} + 2 {υ}_{- 1 , - 1} - 2 {υ}_{1 , - 1} ]$$

$$where \text{:} C = \frac{E}{16 ( 1 + v ) ( 1 - 2 v )} and 𝒰 = [ \begin{matrix}u \\ v\end{matrix} ]$$

Equation (97) induces a linear relationship between a pixel and its neighbors. This relation is used to build the stiffness matrix of Equation (91). If Uₓ_{₁} (i=1, 2) is considered as the displacement vector for the component xᵢ then:
Fᵢ(x)=Uₓ_{₁}*Nₓ_{₁}ⁱ+Uₓ_{₂}*Nₓ_{₂}ⁱ
where

$${N}_{{x}_{1}}^{i} = \frac{E}{16 ( 1 + v ) ( 1 - 2 v )} [ \begin{matrix}3 - 4 v & 2 - 8 v & 3 - 4 v \\ 10 - 8 v & - 36 + 48 v & 10 - 8 v \\ 3 - 4 v & 2 - 8 v & 3 - 4 v\end{matrix} ]$$

$${N}_{{x}_{2}}^{i} = \frac{E}{16 ( 1 + v ) ( 1 - 2 v )} [ \begin{matrix}- 2 & 0 & 2 \\ 0 & 0 & 0 \\ 2 & 0 & - 2\end{matrix} ]$$

$${N}_{{x}_{3}}^{i} = \frac{E}{16 ( 1 + v ) ( 1 - 2 v )} [ \begin{matrix}- 2 & 0 & 2 \\ 0 & 0 & 0 \\ 2 & 0 & - 2\end{matrix} ]$$

$${N}_{{x}_{4}}^{i} = \frac{E}{16 ( 1 + v ) ( 1 - 2 v )} [ \begin{matrix}3 - 4 v & 10 - 8 v & 3 - 4 v \\ 2 - 8 v & - 36 + 48 v & 2 - 8 v \\ 3 - 4 v & 10 - 8 v & 3 - 4 v\end{matrix} ]$$

The pairs (Nₓ_{ᵢ}^{l}, Nₓ_{₂}^{l}), (i=1, 2) will be referred to as the stiffness kernels.

Computation of the Displacement Vector

The assumption made when calculating the displacement vector will now be explained. Let v be a vertex of subdivided curve S and v′ be its corresponding vertex in the deformed curve S′. Let us denote by U[v] the entry in the displacement vector U corresponding to v. Let us suppose that the displacement is constant in each direction everywhere that is U[v]=(k₁, k₂)^{T} with k₁, k₂ ε R for all v in S. Since the sum of all entries of either Nₓ_{₁}¹, Nₓ_{₂}¹, Nₓ_{₁}² or Nₓ_{₂}² is zero, it follows that F₁[v]=F₂[v]=0 for all v in S which means that there is no internal force induced. The computation of the internal forces with the stiffness kernels is then invariant with respect to translation.

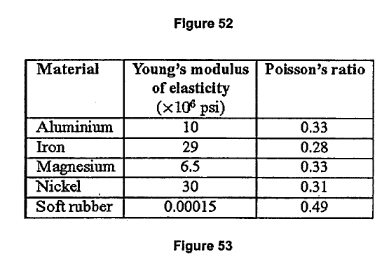

Let v₁, v₂, v₃, v₄ and v₅ be five adjacent vertices of S and v′₁, v′₂, v′₃, v′₄, v′₅ be their corresponding vertices in S′ (see FIG. 52).

Let v_{i,x}_{ⱼ} be the xⱼ coordinate of the spatial representation of the vertex vᵢ. Then, the following relation is obtained:
Uₓ_{ᵢ}=( . . . , v′_{1,x}_{ᵢ}−v_{1,x}_{ᵢ}, v′_{2,x}_{ᵢ}−v_{2,x}_{ᵢ}, v′_{3,x}_{ᵢ}−v_{3,x}_{ᵢ}, v′_{4,x}_{ᵢ}−v_{4,x}_{ᵢ}, v′_{5,x}_{ᵢ}−v_{5,x}_{ᵢ}, . . . )^{T} (i=1

The translation invariance property leads to:

$$\begin{matrix}{F}_{i} ( x ) = {U}_{{x}_{1}} * {N}_{{x}_{1}}^{i} + {U}_{{x}_{2}} * {N}_{{x}_{2}}^{i} \\ = [ {U}_{{x}_{1}} - [ {υ}_{2 , {x}_{1}}^{′} - {υ}_{2 , {x}_{1}} ] ] * {N}_{{x}_{1}}^{i} + [ {U}_{{x}_{2}} - [ {υ}_{2 , {x}_{2}}^{′} - {υ}_{2 , {x}_{2}} ] ] * {N}_{{x}_{2}}^{i}\end{matrix}$$

where [v′_{2,x}_{₁}−v_{2,x}_{₁}] stands for a matrix whose all entries equal v′_{2,x}_{₁}−v_{2,x}_{₁}. The displacement component used to compute the internal force Fᵢ at vertex v₃ is then:

$${U}_{{x}_{k}} [ {v}_{3} ] = ( {v}_{3 , {x}_{k}}^{′} - {v}_{3 , {x}_{k}} ) - ( {v}_{2 , {x}_{k}}^{′} - {v}_{2 , {x}_{k}} ) \\ = ( {v}_{3 , {x}_{k}}^{′} - {v}_{2 , {x}_{k}}^{′} ) - ( {v}_{3 , {x}_{k}} - {v}_{2 , {x}_{k}} )$$

which is the relative displacement of the vertex v₃ with respect to v₂. However, nothing prevents computing the relative displacement of v₃ with respect to v₃. In this case, the xₖ displacement component used to compute the internal force Fᵢ at vertex v₃ would be:

$$\begin{matrix}{U}_{{x}_{k}} [ {v}_{3} ] = ( {v}_{3 , {x}_{k}}^{′} - {v}_{3 , {x}_{k}} ) - ( {v}_{4 , {x}_{k}}^{′} - {v}_{4 , {x}_{k}} ) \\ = ( {v}_{3 , {x}_{k}}^{′} - {v}_{4 , {x}_{k}}^{′} ) - ( {v}_{3 , {x}_{k}} - {v}_{4 , {x}_{k}} )\end{matrix}$$

In order to take into account these facts, the average value of the relative displacements for all adjacent vertices to v₂ is used. Thus:

$${U}_{{x}_{k}} [ {v}_{2} ] = \frac{1}{2} [ \begin{matrix}( {v}_{3 , {x}_{k}}^{′} - {v}_{2 , {x}_{k}}^{′} ) - ( {v}_{3 , {x}_{k}} - {v}_{2 , {x}_{k}} ) + \\ ( {v}_{3 , {x}_{k}}^{′} - {v}_{4 , {x}_{k}}^{′} ) - ( {v}_{3 , {x}_{k}} - {v}_{4 , {x}_{k}} )\end{matrix} ] \qquad ( 97 )$$

Reorganizing the terms of Equation (97), for an arbitrary vertex vᵢ of S, the following relation is obtained:

$$\begin{matrix}{U}_{{x}_{k}} [ {v}_{i} ] = [ \frac{{v}_{i + 1 , {x}_{k}} - 2 {v}_{i , {x}_{k}} + {v}_{i - 1 , {x}_{k}}}{2} ] - \\ [ \frac{{v}_{i + 1 , {x}_{k}}^{′} - 2 {v}_{i , {x}_{k}}^{′} + {v}_{i - 1 , {x}_{k}}^{′}}{2} ] or \\ U [ {v}_{i} ] = [ \frac{{v}_{i + 1} - 2 {v}_{i} + {v}_{i - 1}}{2} ] - [ \frac{{v}_{i + 1}^{′} - 2 {v}_{i}^{′} + {v}_{i - 1}^{′}}{2} ] \\ = \frac{1}{2} [ \frac{{\partial }^{2} S}{\partial {v}^{2}} - \frac{{\partial }^{2} {S}^{′}}{\partial {v}^{2}} ]\end{matrix} \qquad ( 98 )$$

if we assume a finite difference approximation of the second derivative of S and S′ with respect to their vertices.

Let us finally notice that the second derivative of the curve S in Equation (98) can be computed using Gaussian derivatives:

$$\frac{{\partial }^{2} S}{\partial {v}^{2}} = {g}_{σ}^{″} * S$$

where σ controls the degree of smoothing. Such a computation of the second derivative of S allows to obtain smooth results by simulating a smoother target curve.
Experimental Results
Active Contours

The approach proposed herein has been experimented on real and synthetic images in the context of high-resolution images of road databases. For each image, the results have been compared with another method.

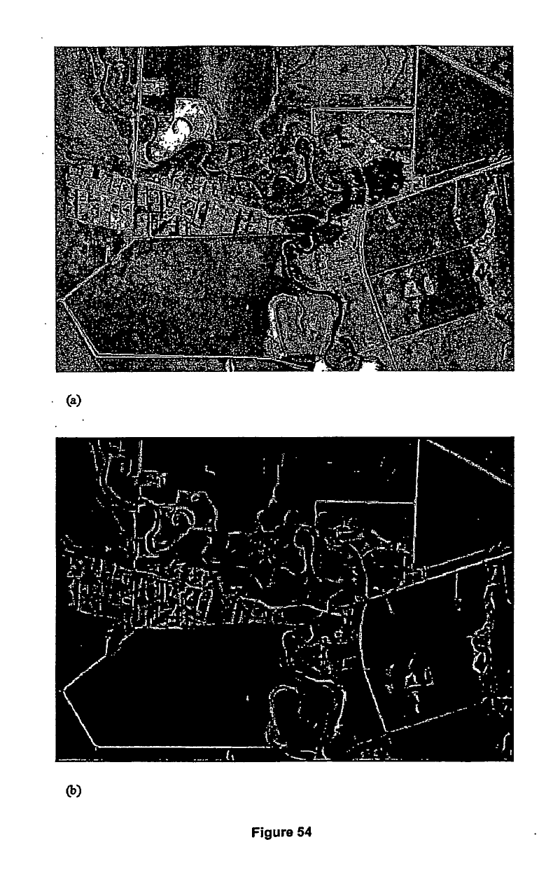

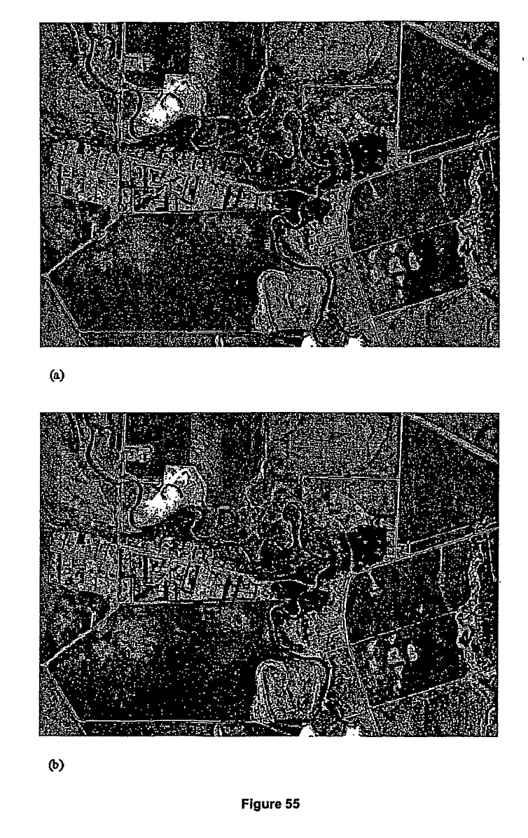

FIG. 55a presents the results for the physics-based method (PB) according to the present invention for an aerial image while FIG. 55b shows the results for the finite element (FEM) method (α and β unknown). A material similar to rubber (see the Table in FIG. 53) with E=150 and v=0.45 has been simulated. In both images, the image force is the gradient (σ=1.5) of the bright line plausibility image obtained using a line detector proposed in [54] with the line detection scale set to 0.8. FIGS. 54a and 54b show respectively the initial curve S₀ and the bright line plausibility image.

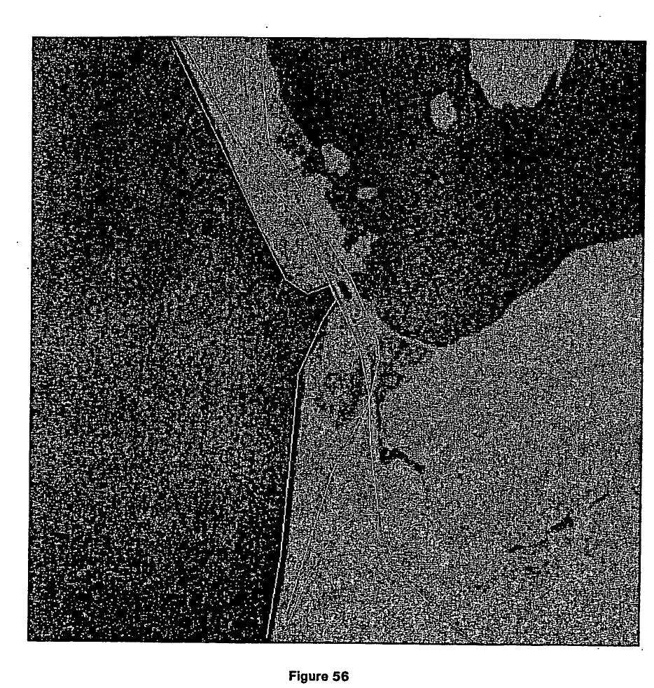

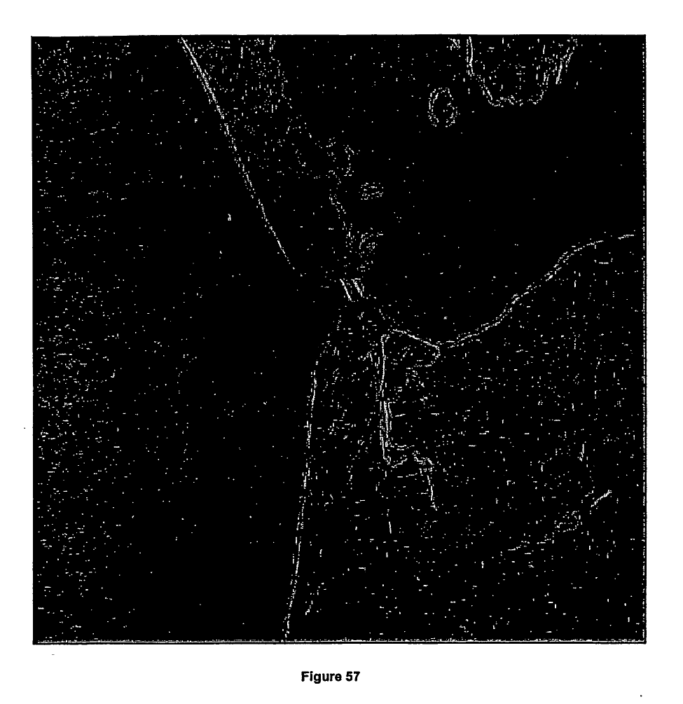

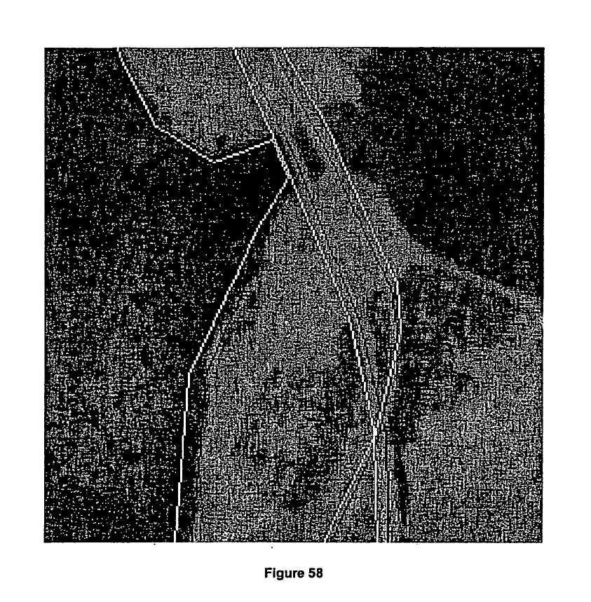

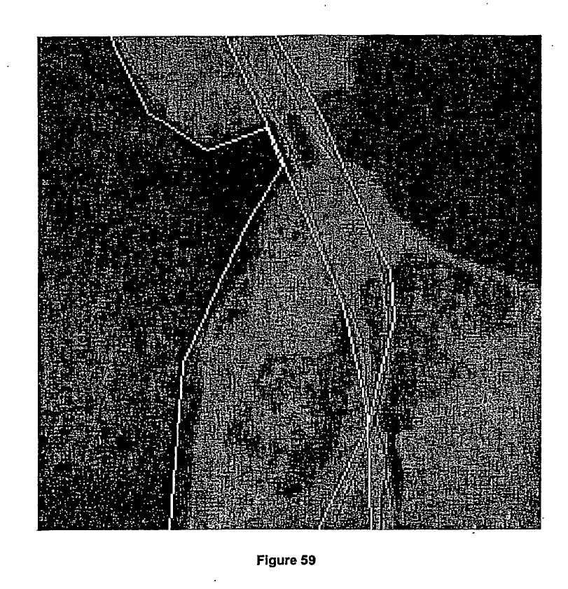

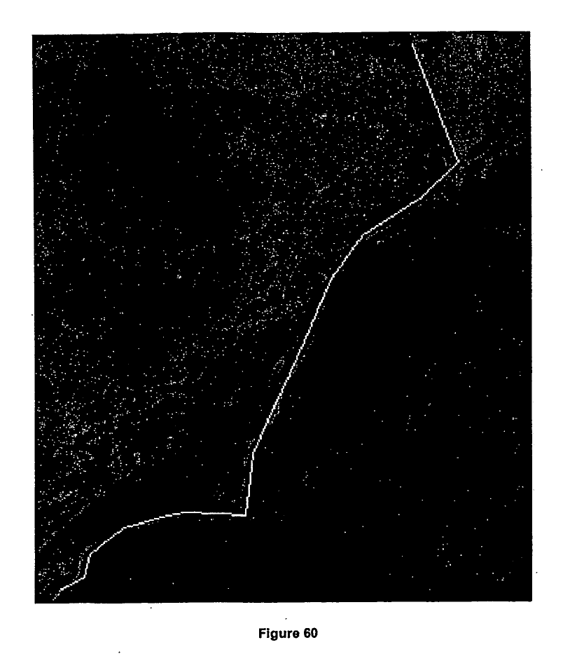

FIG. 56 shows a SAR image in which the initial curves are drawn in white. The line plausibility image (σ=1.5 and line detection scale=0.8) of both bright and dark lines is shown in FIG. 57. FIGS. 58 and 59 presents respectively the results obtained with PB (E=150 and v=0.45) and FEM (α and β unknown) methods. One can notice that the PB curves are closer to the shore than the FEM especially in region of high curvature.

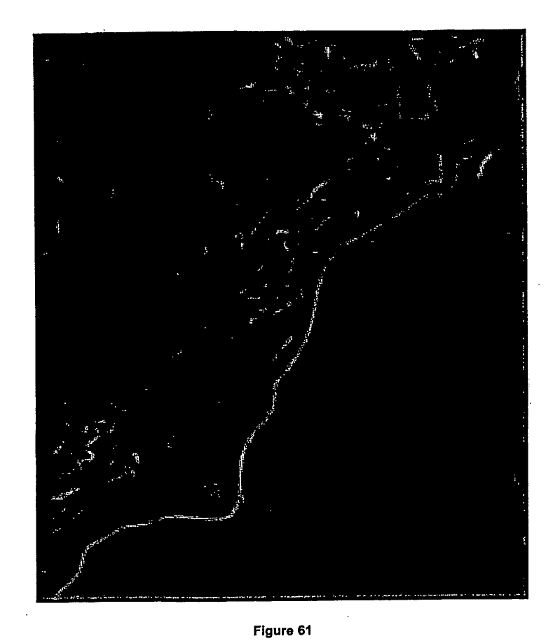

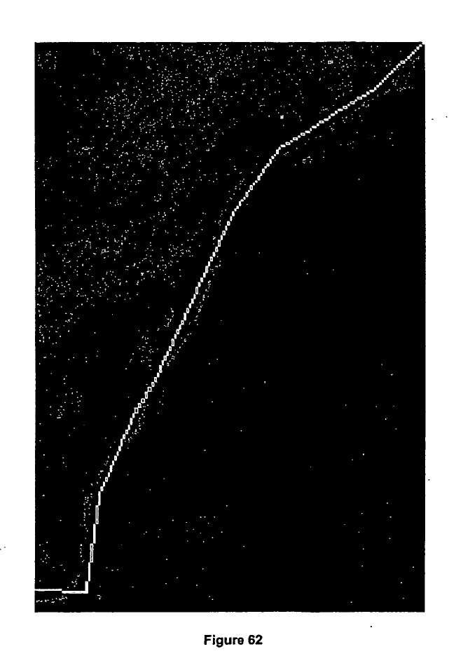

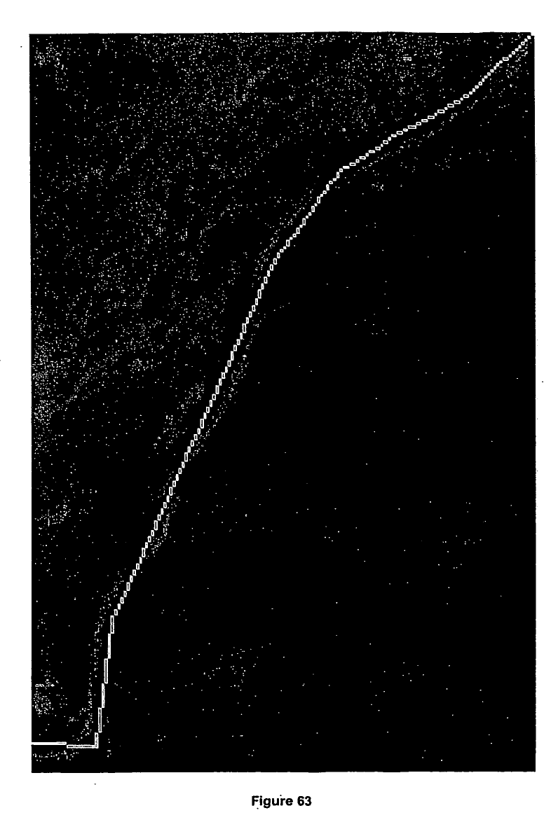

FIG. 60 shows some initialization for the first band of a Landsat 7 image. The bright line plausibility image (σ=1.5 and line detection scale=0.8) is shown in FIG. 61. FIGS. 62 and 63 present the results obtained with the PB and FEM methods respectively.

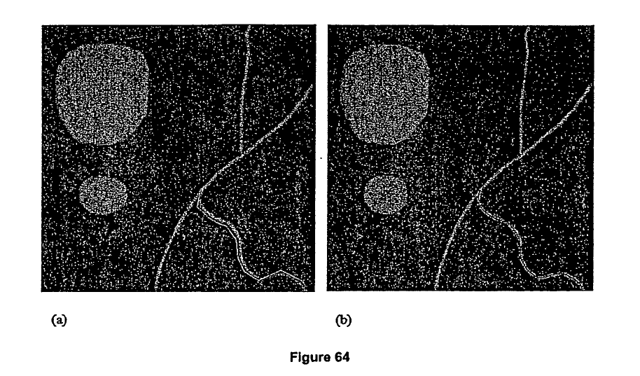

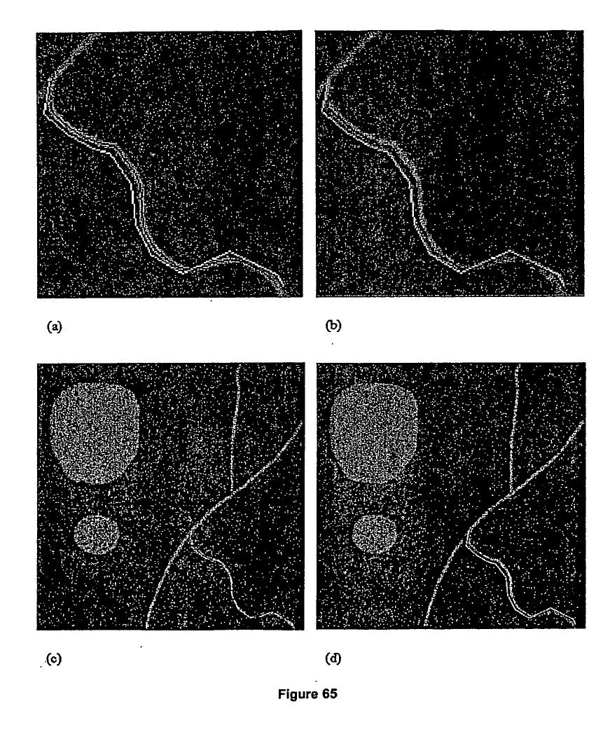

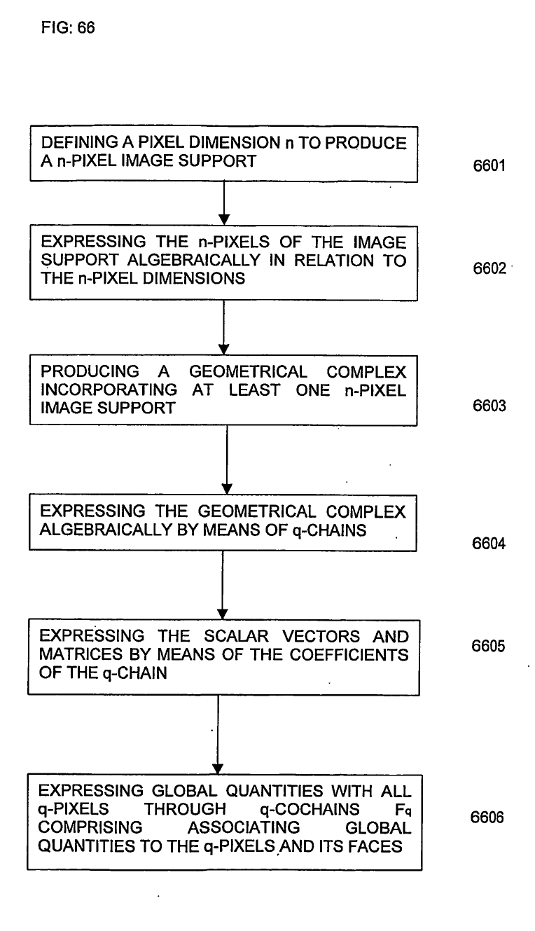

The fact that the deformations obtained using the model according to this illustrative embodiment of the present invention have a physical interpretation has been discussed. The fact that the objects modeled using the PB method have their own physical properties and the ability to recover their original shape when the external forces applied on them are removed has also been discussed. To illustrate this fact, FIGS. 64a and 64b show some initialization and the corrected curve for a synthetic image. FIGS. 65a through FIGS. 65d show the evolution of this corrected curve when the external forces are removed. FIG. 65d presents both the final curve (in black) and the initial curve (in white). One can clearly notice that the curve has recovered its original shape but has also experienced a spatial shift.

Conclusion

A new model for active contours was presented. The proposed approach decompose the image using an image model based on algebraic topology. This model uses generic mathematical tools which can be applied to solve other problems such as linear and non-linear diffusion and optical flow [57]. Moreover, the model works with either 2D or 3D images and can easily be extended to active surfaces and active volumes.

The approach presents the following differences with the other methods: 1) Both global and local quantities are used; 2) The model is based upon basic laws of physics. This allows us to give a physical explanation to the deformation steps; 3) The curves and surfaces have physical behaviors such as the ability to recover their original shape once the applied forces are removed; 4) Approximation are made only when the constitutive equation is involved.

Although the present invention has been described hereinabove by way of non-restrictive illustrative embodiments thereof, it can be modified at will, within the scope of the appended claims, without departing from the spirit and nature of the subject invention.

### REFERENCES

[1] M. Allili and D. Ziou, Extraction of topological properties of images via cubical homology, Technical Report, 2000.
[2] M. Allili and D. Ziou, Topological Feature Extraction in Binary Images, IEEE ISSPA, Malysia, August 2001.
[3] M. Allili, K. Mischaikow, and A. Tannenbaum, Cubical Homology and the Topological Classification of 2D and 3D Imagery, Int. Conf. Image Processing, Greece, 2001.
[4] M. F. Auclair-Fortier, P. Poulin, D. Ziou, and M. Allili, Computational Algebraic Topology for Resolution of the Poisson Equation: Application to Computer Vision, Technical Report, 2001.
[5] R. Egli and N. F. Stewart, A framework for system specification using chains on cell complexes, Computer Aided Design 32, 447-459, 2000.
[6] P. J. Giblin, Graphs, Surfaces and Homology, Chapman and Hall, London, 1977.
[7] T. Y. Kong and A. Rosenfeld, Digital Topology: Introduction and Survey, CVGIP 48, 357-393, 1989.
[8] V. A. Kovalvesky, Finite Topology to Image Analysis, Comp. Vision, and Image Processing 46, 141-161, 1989.
[9] W. S. Massey, A Basic Course in Algebraic Topology, Springer-Verlag, New York, 1991.
[10] J. R. Munkres, Elements of Algebraic Topology, Addison-Wesley, 1984.
[11] R. S. Palmer and V. Shapiro, Chain Models of Physical Behavior for Engineering Analysis and Design, Research in Engineering Design 5, 161-184, 1993.
[12] P. Poulin, D. Ziou, and M. F. Auclair-Fortier, Computational Algebraic Topology for Deformable Objects, Technical Report, 2001.
[13] A. S. Schwarz, Topology for Physicists, Springer-Verlag, 1994.
[14] E. Tonti, On the Formal Structure of Physical Theories, Technical Report Istituto Di Mathematica Del Politechnico Di Milano, Milan, 1975.
[15] D. Ziou and M. Allili, Computation of the Euler Number in Binary Images without Skeletonization via Cubical Complex, Technical Report, 2001.
[16] M. Allili and D. Ziou. Extraction of Topological Properties of Images via Cubical Homology. Technical Report CDSNS 2000-365, Georgia Institute of Technology, June 2000.
[17] L. Alvarez, R. Deriche, and F. Santana. Recursivity and PDE's in Image Processing. In Proceedings 15th International Conference on Pattern Recognition, volume I, pages 242-248, September 2000.
[18] J. L. Barron, D. J. Fleet, and S. S. Beauchemin. Systems and Experiment Performance of Optical Flow Techniques. International Journal of Computer Vision, 12(1):43-77, 1994.
[19] S. S. Beauchemin and J. L. Barron. The Computation of Optical Flow. ACM Computing Survey, 27(3), 1995.
[20] A. J. Chapman. Fundamentals of Heat Transfer. Macmillan Publishing Company, 1987.
[21] A. K. Chhabra and T. A. Grogan. On Poisson Solvers and Semi-Direct Methods for Computing Area Based Optical Flow. IEEE Transactions on Pattern Analysis and Machine Intelligence, 16:1133-1138, 1994.
[22] H. Chidiac and D. Ziou. Formation d'images optiques. Technical Report 226, Département de mathématiques et d'informatique, Universitë de Sherbrooke, November 1998.
[23] L. D. Cohen and I. Cohen. Finite Element Methods for Active Contour Models and Balloons for 2D and 3D Images. IEEE Transactions on Pattern Analysis and Machine Intelligence, 15, Nov. 1993.
[24] L. D. Cohen. On active contour models and balloons. Computer Vision, Graphics and Image Processing, 53(2):211-218, March 1991.
[25] R. Deriche and O. Faugeras. Les EDP en traitement des images et vision par ordinateur. Technical Report 2697, INRIA, November 1995.
[26] C. H. Edwards and D. E. Penney. Calculus with Analytic Geometry. Prentice Hall, 1998.
[27] H. U. Fuchs. The Dynamics of Heat. Springer-Verlag, 1996.
[28] D. Halliday, R. Resnick, and J. Walker. Fundamentals of Physics. John Willey and Sons, 1997.
[29] B. K. P. Horn and B. Schunck. Determining Optical Flow. Artificial Intelligence, 17:185-203, 1981.
[30] J. Kervorkian. Partial Differential Equations: Analytical Solution Techniques, chapter 2, pages 48-116. Mathematics Series. Chapman and Hall, 1990.
[31] S. H. Lai and B. C. Vermuri. An O(n) Iterative Solution to the Poisson Equation in Low-level Vision Problems. Technical Report TR93-035, University of Florida, Computer and Information Sciences Department, 1993.
[32] J. Li and A. O. Hero. A Spectral Method for Solving Elliptic Equations for Surface Reconstruction and 3D Active Contours. Proceedings of IEEE International Conference on Image Processing, Thessaloniki, Greece, October 2001.
[33] G. T. Mase and G. E. Mase. Continuum Mechanics for Engineers. CRC Press, 1999.
[34] C. Mattiussi. An Analysis of Finite Volume, Finite Element, and Finite Difference Methods Using Some Concepts from Algebraic Topology. Journal of Computational Physics, 133:289-309, 1997.
[35] J. Monteil and A. Beghdadi. A New Interpretation and Improvement of the Nonlinear Anisotropic Diffusion for Image Enhancement. IEEE Transactions on Pattern Analysis and Machine Intelligence, 21(9):940-946, September 1999.
[37] S. V. Patankar. Numerical Heat Transfer and Fluid Flow. Computational Methods in Mechanics and Thermal Sciences. McGraw-Hill Book Company, 1980.
[38] P. Perona and J. Malik. Scale-Space and Edge Detection Using Anisotropic Diffusion. IEEE Transactions on Pattern Analysis and Machine Intelligence, 12(7):629-639, July 1990.
[39] T. Symchony, R. Chellappa, and M. Shao. Direct Analytical Methods for Solving Poisson Equations in Computer Vision Problems. IEEE Transactions on Pattern Analysis and Machine Intelligence, 12(5):435-446, May 1990.
[40] D. Terzopoulos. Image Analysis Using Multigrid Relaxation Methods. IEEE Transactions on Pattern Analysis and Machine Intelligence, 8:129-129, 1986.
[41] G. B. Thomas and R. L. Finney. Calculus and Analytic Geometry. Addison-Wesley Publishing Company, 1988.
[42] E. Tonti. On the Formal Structure of Physical Theories. Technical report, Istituto Di Mathematica Del Polithechnico Di Milano, 1975.
[43] J. Weickert. A Review of Nonlinear Diffusion Filtering. Lecture Notes in Computer Science, 1252:3-28, 1997.
[44] E. Zauderer. Partial Differential Equations of Applied Mathematics. Pure and Applied Mathematics. John Willey and Sons, New York, US, 1983.
[45] M. Allili and D. Ziou. Extraction of Topological Properties of Images via Cubical Homology. Technical Report CDSNS 2000-365, Georgia Institute of Technology, June 2000.
[46] M.-F. Auclair-Fortier, D. Ziou, C. Armenakis, and S. Wang. Automated Correction and Updating of Road Databases from High-Resolution Imagery. Canadian Journal of Remote Sensing, 27:76-89, 2001.
[48] K. J. Bathes. Finite element procedures. Prentice Hall, 1996.
[49] A. P. Boresi. Elasticity in Engineering Mechanics. Prentice Hall, 1965.
[50] A. P. Boresi, R. J. Schmidt, and O. M. Sidebottom. Advanced Mechanics of Materials, Fifth edition. John Willey and Sons, 1993.
[51] M. Bro-Nielsen. Surgery simulation using fast finite elements. In Proc. Visualization in Biomedical Computing (VBC'96), volume 1131, pages 529-534, Hamburg, Germany, September 1996. Springer Lecture Notes in Computer Science.
[52] E. F. Byars and R. D. Snyder. Mechanics of Deformable Bodies. Intext Educational Publishers, 1975.
[53] S. Cotin and N. Ayache. A Hybrid Elastic Model Allowing Real-Time Cutting, Deformations and Force-Feedback for Surgery Training and Simulation. In Proc. of CAS99, pages 70-81, May 1999.
[54] F. Deschénes, D. Ziou, and M.-F. Auclair-Fortier. Detection of Lines, Line Junctions and Line Terminations. Technical Report 259, Département de mathématiques et d'informatique, Université de Sherbrooke, 2000. Submitted in ISPRS Journal of Photogrammetry and Remote Sensing, 2000.
[55] C. H. Edwards and D. E. Penney. Calculus with Analytic Geometry. Prentice Hall, 1998.
[56] K. M. Entwistle. Basic Principles of the Finite Element Method. IOM Communications Ltd, 1999.
[57] S. F. F. Gibson and B. Mirtich. A Survey of Deformable Modeling in Computer Graphics. Technical report, Mitsubishi Electric Research Laboratory, 1997.
[58] R. C. Juvinall. Engineering considerations of Stress, Strain and Strength. McGraw-Hill, 1967.
[59] M. Kass, A. Witkin, and D. Terzopoulos. Snakes: Active Contour Models. The International Journal of Computer Vision, 1(4):321-331, 1988.
[60] G. T. Mase and G. E. Mase. Continuum Mechanics for Engineers. CRC Press, 1999.
[61] C. Mattiussi. An Analysis of Finite Volume, Finite Element, and Finite Difference Methods Using Some Concepts from Algebraic Topology. Journal of Computational Physics, 133:289-309, 1997.
[62] J. Montagnat and H. Delingette. Volumetric Medical Images Segmentation using Shape Constrained Deformable Models. Lecture Notes in Computer Science, 1205:13-22, 1997.
[63] J. Montagnat, H. Delingette, N. Scapel, and N. Ayache. Representation, shape, topology and evolution of deformable surfaces. Application to 3D medical imaging segmentation. Technical Report 3954, INRIA, 2000.
[64] K. W. Morton and D. F. Mayers. Numerical Solution of Partial Differential Equations. Cambridge University Press, 1994.
[65] B. V. Muvdi and J. W. McNabb. Engineering Mechanics of Materials. Macmillan Publishing Co, 1980.
[66] N. O. Myklestad. Statics of deformable bodies. MacMillan Company, 1966.
[67] R. S. Palmer and V. Shapiro. Chain Models of Physical Behavior for Engineering Analysis and Design. Technical Report TR93-1375, Cornell University, Computer Science Department, August 1993.
[68] N. Peterfreund. Robust Tracking of Position and Velocity With Kalman Snakes. IEEE Transactions on Pattern Analysis and Machine Intelligence, 21(6):564-569, 1999.
[69] W. D. Pilkey and W. Wunderlich. Mechanics of structures: variational and computational methods. CRC Press, 1994.
[70] W. Press, S. Teukolsky, W. Vetterling, and B. Flannery. Numerical Recipes in C. Cambridge University Press, 1992.
[71] G. B. Thomas and R. L. Finney. Calculus and Analytic Geometry. Addison-Wesley Publishing Company, 1988.
[72] E. Tonti. On the Formal Structure of Physical Theories. Technical report, Istituto Di Mathematica Del Polithechnico Di Milano, 1975.

1. A computational image model, comprising:
an image support including a structure of n-pixels comprising pixel faces;
quantities related to image features; and
an algebraic structure relating the quantities to the n-pixels and/or pixel faces, the algebraic structure comprising algebraic operations defining a relation between the quantities.

2. A computational image model as defined in claim 1, wherein each n-pixel is defined as a geometrical structure comprising vertices, edges, faces and a volume, and wherein each n-pixel comprises:
a first pixel dimension n=0 including the vertices of the n-pixel;
a second pixel dimension n=1 including the edges of the n-pixel;
a third pixel dimension n=2 including the faces of the n-pixel;
a fourth pixel dimension n=3 including the volume of the n-pixel; and
a n^{th} pixel dimension n including the hypervolume of the n-pixel.

3. A computational image model as defined in claim 1, wherein the geometrical structure is selected from the group consisting of: a cube, a triangle, a hexagone and a pentagons.

4. A computational image model as defined in claim 1, wherein the quantities related to image features are selected from the group consisting of: scalar quantities, vectors, tensors and matrices.

5. A computational image model as defined in claim 1, wherein the algebraic operations comprise problem-independent operations.

6. A computational image model as defined in claim 1, wherein the algebraic operations comprise problem-dependent operations.

7. A computational image model as defined in claim 1, wherein the structure of n-pixels comprises pairs of disjoint n-pixels.

8. A computational image model as defined in claim 1, wherein the structure of n-pixels comprises pairs of n-pixels intersecting through a common i-pixel, where i<n.

9. A computational image model as defined in claim 1, wherein each n-pixel is translated algebraically into a q-pixel, wherein q ε {1, 2, . . . , n}.

10. A computational image model as defined in claim 9, wherein each q-pixel includes (q−1)-faces, (q−2)-faces, . . . , (q-q)-faces.

11. A computational image model as defined in claim 9, wherein the image support comprises a geometrical complex, which is a collection of q-pixels.

12. A computational image model as defined in claim 10, wherein the image support comprises a geometrical complex, which is a collection of q-pixels, and wherein:
every face of a q-pixel in the geometrical complex is also located in the geometrical complex; and
any pair of two q-pixels of the geometrical complex have an intersection which is either empty or constituted by a common face of both q-pixels of the pair.

13. A computational image model as defined in claim 11, comprising a plurality of image supports forming the geometrical complex.

14. A computational image model as defined in claim 11, wherein the geometrical complex is expressed in algebraic form as a q-chain, which is a linear combination of all the q-pixels of the geometrical complex.

15. A computational image model as defined in claim 9, wherein the geometrical complex comprises q-cochains, which are relations associating quantities related to image features to the q-pixels and/or faces of said q-pixels.

16. A computational image model as defined in claim 15, wherein the quantities related to image features and associated to the q-pixels and/or faces of said q-pixels are global quantities associated to all the q-pixels.

17. A computational image model as defined in claim 15, wherein the quantities related to image features and associated to the q-pixels and/or faces of said q-pixels are local quantities each associated to one q-pixel and/or faces of said one q-pixel.

18. A computational image model as defined in claim 16, comprising (q≧1)-cochains to represent the local quantities.

19. A computational image model as defined in claim 17, comprising 0-cochain to represent the global quantities.

20. A computational image model as defined in claim 17, wherein the algebraic operations comprise a coboundary operation giving a relationship between the q-cochains.

21. A computational image model as defined in claim 9, wherein:
the image support comprises a plurality of geometrical complexes, each being a collection of q-pixels; and
the algebraic operations comprise a codual operation establishing a link between q-cochains that belong to different geometrical complexes.

22. A method of computationally modelling an image, comprising:
producing an image support including a structure of n-pixels comprising pixel faces;
defining quantities related to image features; and
relating the quantities to the n-pixels and/or pixel faces through an algebraic structure, and relating the quantities to each other through algebraic operations.

23. A method of computationally modelling an image as defined in claim 22, wherein relating the quantities to the n-pixels and/or pixel faces through an algebraic structure comprises translating each n-pixel algebraically into a q-pixel, wherein q ε {1, 2, . . . , n}, wherein each q-pixel includes (q−1)-faces, (q−2)-faces, . . . , (q-q)-faces.

24. A method of computationally modelling an image as defined in claim 22, wherein producing an image support comprises forming a geometrical complex, which is a collection of q-pixels, and wherein:
every face of a q-pixel in the geometrical complex is also located in the geometrical complex; and
any pair of two q-pixels of the geometrical complex have an intersection which is either empty or constituted by a common face of both q-pixels of the pair.

25. A method of computationally modelling an image as defined in claim 24, wherein producing an image support comprises forming a plurality of image supports forming the geometrical complex.

26. A method of computationally modelling an image as defined in claim 24, wherein relating the quantities to the n-pixels and/or pixel faces through an algebraic structure comprises expressing the geometrical complex in algebraic form as a q-chain, which is a linear combination of all the q-pixels of the geometrical complex.

27. A method of computationally modelling an image as defined in claim 24, wherein relating the quantities to the n-pixels and/or pixel faces through an algebraic structure comprises forming, in the geometrical complex, q-cochains which are relations associating quantities related to image features to the q-pixels and/or faces of said q-pixels.

28. A method of computationally modelling an image as defined in claim 22, wherein defining quantities related to image features comprises defining global quantities associated to all the q-pixels.

29. A method of computationally modelling an image as defined in claim 22, wherein defining quantities related to image features comprises defining local quantities associated to one q-pixel and/or faces of said one q-pixel.

30. A method of computationally modelling an image as defined in claim 27, wherein relating the quantities to each other through algebraic operations comprise producing a coboundary operator giving a relationship between q-cochains.

31. A method of computationally modelling an image as defined in claim 27, wherein:
producing an image support comprises forming a plurality of geometrical complexes, each being a collection of q-pixels; and
relating the quantities to each other through algebraic operations comprises producing a codual operation establishing a link between cochains that belong to different geometrical complexes.

32. An image modelling method as defined in claim 27, wherein relating the quantities to the n-pixels and/or pixel faces through an algebraic structure comprises expressing a global quantity associated with all q-pixels through a q-cochain such that, for two adjacent q-pixels c_{q}¹ and c_{q}², the q-cochain F_{q} satisfies the relation F_{q}(λ₁c_{q}¹+λ₂c_{q}²)=λ₁F_{q}(c_{q}¹)+λ₂F_{q}(c_{q}²), where λ1 and λ2 are integers.

33. An image modelling method as defined in claim 22, wherein:
relating the quantities to the n-pixels and/or pixel faces through an algebraic structure comprises translating each n-pixel algebraically into a q-pixel, wherein q ε {1, 2, . . . , n}, wherein each q-pixel includes (q−1)-faces, (q−2)-faces, . . . , (q-q)-faces;
producing an image support comprises forming geometrical complexes, each being a collection of q-pixels;
relating the quantities to the n-pixels and/or pixel faces through an algebraic structure comprises:
expressing each geometrical complex in algebraic form as a q-chain, which is a linear combination of all the q-pixels of the geometrical complex;
forming, in the geometrical complexes, q-cochains which are relations associating quantities related to image features to the q-pixels and/or faces of said q-pixels;
relating the quantities to each other through algebraic operations comprises:
producing a coboundary operator giving a relationship between the q-cochains; and
producing a codual operation establishing a link between q-cochains that belong to different geometrical complexes.

34. A computational framework for solving a problem using an image computationally modelled by means of the method of claim 33, comprising:
identifying basic laws associated to the problem;
from the identified basic laws, defining quantities related to the problem;
associating the quantities to respective q-cochains;
associating the basic laws related to the problem to respective coboundary and codual operations; and
resolving the resulting algebraic system.

35. A computational framework as defined in claim 34, wherein forming geometrical complexes comprises forming first and second geometrical complexes.

36. A computational framework as defined in claim 35, wherein identifying basic laws associated to the problem comprises supporting one basic law through the first geometrical complex.

37. A computational framework as defined in claim 36, wherein the problem to be solved is a 2D global differential equation for heat flow in a homogeneous medium, and wherein said one basic law is a heat flow law.

38. A computational framework as defined in claim 37, wherein associating the quantities to respective q-cochains comprises representing a global quantity of temperature through a 0-cochain, and associating the heat flow law through a 1-cochain.

39. A computational framework as defined in claim 35, wherein identifying basic laws associated to the problem comprises supporting one basic law through the second geometrical complex.

40. A computational framework as defined in claim 39, wherein the problem to be solved is a 2D global differential equation for heat flow in a homogeneous medium, and wherein said one basic law is a heat source law.

41. A computational framework as defined in claim 36, wherein identifying basic laws associated to the problem comprises supporting a second basic law through the second geometrical complex, and wherein associating the basic laws related to the problem to respective coboundary and codual operations comprises representing a constitutive law linking basic laws from the first and second geometrical complexes by a codual operation.

42. An image modelling method as defined in claim 22, wherein:
relating the quantities to the n-pixels and/or pixel faces through an algebraic structure comprises translating each n-pixel algebraically into a q-pixel, wherein q ε {1, 2, . . . , n}, wherein each q-pixel includes (q−1)-faces, (q−2)-faces, . . . , (q-q)-faces;
producing an image support comprises forming a geometrical complex, which is a collection of q-pixels;
relating the quantities to the n-pixels and/or pixel faces through an algebraic structure comprises:
expressing the geometrical complex in algebraic form as a q-chain, which is a linear combination of all the q-pixels of the geometrical complex;
forming, in the geometrical complex, q-cochains which are relations associating quantities related to image features to the q-pixels and/or faces of said q-pixels;
relating the quantities to each other through algebraic operations comprises:
producing coboundary operations giving a relationship between the q-cochains.

43. A computational framework for solving a problem using an image computationally modelled by means of the method of claim 42, comprising:
identifying basic laws associated to the problem;
from the identified basic laws, defining quantities related to the problem;
associating the quantities to respective q-cochains;
associating the basic laws related to the problem to respective coboundary operations; and
resolving the resulting algebraic system.

44. A computational framework for solving a heat transfer problem, comprising:
producing an image support including a structure of n-pixels, the image support comprising:
q-pixels respectively translating the n-pixel algebraically, wherein q ε {1, 2, . . . , n}, and wherein each q-pixel includes (q−1)-faces, (q−2)-faces, . . . , (q-q)-faces;
geometrical complexes each being a collection of q-pixels;
q-chains respectively expressing the geometrical complexes in algebraic form, each q-chain being a linear combination of all the q-pixels of the geometrical complex;
in the geometrical complexes, q-cochains which are relations associating quantities related to image features to the q-pixels and/or faces of said q-pixels; and
a coboundary defining a relation between q-cochains;
computing a q-cochain T of a first of said geometrical complexes as the location of unknown temperatures;
computing a q-cochain H of the first geometrical complex as a global temperature variation;
finding a q-cochain ε of a second geometrical complex as a global energy variation, as a function of the q-cochain H through a linear transformation;
finding the q-cochain ε as a function of the q-cochain T;
defining a q-cochain G of the first geometrical complex from the q-cochain T through a first coboundary operation, transforming the q-cochain G into a q-cochain Q of the second geometrical complex, and defining, from the q-cochain Q and through a second coboundary operation, a q-cochain D of the second geometrical complex as a global diffusion;
defining a q-cochain S of the second geometrical complex as a global source; and
establishing a relation between the q-cochains ε, D and S.

45. A computational framework for two-dimensional active contour model, comprising:
producing an image support including a structure of n-pixels, the image support comprising:
q-pixels respectively translating the n-pixel algebraically, wherein q ε {1, 2, . . . , n}, and wherein each q-pixel includes (q−1)-faces, (q−2)-faces, . . . , (q-q)-faces;
geometrical complexes each being a collection of q-pixels;
q-chains respectively expressing the geometrical complexes in algebraic form, each q-chain being a linear combination of all the q-pixels of the geometrical complex;
in the geometrical complexes, q-cochains which are relations associating quantities related to image features to the q-pixels and/or faces of said q-pixels; and
a coboundary defining a relation between q-cochains;
computing a displacement q-cochain D of a first of said geometrical complexes;
computing a strain q-cochain S of a second of said geometrical complexes, comprising:
defining an approximate strain function \tilde{ε}(x) as a function of the q-cochain D;
expressing the q-cochain S as a function of the approximate strain function and relative positions of the first and second geometrical complexes; and
computing a force q-cochain F of the second geometrical complex as a coboundary of the strain q-cochain S.
